(19) United States
(12) Patent Application Publication
(10) Pub. No.: US 2022/0132388 A1
(43) Pub. Date: Apr. 28, 2022

(54) NOTIFICATION OF RADIO LINK FAILURE IN WIRELESS RELAY NETWORKS

(71) Applicants: SHARP KABUSHIKI KAISHA, Sakai City, Osaka (JP); FG Innovation Company Limited, Tuen Mun (HK)

(72) Inventors: ATSUSHI ISHII, Sakai City, Osaka (JP); TATSUSHI AIBA, Sakai City, Osaka (JP); KAZUNARI YOKOMAKURA, Sakai City, Osaka (JP)

(21) Appl. No.: 17/428,787

(22) PCT Filed: Dec. 26, 2019
(86) PCT No.: PCT/JP2019/051279

§ 371 Date: Aug. 5, 2021

Related U.S. Application Data
(60) Provisional application No. 62/805,762, filed on Feb. 14, 2019.

(51) Int. Cl. H04W 36/30; H04W 76/19

(52) U.S. Cl. CPC H04W 36/305; H04W 80/02; H04W 76/19

(57) ABSTRACT

A wireless terminal comprises processor circuitry and receiver circuitry. The receiver circuitry is configured to receive a notification message from a wireless relay node, the notification message comprising information representing at least one radio condition of an upstream radio link of the wireless relay node, the notification message received in at least one of Medium Access Control (MAC) layer signaling and physical layer signaling. The processor circuitry is configured to perform a designated action based on reception of the notification message.

### CROSS-REFERENCE TO RELATED APPLICATION(S)

This Nonprovisional application claims priority under 35 U.S.C. § 119 to provisional U.S. Patent Application No. 62/805,762, filed on Feb. 14, 2019, the entire contents of which are hereby incorporated herein by reference.

### TECHNICAL FIELD

The technology relates to wireless communications, and particularly to radio architecture and operation for resolving problematic conditions on wireless relay networks.

### BACKGROUND ART

A radio access network typically resides between wireless devices, such as user equipment (UEs), mobile phones, mobile stations, or any other device having wireless termination, and a core network. Example of radio access network types includes the Global System for Mobile Communications (GSM) radio access network (GRAN); the GSM Enhanced Data rates for GSM Evolution (EDGE) radio access network (GERAN), which includes EDGE packet radio services; the Universal Mobile Telecommunications System (UMTS) radio access network (UTRAN); the Long-Term Evolution (LTE) UTRAN (E-UTRAN), which includes Long-Term Evolution; and the g-UTRAN, and New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio (“NR”) technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. FIG. 50 is a diagrammatic view of overall architecture for a 5G New Radio system. Overall architecture for a fifth generation (5G) system, e.g., the 5G System, also called “NR” or “New Radio”, as well as “NG” or “Next Generation” is shown in FIG. 50, and is also described in 3GPP TS 38.300. The 5G NR network is comprised of NG RAN (Next Generation Radio Access Network) and 5GC (5G Core Network). As shown, NG RAN is comprised of gNBs (e.g., 5G Base stations) and new generation eNodeBs (ng-eNB) (i.e. LTE base stations). An Xn interface exists between gNB-gNB, between (gNB)-(ng-eNB) and between (ng-eNB)-(ng-eNB). The Xn is the network interface between NG RAN nodes. Xn-U stands for Xn User Plane interface and Xn-C stands for Xn Control Plane interface. An NG interface exists between 5GC and the base stations (i.e. gNB & ng-eNB). A gNB node provides NR user plane and control plane protocol terminations towards the UE, and is connected via the NG interface to the 5GC. The 5G NR (New Radio) gNB is connected to AMF (Access and Mobility Management Function) and UPF (User Plane Function) in 5GC (5G Core Network).

In some cellular mobile communication systems and networks, such as Long-Term Evolution (LTE) and New Radio (NR), a service area is covered by one or more base stations, where each of such base stations may be connected to a core network by fixed-line backhaul links (e.g., optical fiber cables). In some instances, due to weak signals from the base station at the edge of the service area, users tend to experience performance issues, such as: reduced data rates, high probability of link failures, etc. A relay node concept has been introduced to expand the coverage area and increase the signal quality. As implemented, the relay node may be connected to the base station using a wireless backhaul link.

In 3rd Generation Partnership Project (3GPP), the relay node concept for the fifth generation (5G) cellular system has been discussed and standardized, where the relay nodes may utilize the same 5G radio access technologies (e.g., New Radio (NR)) for the operation of services to User Equipment (UE) (access link) and connections to the core network (backhaul link) simultaneously. These radio links may be multiplexed in time, frequency, and/or space. This system may be referred to as Integrated Access and Backhaul (IAB).

Some such cellular mobile communication systems and networks may comprise IAB-donors and IAB-nodes, where an IAB-donor may provide interface to a core network to UEs and wireless backhauling functionality to IAB-nodes; and additionally, an IAB-node may provide IAB functionality combined with wireless self-backhauling capabilities. IAB-nodes may need to periodically perform inter-IAB-node discovery to detect new IAB-nodes in their vicinity based on cell-specific reference signals (e.g., Synchronization Signal and PBCH block SSB). The cell-specific reference signals may be broadcasted on a Physical Broadcast Channel (PBCH) where packets may be carried or broadcasted on the Master Information Block (MIB) section.

Demand for wireless traffic has increased significantly over time and IAB systems are expected to be reliable and robust against various kinds of possible failures. Considerations have been given for IAB backhaul design. In particular, to provide methods and procedures to address radio link failures on the backhaul link.

What is needed are methods, apparatus, and/or techniques to cope with unfavorable conditions or problems on a wireless backhaul link.

### SUMMARY OF INVENTION

In one example, a wireless relay node comprises: processor circuitry configured to generate a notification message for transmission on at least one of Medium Access Control (MAC) layer signaling and physical layer signaling, the notification message comprising information representing a radio condition; and transmitter circuitry configured to transmit the notification message to a wireless terminal.

In one example, a wireless terminal comprises: receiver circuitry configured to receive a notification message from a wireless relay node, the notification message comprising information representing a radio condition of an upstream radio link of the wireless relay node, the notification message received in at least one of Medium Access Control (MAC) layer signaling and physical layer signaling; and processor circuitry configured to perform a designated action based on reception of the notification message.

In one example, a method for a wireless relay node comprises: generating a notification message comprising information representing at least one radio condition for transmission on at least one of Medium Access Control (MAC) layer signaling and or physical layer signaling; and transmitting the notification message to a wireless terminal.

In one example, a method for a wireless terminal comprises: receiving a notification message from a wireless relay node, the notification message comprising information representing at least one radio condition of an upstream radio link of the wireless relay node, the notification message received on at least one of Medium Access Control (MAC) layer signaling and physical layer signaling; and performing a designated action based on reception of the notification message.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view illustrating a mobile network infrastructure using 5G signals and 5G base stations.

FIG. 2 is a diagrammatic view depicting an example of functional block diagrams for the IAB-donor and the IAB-node.

FIG. 3 is a diagrammatic view illustrating Control Plane (C-Plane) and User Plane (U-Plane) protocols among the UE, IAB-nodes, and an IAB-donor.

FIG. 4 is a functional block diagram of an example protocol stack configuration for the U-Plane.

FIG. 5A depicts a functional block diagram of an example protocol stack configuration for the C-Plane between an IAB-node directly connected to an IAB-donor.

FIG. 5B depicts a functional block diagram of an example configuration of the C-Plane protocol stack for an IAB-node connected to another IAB-node which is connected to an IAB-donor.

FIG. 5C depicts a functional block diagram of an example configuration of the C-Plane protocol stack for a UE's Radio Resource Control (RRC) signaling.

FIG. 6A depicts an example message sequence or flow of information for an IAB-node to establish an RRC connection, followed by an F1-AP* connection.

FIG. 6B depicts an example message sequence for an IAB-node to establish an RRC connection with an IAB-donor, followed by the F1 setup procedure.

FIG. 7 is a diagrammatic view of an example scenario where an IAB-node detects a Radio Link Failure (RLF) on the upstream link to its parent node.

FIG. 8 illustrates an example flow of information transmission/reception and/or processing by a UE and/or an IAB-node connected to a set of IAB-nodes in communication with an IAB-donor, for processing a notification of an RLF.

FIG. 9A illustrates an example flow of information transmission/reception and/or processing by a UE and/or IAB-node connected to a set of IAB-nodes in communication with an IAB-donor, based on receiving an Upstream RLF notification.

FIG. 9B illustrates another example flow of information transmission/reception and/or processing by a UE and/or IAB-node connected to a set of IAB-nodes in communication with an IAB-donor, based on not having received an Upstream RLF notification.

FIG. 10 is a diagrammatic view illustrating an example of a radio protocol architecture for the control and user planes in a mobile communications network.

FIG. 11 is a diagrammatic view showing another example telecommunications system in which a conditional autonomous handover may be performed for resolving a wireless link backhaul condition.

FIG. 12 is a diagrammatic view showing an example, non-limiting more detailed implementation of at least portions of the system of FIG. 11.

FIG. 13 is a flowchart showing example, non-limiting, basic acts or steps that may be performed by a wireless access node of FIG. 11 and FIG. 12.

FIG. 14 is a flowchart showing example, non-limiting, basic acts or steps that may be performed by a child node of FIG. 11 and FIG. 12.

FIG. 15 depicts example, basic, representative acts or steps of a message flow for the system scenario shown in FIG. 11.

FIG. 16 is a diagrammatic view showing another example telecommunications system in which a wireless link backhaul condition may be resolved when redundant links are utilized.

FIG. 17 is a diagrammatic view showing an example, non-limiting more detailed implementation of at least portions of the system of FIG. 16.

FIG. 18 is a flowchart showing example, non-limiting, basic acts or steps that may be performed by a wireless access node of FIG. 16 and FIG. 17.

FIG. 19 is a flowchart showing example, non-limiting, basic acts or steps that may be performed by a child node of FIG. 16 and FIG. 17.

FIG. 20A depicts example, basic, representative acts or steps of a message flow for a first example system scenario shown in FIG. 16.

FIG. 20B depicts example, basic, representative acts or steps of a message flow for a first example system scenario shown in FIG. 16.

FIG. 21 is a diagrammatic view showing another example telecommunications system in which a routing loop may occur upon cell selection.

FIG. 22A depicts example, basic, representative acts or steps of a message flow in a situation in which an IAB node of FIG. 21 may recover from a broken upstream link by an RRC reestablishment procedure with a first parent IAB node.

FIG. 22B depicts example, basic, representative acts or steps of a message flow in a situation in which an IAB node of FIG. 21 may recover from a broken upstream link by an RRC reestablishment procedure with a second parent IAB node.

FIG. 23 is a diagrammatic view showing another example telecommunications system, and particularly an example telecommunications system in which generic routing loop prevention information is used to address a potential routing loop problem.

FIG. 24 is a flowchart showing example, non-limiting, basic acts or steps that may be performed by a wireless access donor node of FIG. 23.

FIG. 25 is a flowchart showing example, non-limiting, basic acts or steps that may be performed by a non-donor Integrated Access and Backhaul (IAB) node of FIG. 23.

FIG. 26A is a diagrammatic view showing an example implementation of the generic telecommunications system of FIG. 23 in which the routing loop prevention information comprises configuration information, e.g., configuration parameter(s), generated by a donor Integrated Access and Backhaul (IAB) node.

FIG. 26B is a diagrammatic view showing an example implementation of the generic telecommunications system of FIG. 23 in which the routing loop prevention information comprises configuration information, e.g., configuration parameter(s), generated by a network server entity.

FIG. 27 is a diagrammatic view of an example message flow including a RRCReconfiguration message for sending a whitelist or blacklist of configuration parameter(s).

FIG. 28 is a flowchart showing example, representative acts or steps which may be performed by the IAB node of FIG. 26A and FIG. 26B.

FIG. 29 is a flowchart showing example, representative acts or steps which may be performed by the wireless access donor node of FIG. 26A.

FIG. 30 is a flowchart showing example, representative acts or steps which may be performed by the wireless access donor node of FIG. 26B.

FIG. 31 is a flowchart showing example, representative acts or steps which may be performed by the network entity of FIG. 26B.

FIG. 32 is a schematic view of an IAB node which further comprises a configuration parameter(s) validity timer.

FIG. 33 is a diagrammatic view showing an example implementation of the generic telecommunications system of FIG. 23 in which an Integrated Access and Backhaul (IAB) node broadcasts system information as routing loop prevention information, which announces parent nodes.

FIG. 34 is a diagrammatic view illustrating a mode of operation of a telecommunications network that includes Integrated Access and Backhaul (IAB) nodes that broadcast system information which announces parent nodes in the manner of FIG. 33.

FIG. 35 is a diagrammatic view showing an example implementation of the generic telecommunications system of FIG. 23 in which an Integrated Access and Backhaul (IAB) node broadcasts system information as routing loop prevention information, which announces parent nodes, and in which a routing loop prevention information generator takes the form of a parent node identification generator.

FIG. 36 is a flowchart showing example, representative acts or steps which may be performed by the wireless access donor node of FIG. 33-FIG. 35.

FIG. 37 is a flowchart showing example, representative acts or steps which may be performed by the wireless access donor node of FIG. 33-FIG. 35.

FIG. 38A is a diagrammatic view showing portions of an example telecommunications system in which an uplink condition notification message includes or comprises MAC layer signaling.

FIG. 38B a diagrammatic view showing portions of an example telecommunications system in which an uplink condition notification message includes or comprises physical layer signaling.

FIG. 39A is a flowchart showing example, representative acts or steps which may be performed by the IAB node of FIG. 38A.

FIG. 39B is a flowchart showing example, representative acts or steps which may be performed by the IAB node of FIG. 38B.

FIG. 40A is a flowchart showing example, representative acts or steps which may be performed by the UE/IAB node of FIG. 38A.

FIG. 40B is a flowchart showing example, representative acts or steps which may be performed by the UE/IAB node of FIG. 38B.

FIG. 41 is a diagrammatic view showing an example format of a MAC downlink Protocol Data Unit (PDU).

FIG. 42A is a diagrammatic view showing three different MAC subheader formats.

FIG. 42B is a diagrammatic view showing three different MAC subheader formats.

FIG. 42C is a diagrammatic view showing three different MAC subheader formats.

FIG. 43A is a diagrammatic view showing an example format in which a MAC layer signaled notification message does not carry other information.

FIG. 43B is a diagrammatic view showing an example format in which a MAC layer signaled notification message additionally carries status information of the upstream backhaul link of the IAB-node.

FIG. 43C is a diagrammatic view showing an example format in which a MAC layer signaled notification message additionally carries types of information other than status information for the upstream backhaul link of the IAB-node.

FIG. 44 is a diagrammatic view showing a resource grid and a Physical Downlink Shared Channel (PDSCH) which comprise the downlink control information (DCI) which indicates scheduling of a Physical Downlink Shared Channel (PDSCH) which includes a MAC PDU that comprises or includes the link condition notification message.

FIG. 45A is a diagrammatic view showing a Cyclic Redundancy Check (CRC) associated with downlink control information (DCI) being scrambled by a Cell Radio Network Temporary Identifier (C-RNTI) for a specific child IAB node.

FIG. 45B is a diagrammatic view showing a CRC associated with downlink control information (DCI) being scrambled by an IAB-RNTI for broadcast.

FIG. 46 is a diagrammatic view showing an IAB-donor node sending an RRCReconfiguration message comprising (1) an indication of whether or not the IAB-node/UE should expect the upstream RLF notification and (2) a RNTI to be used to decode the DCI associated with the MAC PDU.

FIG. 47 is a diagrammatic view showing a Physical Downlink Control Channel (PDCCH) comprising one or more control resource sets (CORESETs), each of which may comprise one or more search space set(s).

FIG. 48 is a diagrammatic view showing an IAB-donor node sending an RRCReconfiguration message comprising a configuration for determining search space set(s) to be used by an IAB node or UE/IAB node.

FIG. 49 is a diagrammatic view showing example elements comprising electronic machinery which may comprise a wireless terminal, a radio access node, and a core network node according to an example embodiment and mode.

FIG. 50 is a diagrammatic view of overall architecture for a 5G New Radio system.

### DESCRIPTION OF EMBODIMENTS

In one of its example aspects the technology disclosed herein concerns a wireless relay node which comprises processor circuitry and transmitter circuitry, and a method of operating such wireless relay node. The processor circuitry is configured to generate a notification message for transmission on at least one of Medium Access Control (MAC) layer signaling and physical layer signaling, the notification message comprising information representing a radio condition. The transmitter circuitry configured to transmit the notification message to a wireless terminal.

In another of its example aspects the technology disclosed herein concerns a wireless terminal which comprises processor circuitry and receiver circuitry, and a method of operating such wireless terminal. The receiver circuitry is configured to receive a notification message from a wireless relay node, the notification message comprising information representing a radio condition of the wireless relay node's upstream radio link, the notification message being received in at least one of Medium Access Control (MAC) layer signaling and physical layer signaling. The processor circuitry configured to perform a designated action based on a reception of the notification message.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMT Advanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

Any reference to a “resource” herein means “radio resource” unless otherwise clear from the context that another meaning is intended. In general, as used herein a radio resource (“resource”) is a time-frequency unit that can carry information across a radio interface, e.g., either signal information or data information. An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix. A mobile network used in wireless networks may be where the source and destination are interconnected by way of a plurality of nodes. In such a network, the source and destination may not be able to communicate with each other directly due to the distance between the source and destination being greater than the transmission range of the nodes. That is, a need exists for intermediate node(s) to relay communications and provide transmission of information. Accordingly, intermediate node(s) may be used to relay information signals in a relay network, having a network topology where the source and destination are interconnected by means of such intermediate nodes. In a hierarchical telecommunications network, the backhaul portion of the network may comprise the intermediate links between the core network and the small subnetworks of the entire hierarchical network. Integrated Access and Backhaul (IAB) Next generation NodeB use 5G New Radio communications such as transmitting and receiving NR User Plane (U-Plane) data traffic and NR Control Plane (C-Plane) data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Radio Link Control (RLC) Protocol.

In some aspects of the embodiments for handling of radio link failures in wireless relay networks, disclosed is a Mobile Termination (MT) functionality-typically provided by the User Equipment (UE) terminals—that may be implemented by Base Transceiver Stations (BTSs or BSs) nodes, for example, IAB nodes. In one embodiment, the MT functions may comprise common functions such as: radio transmission and reception, encoding and decoding, error detection and correction, signaling, and access to a SIM.

In a mobile network, an IAB child node may use the same initial access procedure (discovery) as an access UE to establish a connection with an IAB node/donor or parent-thereby attaching to the network or camping on a cell. In one embodiment, Radio Resource Control (RRC) protocol may be used for signaling between 5G radio network and UE, where RRC may have at least two states (e.g., RRC_IDLE and RRC_CONNECTED) and state transitions. The RRC sublayer may enable establishing of connections based on the broadcasted system information and may also include a security procedure. The U-Plane may comprise of PHY, MAC, RLC and PDCP layers.

Embodiments of the present system disclose methods and devices for an IAB-node to inform child nodes and/or UEs of upstream radio conditions and accordingly, the term IAB-node may be used to represent either a parent IAB-node or a child IAB-node, depending on where the IAB-node is in the network communication with the IAB-donor which is responsible for the physical connection with the core network. Embodiments are disclosed where an IAB-node (child IAB-node) may follow the same initial access procedure as a UE, including cell search, system information acquisition, and random access, in order to initially set up a connection to a parent IAB-node or an IAB-donor. That is, when an IAB base station (eNB/gNB) needs to establish a backhaul connection to, or camp on, a parent IAB-node or an IAB-donor, the IAB-node may perform the same procedures and steps as a UE, where the IAB-node may be treated as a UE but distinguished from a UE by the parent IAB-node or the IAB-donor.

In the disclosed embodiments for handling radio link failures in wireless relay networks, MT functionality—typically offered by a UE—may be implemented on an IAB-node. In some examples of the disclosed systems, methods, and device embodiments, consideration may be made in order for a child IAB-node to monitor a radio condition on a radio link to a parent IAB-node—where the parent IAB-node may itself be a child IAB-node in communication with an IAB-donor.

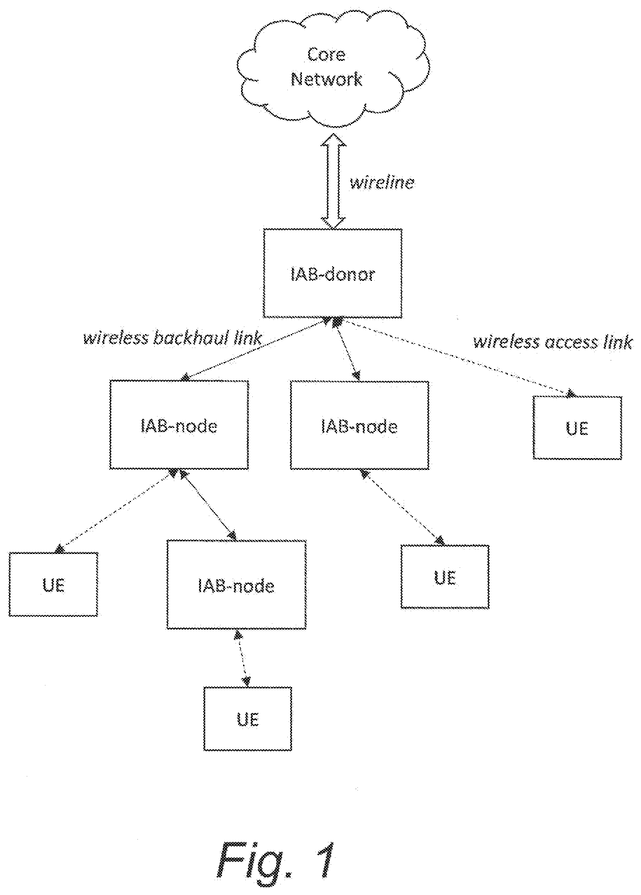

FIG. 1 is a diagrammatic view illustrating a mobile network infrastructure using 5G signals and 5G base stations. With reference to FIG. 1, the present embodiments include a mobile network infrastructure using 5G signals and 5G base stations (or cell stations). Depicted is a system diagram of a radio access network utilizing IAB nodes, where the radio access network may comprise, for example, one IAB-donor and multiple IAB-nodes. Different embodiments may comprise different number of IAB-donor and IAB-node ratios. Herein, the IAB nodes may be referred to as IAB relay nodes. The IAB-node may be a Radio Access Network (RAN) node that supports wireless access to UEs and wirelessly backhauls the access traffic. The IAB-donor may be a RAN node which may provide an interface to the core network to UEs and wireless backhauling functionality to IAB nodes. An IAB-node/donor may serve one or more IAB nodes using wireless backhaul links as well as UEs using wireless access links simultaneously. Accordingly, network backhaul traffic conditions may be implemented based on the wireless communication system to a plurality of IAB nodes and UEs.

With further reference to FIG. 1, a number of UEs are depicted as in communication with IAB nodes, for example, IAB nodes and IAB donor node, via wireless access link. Additionally, the IAB-nodes (child nodes) may be in communication with other IAB-nodes and/or an IAB-donor (all of which may be considered IAB parent nodes) via wireless backhaul link. For example, a UE may be connected to an IAB-node which itself may be connected to a parent IAB-node in communication with an IAB-donor, thereby extending the backhaul resources to allow for the transmission of backhaul traffic within the network and between parent and child for integrated access. The embodiments of the system provide for capabilities needed to use the broadcast channel for carrying information bit(s) (on the physical channels) and provide access to the core network.

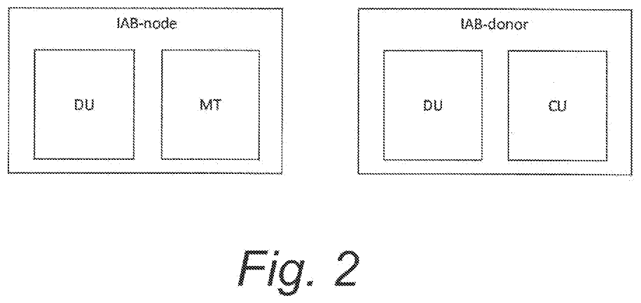

FIG. 2 is a diagrammatic view depicting an example of functional block diagrams for the IAB-donor and the IAB-node. FIG. 2 depicts an example of functional block diagrams for the IAB-donor and the IAB-node (see FIG. 1). The IAB-donor may comprise at least one Central Unit (CU) and at least one Distributed Unit (DU). The CU is a logical entity managing the DU collocated in the IAB-donor as well as the remote DUs resident in the IAB-nodes. The CU may also be an interface to the core network, behaving as a RAN base station (e.g., eNB or gNB). In some embodiments, the DU is a logical entity hosting a radio interface (backhaul/access) for other child IAB-nodes and/or UEs. In one configuration, under the control of CU, the DU may offer a physical layer and Layer-2 (L2) protocols (e.g., Medium Access Control (MAC), Radio Link Control (RLC), etc.) while the CU may manage upper layer protocols (such as Packet Data Convergence Protocol (PDCP), Radio Resource Control (RRC), etc.). An IAB-node may comprise DU and Mobile-Termination (MT) functions, where in some embodiments the DU may have the same functionality as the DU in the IAB-donor, whereas MT may be a UE-like function that terminates the radio interface layers. As an example, the MT may function to perform at least one of: radio transmission and reception, encoding and decoding, error detection and correction, signaling, and access to a SIM.

Embodiments include a mobile network infrastructure where a number of UEs are connected to a set of IAB-nodes and the IAB-nodes are in communication with each other for relay and/or an IAB-donor using the different aspects of the present embodiments. In some embodiments, the UE may communicate with the CU of the IAB-donor on the C-Plane using RRC protocol and in other embodiments, using Service Data Adaptation Protocol (SDAP) and/or Packet Data Convergence Protocol (PDCP) radio protocol architecture for data transport (U-Plane) through NR gNB. In some embodiments, the DU of the IAB-node may communicate with the CU of the IAB-donor using 5G radio network layer signaling protocol: F1 Application Protocol (F1-AP*) which is a wireless backhaul protocol that provides signaling services between the DU of an IAB-node and the CU of an IAB-donor. That is, as further described below, the protocol stack configuration may be interchangeable, and different mechanism may be used.

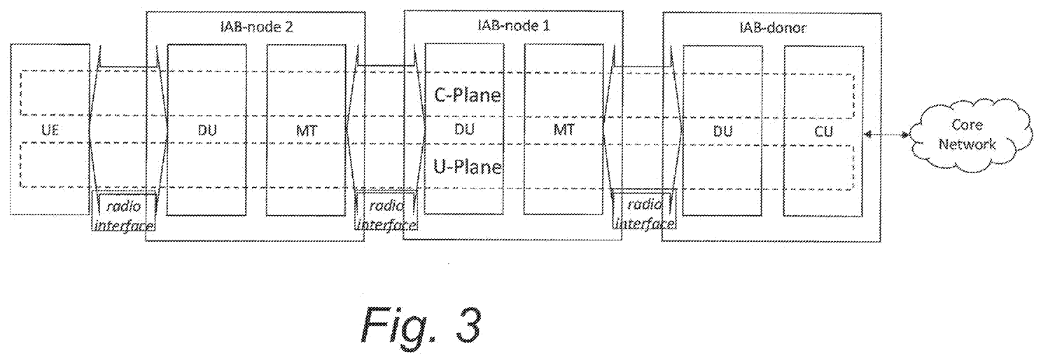

FIG. 3 is a diagrammatic view illustrating Control Plane (C-Plane) and User Plane (U-Plane) protocols among the UE, IAB-nodes, and an IAB-donor. As illustrated by the diagram shown in FIG. 3, the protocols among the UE, IAB-nodes, and IAB donor are grouped into Control Plane (C-Plane) and User Plane (U-Plane). C-Plane carries control signals (signaling data), whereas the U-Plane carries user data. FIG. 3 shows an example of the embodiment where there are two IAB-nodes, IAB-node 1 and IAB-node 2, between the UE and the IAB-donor (two hops). Other embodiments may comprise a network with a single hop or multiple hops where there may be more than two IAB-nodes present.

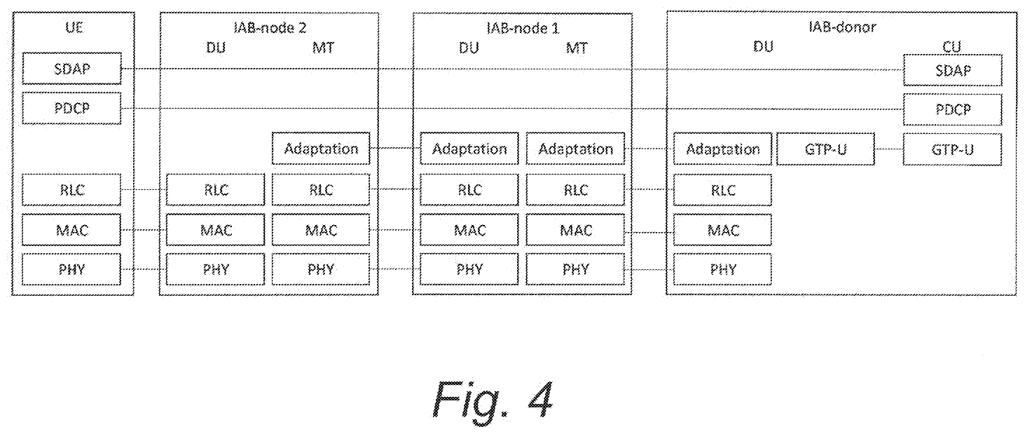

FIG. 4 is a functional block diagram of an example protocol stack configuration for the U-Plane. FIG. 4 depicts a functional block diagram of an example protocol stack configuration for the U-Plane, the stack comprising Service Data Protocol (e.g., SDAP, 3GPP TS 38.324) which may carry user data (e.g., via IP packets). In one embodiment, the SDAP runs on top of PDCP (3GPP TS 38.323) and the L2/Physical layers. In one embodiment, an Adaptation Layer is introduced between the IAB-node and the IAB-node/donor, where the Adaptation Layer carries relay-specific information, such as IAB-node/donor addresses, QoS information, UE identifiers, and potentially other information. In this embodiment, RLC (3GPP TS 38.322) may provide reliable transmission in a hop-by-hop manner while PDCP may perform end-to-end (UE-CU) error recovery. GTP-U (GPRS Tunneling Protocol User Plane) may be used for routing user data between CU and DU inside the IAB-donor.

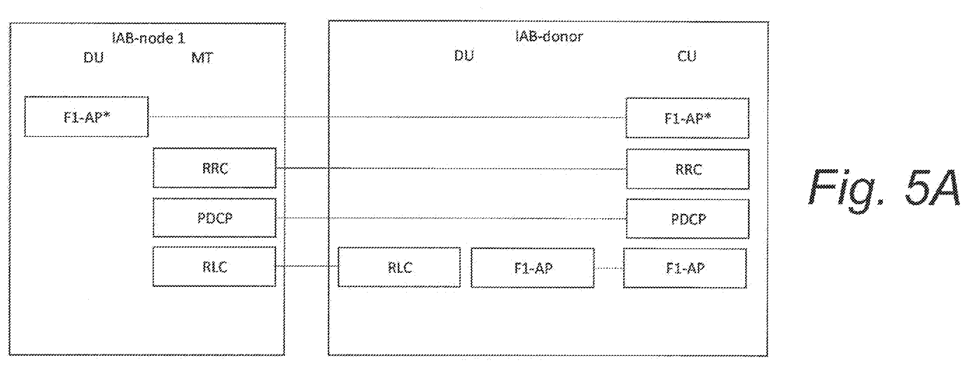

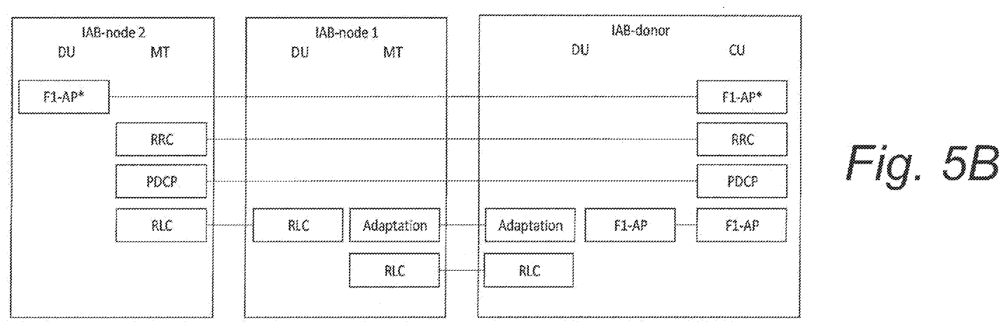

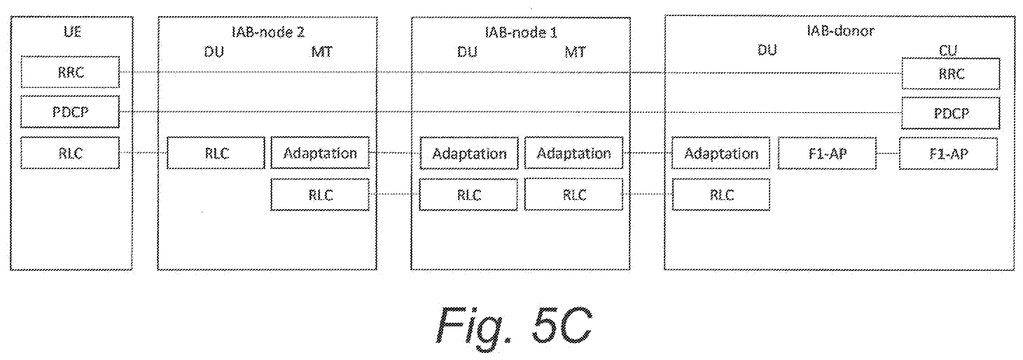

FIG. 5A is a functional block diagram of an example protocol stack configuration for the C-Plane between an IAB-node (IAB-node 1) directly connected to the IAB-donor (via a single hop). In this embodiment, the MT component of IAB-node 1 may establish an RRC connection with the CU component of the IAB-donor. In parallel, RRC may be used for carrying another signaling protocol in order for CU/IAB-donor to control the DU component resident in the IAB-node 1. In one embodiment, such a signaling protocol may be referred to as F1 Application Protocol* (F1-AP*), either the protocol referred as F1-AP specified in 3GPP TS 38.473 or a protocol based on the F1-AP with potential extended features to accommodate wireless backhauls (the original F1-AP is designed for wirelines). In other embodiments, F1-AP may be used for CU-DU connection inside the IAB-donor. It is assumed that below RLC, MAC/PHY layers are shared with the U-Plane.

FIG. 5B depicts a functional block diagram of an example configuration of the C-Plane protocol stack for an IAB-node 2 connected to another IAB-node 1 (2 hops) which is connected to an IAB-donor. In one embodiment, it may be assumed that the IAB-node 1 has already established RRC/F1-AP* connections with the IAB-donor as shown in FIG. 5A. In IAB-node 1 the signaling bearer for IAB-node 2 RRC/PDCP may be carried by the Adaptation Layer to the IAB-donor. Similar to FIG. 5A, the F1-AP* signaling is carried by the RRC of IAB-node 2.

FIG. 5C depicts a functional block diagram of an example configuration of the C-Plane protocol stack for a UE's RRC signaling. FIG. 5C illustrates an example configuration of the C-Plane protocol stack for UE's RRC signaling under the 2-hop relay configuration shown in FIG. 5B. Accordingly, the UE having an MT component and functionality, via the C-Plane, may be connected to the CU of the IAB-donor. Though traffic is routed through IAB-node 2 and IAB-node 1, as depicted, the two nodes are passive nodes in that the data is passed to the next node(s) without manipulation. That is, data is transmitted by the UE to the node it is connected to, e.g., IAB-node 2, and then IAB-node 2 transmits the data to the node that is connected to, e.g., IAB-node 1, and then IAB-node 1 transmits the data (without manipulation) to the IAB-donor.

FIGS. 5A, 5B, and 5C illustrate that the MT of each IAB-node or UE has its own end-to-end RRC connection with the CU of the IAB-donor. Likewise, the DU of each IAB-node has an end-to-end F1-AP* connection with the CU of the IAB-donor. Any IAB nodes present between such end points transparently convey RRC or F1-AP signaling traffic.

FIGS. 6A and 6B are diagrams of an example flow of information transmission/reception and/or processing by IAB-node(s) and an IAB-donor according to aspects of the present embodiments.

FIG. 6A depicts an example message sequence for an IAB-node 1 to establish an RRC connection with an IAB-donor, followed by F1-AP* connection. It is assumed that IAB-node 1 has been pre-configured (or configured by the network) with information that instructs how to select a cell served by the IAB-donor. As shown in the figure, IAB-node 1—in an idle state (RRC_IDLE)—may initiate an RRC connection establishment procedure by sending Random Access Preamble to the IAB-donor, which may be received and processed by the DU of the IAB-donor. Upon successful reception of Random Access Response from the IAB-donor, IAB-node 1 may send a RRCSetupRequest, followed by reception of an RRCSetup and transmission of RRCSetupComplete. At this point of the message sequence, the IAB-node 1 may enter a connected state (RRC_CONNECTED) with the IAB-donor, and may proceed with a security procedure to configure encryption/integrity protection features. The CU of the IAB-donor may further send an RRCReconfiguration to IAB-node 1, which may comprise configuration parameters to configure radio bearers (e.g., data radio bearers (DRBs) and signaling radio bearers (SRBs)). In some embodiments, the RRCReconfiguration is sent to modify an RRC connection and establish Radio Connection between a UE and the network, however, in the present embodiment, the RRCReconfiguration may also be sent to configure a connection between an IAB-node and the network. RRC Connection Reconfiguration messages may be used to, for example, establish/modify/release Radio Bearers, and/or perform handover, etc. In one embodiment, any of the RRC messages transmitted from IAB-node 1 may include information identifying the IAB-node 1 as an IAB-node (not as a UE). For example, the Donor CU may be configured with a list of node identities (e.g., IMSI or S-TMSI) that may be allowed to use the service from the donor. The information may be used by the CU in the subsequence operations, for example, to distinguish a UE from an IAB-node.

As described above, following the RRC connection establishment procedure, the DU of IAB-node 1 and IAB-donor may proceed with F1 setup procedure using the F1-AP* protocol, which may activate one or more cells served by the DU of IAB-node 1—thereby allowing other IAB nodes and/or UEs to camp on the cell. In this procedure, the Adaptation Layer for IAB-node 1 and IAB-donor may be configured and activated as well.

FIG. 6B depicts an example message sequence or flow of information for an IAB-node 2 to establish an RRC connection with IAB-donor, followed by the F1 setup procedure. It is assumed in this embodiment that IAB-node 1 has already performed the process disclosed in FIG. 6A to establish an RRC and F1-AP* connection. Referring back to FIG. 3, the IAB-node 2 shown in communication via the radio interface with IAB-node 1, may be also depicted in FIG. 6B as a child node of IAB-node 1 according to aspects of the present embodiments.

It should be understood that upon or after establishing the RRC/F1-AP connection the IAB-donor may acquire knowledge of the IAB-node location within the relay network topology. In one configuration, this may be achieved by intermediate IAB-nodes relaying identifications of nodes located in its downstream to its upstream nodes.

Due to the nature of wireless communications, the wireless backhaul links are susceptible to be deteriorated or broken at any time. In aspects of the present embodiments, the MT part of an IAB-node may constantly monitor the quality of the radio link and/or signal quality on the upstream of the IAB-node, where the radio link may be to a parent IAB node/donor of the IAB-node. If radio problems cannot be recovered in a designated duration, the MT may declare Radio Link Failure (RLF), meaning a loss of communication link may have occurred or signal strength is weak to continue (e.g., below a threshold).

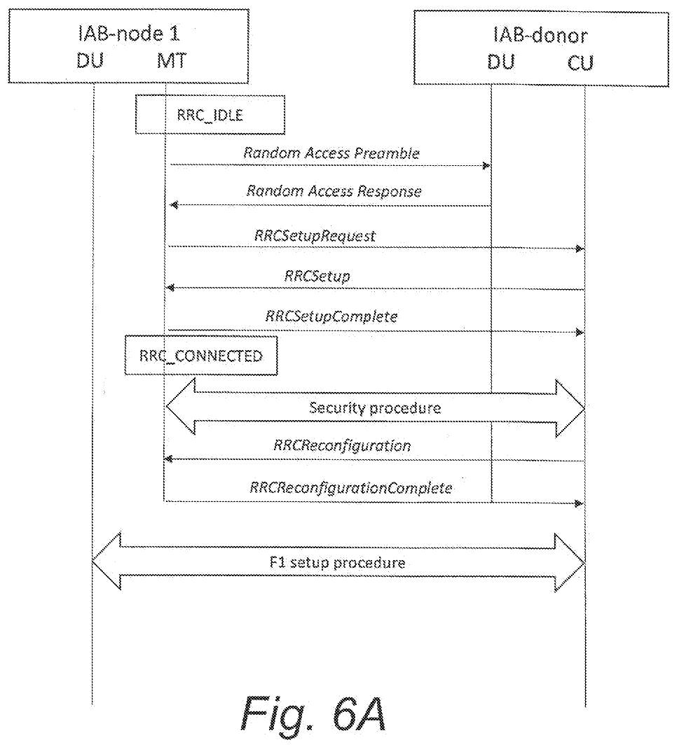

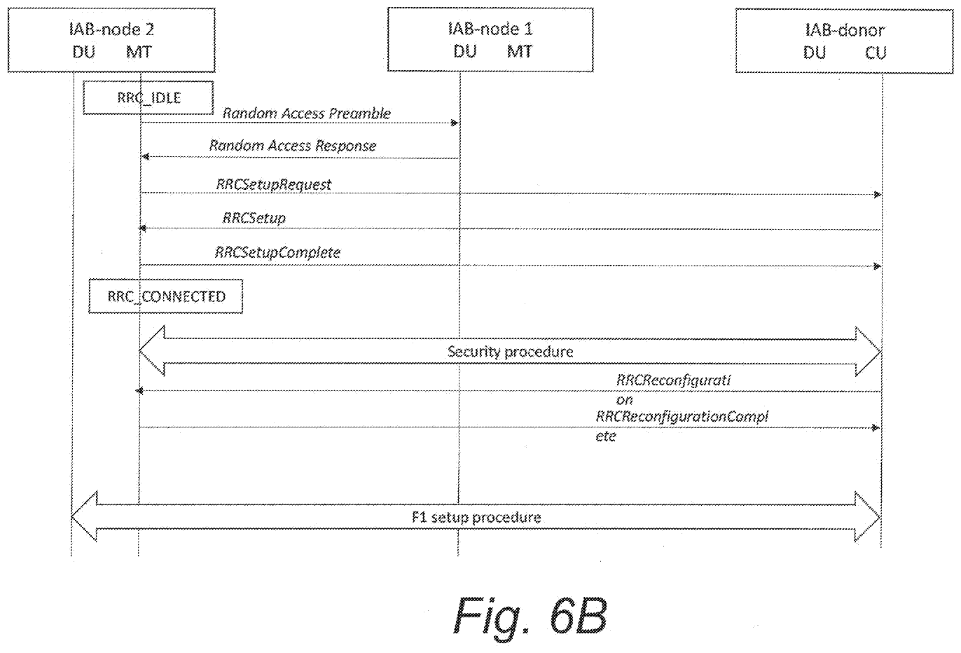

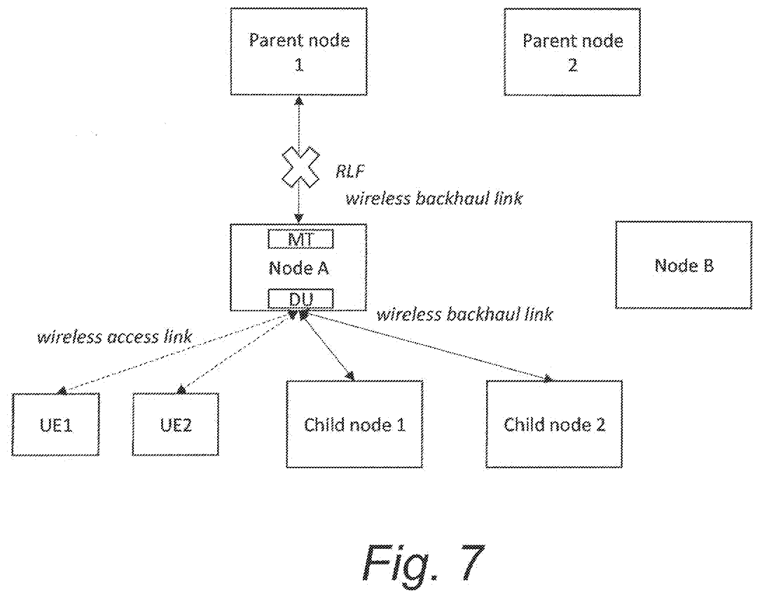

FIG. 7 is a diagrammatic view of an example scenario where an IAB-node (Node A) detects an RLF on the upstream link to its parent node (Parent node 1). In some embodiments, the MT component of Node A may need to find another parent that is visible from the node. In this case, the MT component may perform a cell selection procedure, and if a suitable cell (Parent node 2) is successfully found, the Node A may then proceed with an RRC reestablishment procedure with the suitable cell (Parent node 2). It should be noted that Node A in this scenario needs to find a cell served by either an IAB-node or an IAB-donor (i.e., non-IAB-capable cells are not suitable). In one embodiment, a cell served by either an IAB-node or an IAB-donor may broadcast (e.g., in the system information, such as MIB, system information block type 1 (SIB1) or any of the other SIBs) a state, e.g., via a flag, as an indication indicating the IAB capability, which may further comprise an indication of the IAB functionality, a node type (IAB-node or IAB-donor), a hop count and/or the current state of the connectivity to the parent node. Alternatively, or in parallel, Node A may have been pre-configured or configured by the network with a list of IAB-capable cell identifications.

While Node A is trying to find a new suitable IAB-capable serving cell, the child IAB nodes (Child node 1 and Child node 2) and/or UEs (UE1 and UE2) may still be in connected mode with Node A. If Node A successfully recovers from the RLF before expiration of a pre-configured (or network-configured) period of time, the child nodes and/or the UEs may not be aware of the RLF. However, in the scenario where Node A fails or has failed to recover from the RLF in a timely manner (e.g., before expiration of a pre-configured/network-configured period of time), not only may these child nodes/UEs suffer discontinuity of service, but also all the nodes/UEs in the downstream may also suffer discontinuity of service.

The present embodiments disclose systems, methods, and device where an IAB-node may inform connected nodes (child nodes) or UEs, of the upstream radio conditions. In some embodiments, the upstream radio condition information may enable the child nodes or UEs to decide to stay connected with the IAB-node or to look for another node to connect to.

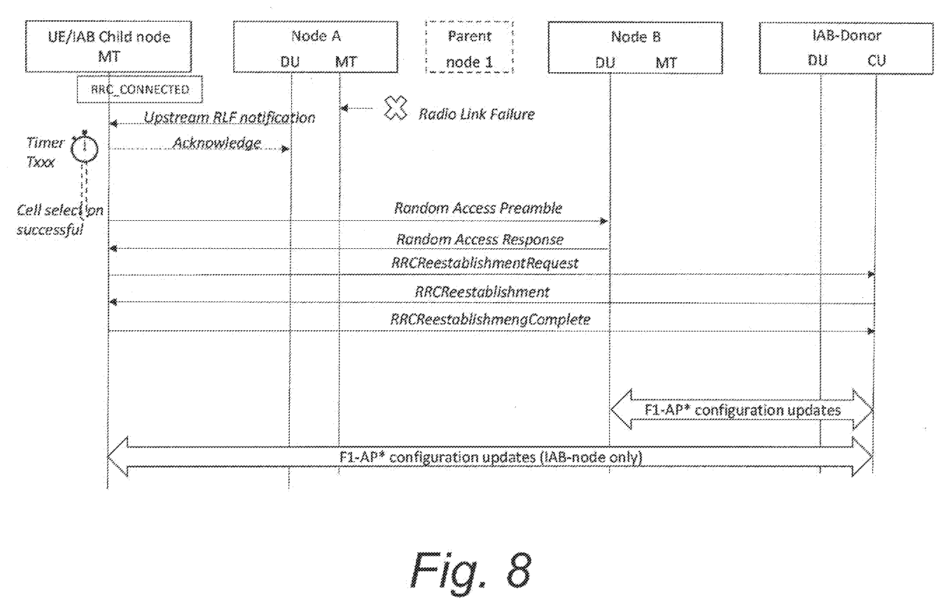

FIG. 8 illustrates an example flow of information transmission/reception and/or processing by a UE and/or an IAB-node connected to a set of IAB-nodes in communication with an IAB-donor, for processing a notification of an RLF. FIG. 8 shows an example scenario for Upstream RLF notification, a notification of an RLF, sent from a node (Node A) and detected on the node's upstream, to the child nodes and/or the directly connected UEs. In one embodiment, upon receiving the notification, each of the child nodes and/or UEs may perform cell selection and, if successful, proceed to RRC reestablishment. As shown in FIG. 8, each of the child nodes and/or UEs, after a successful selection to a new node (Node B), may start the reestablishment procedure through Node B. That is, once a successful selection is made, the child nodes and/or UEs may transmit Random Access Preamble/Response messages, followed by RRCReestablishmentRequest and subsequent messages as illustrated in FIG. 8.

In one embodiment, Upstream RLF notification may be carried by the Adaptation Layer (e.g., a header part or a message body of the Adaptation Layer protocol). In an alternate embodiment, or in addition to, the notifications may be carried by the RLC sublayer, MAC, or a physical layer signaling (e.g., PDCCH). Additionally or alternatively, the notifications may be broadcasted via system information (e.g., MIB, SIB1 or any of the other SIBs) or transmitted in a dedicated manner.

Accordingly, in one embodiment, RRC resident in each of the child nodes and/or UEs may perform cell selection upon receiving a notification indicating the reception of the Upstream RLF notification from lower layers. In the present embodiments, this may be performed even if the radio link to the parent node remains in good condition. The node and/or UE may then start a timer, timer Txxx (e.g., T311 specified in 3GPP TS 38.331), based on the received notification, and upon selecting a suitable cell while timer Txxx is running, the node and/or UE may stop timer Txxx and initiate transmission of RRCReestablishmentRequest to the IAB-donor.

Once the RRC connection is reestablished, the CU of the IAB-donor may update the F1-AP* configurations in Node B as well as the child IAB-node that initiated the RRC reestablishment. In the scenario where the connecting device is a UE, F1-AP* configuration updates are not needed as they do not have the F1-AP* interface. Accordingly, the updated configuration from the IAB-donor may be used to reconfigure the routing topology which was modified or changed due to the RLF.

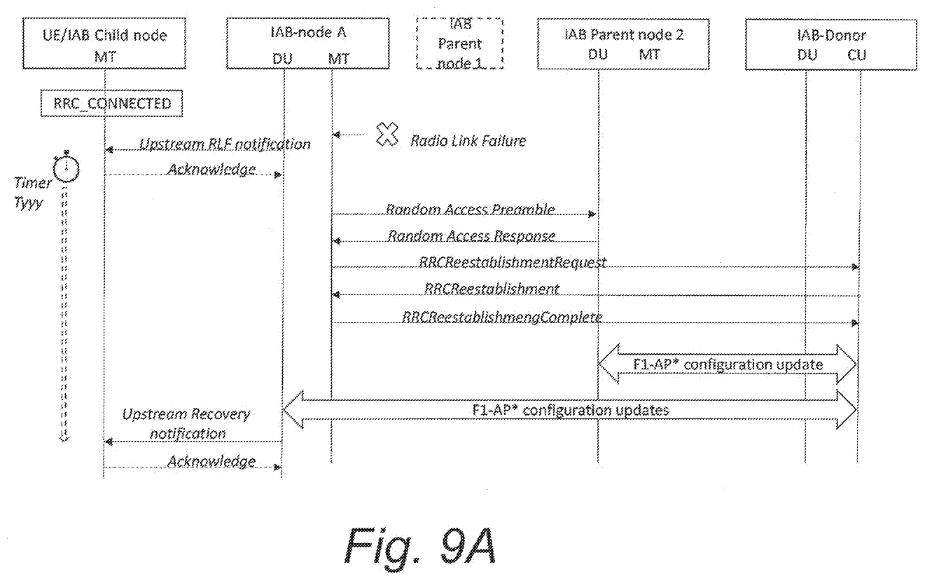

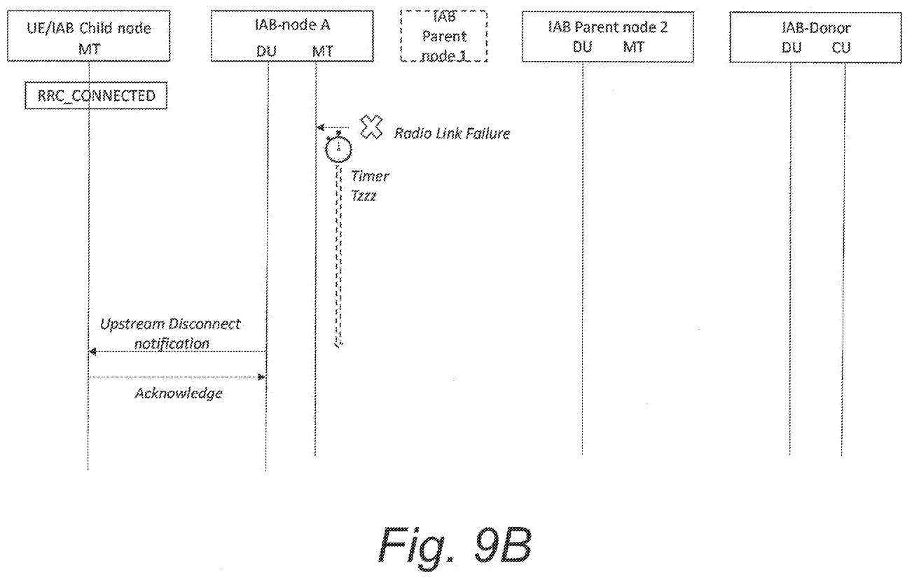

FIG. 9A illustrates an example flow of information transmission/reception and/or processing by a UE and/or IAB-node connected to a set of IAB-nodes in communication with an IAB-donor, based on receiving an Upstream RLF notification. FIG. 9A shows another scenario where the child nodes and/or UEs may start a timer, for example, timer Tyyy, based on receiving an Upstream RLF notification. While the timer Tyyy is running, Node A may attempt to recover the upstream link by performing cell selection. In the scenario depicted in FIG. 9, Node A has successfully found a new parent node (Parent node 2) and may initiate the RRC reestablishment procedure. Node A, based on receiving F1-AP* configuration update from the CU of the IAB-donor, may transmit/send Upstream Recovery notification-a notification indicating that the upstream is recovered—to the child IAB-node and/or the UEs. If timer Tyyy has not expired yet, the child IAB-node and/or the UEs that receive the notification may stop timer Tyyy and stay connected with Node A. If the timer expires before receiving Upstream Recovery notification, the child IAB-node and/or the UEs may perform cell selection/RRC reestablishment as shown in FIG. 8. In one embodiment, the timer value/configuration may be pre-configured. In another embodiment, the timer value/configuration may be configured by the parent node (e.g., Parent node 1) via a dedicated signaling or via a broadcast signaling (e.g., system information, such as MIB, SIB1 or any of the other SIBs).

Similar to the previous scenario, in one embodiment, the Upstream RLF notification may be carried by the Adaptation Layer, RLC, MAC, or a physical layer signaling. Additionally, the notifications may be broadcasted via system information (e.g., MIB, SIB1 or any of the other SIB s) or transmitted in a dedicated manner.

In yet another embodiment for this scenario, RRC resident in each of the child nodes and/or UEs may start timer Tyyy upon receiving Upstream RLF notification from the lower layers. If the node and/or UE receive a notification indicating the reception of the Upstream RLF notification from lower layers while timer Tyyy is running, the node and/or UE may stop timer Tyyy. If timer Tyyy expires, the node and/or UE may then start timer Txxx and upon selecting a suitable cell while the timer is running, the node and/or UE may stop the timer and initiate transmission of RRCReestablishmentRequest.

FIG. 9B illustrates another example flow of information transmission/reception and/or processing by a UE and/or IAB-node connected to a set of IAB-nodes in communication with an IAB-donor, based on not having received an Upstream RLF notification. FIG. 9B shows yet another scenario where Node A may start a timer Tzzz upon detecting an RLF. In this scenario, Node A may or may not send the aforementioned Upstream RLF notification to the child IAB-nodes and/or UEs. While the timer Tzzz is running, Node A may attempt to recover the upstream link by performing cell selection. In the scenario depicted in FIG. 9B, at the timer Tzzz expiry (cell selection failure), Node A may send a notification (e.g. Upstream Disconnect notification) to the child IAB-nodes/UEs notifying the unsuccessful RLF recovery. In this case, the child IAB-nodes/UEs that receive the notification may start the aforementioned timer Txxx and initiate the cell selection procedure as shown in FIG. 8. The notification may be carried by the Adaptation Layer, RLC, MAC, or a physical layer signaling, in a broadcast or a dedicated manner. In one embodiment, the timers Txxx and Tzzz may be the same timer or share same configurations. In another embodiment, the timers Txxx and Tzzz may be different timers or differently configured.

Additionally, notifications that an IAB-node provides to its downstream (children/UEs) may not be limited to RLF or RLF recovery. In some embodiments, the IAB-node may inform child nodes and/or UEs of the signal quality (e.g., Reference Signal Received Power (RSRP), Reference Signal Received Quality (RSRQ)), error rates, and/or any other types of measurements that indicate the radio condition of the upstream. In this case, IAB-nodes and/or UEs may be pre-configured or configured by the network with conditions for initiating cell selection/reestablishment. The notifications may be carried by the Adaptation Layer, RLC, MAC, or a physical layer signaling, in a broadcast or a dedicated manner.

In one embodiment, upon receiving one of the notifications from the parent node, the IAB-node and/or UE may send back or respond with an acknowledgement to the parent node, as shown in FIG. 8, FIGS. 9A and 9B.

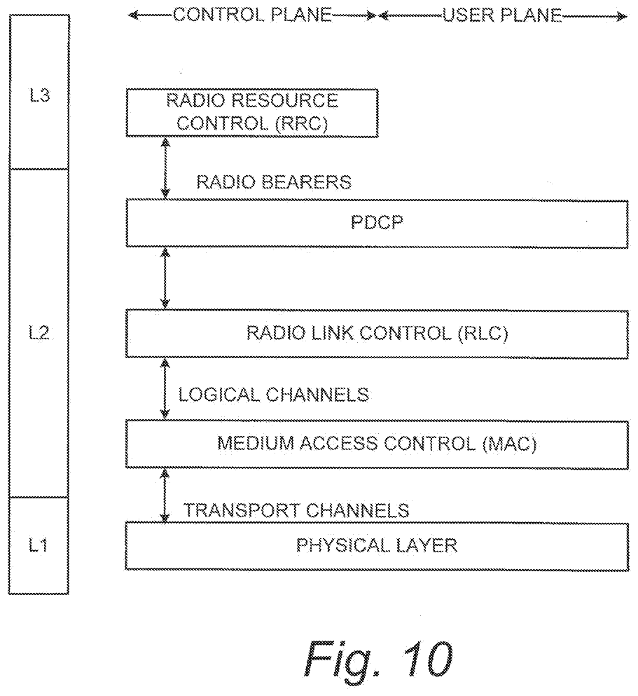

FIG. 10 is a diagram illustrating an example of a radio protocol architecture for the control and user planes in a mobile communications network. The radio protocol architecture for the UE and/or the gNodeB may be shown with three layers: Layer 1, Layer 2, and Layer 3. Layer 1 (L1 layer) is the lowest layer and implements various physical layer signal processing functions. Layer 2 (L2 layer) is above the physical layer and responsible for the link between the UE and/or gNodeB over the physical layer. In the user plane, the L2 layer may include a media access control (MAC) sublayer, a radio link control (RLC) sublayer, and a packet data convergence protocol (PDCP) sublayer, which are terminated at the gNodeB on the network side. Although not shown, the UE may have several upper layers above the L2 layer including a network layer (e.g., IP layer) that is terminated at the PDN gateway on the network side, and an application layer that is terminated at the other end of the connection (e.g., far end UE, server, etc.). The control plane also includes a radio resource control (RRC) sublayer in Layer 3 (L3 layer). The RRC sublayer is responsible for obtaining radio resources (i.e., radio bearers) and for configuring the lower layers using RRC signaling between the IAB-nodes and/or the UE and an IAB-donor.

Addressing Backhaul Conditions with Autonomous Handover

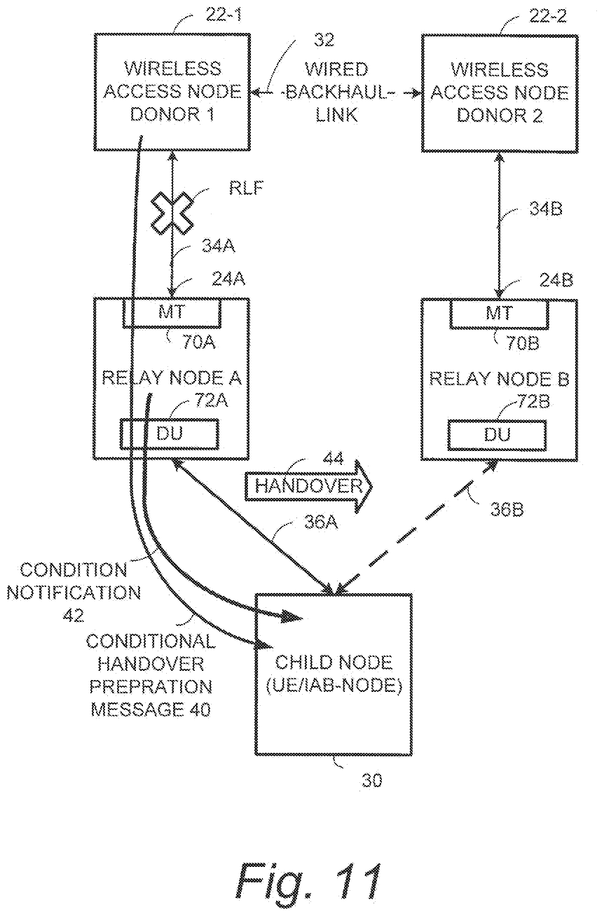

FIG. 11 is a diagrammatic view showing another example telecommunications system in which a conditional autonomous handover may be performed for resolving a wireless link backhaul condition. FIG. 11 shows yet another example diagram of a telecommunications system 20 comprising wireless access node 22-1, also known as Donor node 1; wireless access node 22-2, also known as Donor node 2; IAB-node 24A, also known as Node A or relay node A; IAB-node 24B, also known as Node B or relay node B; and child node 1, also known as child node 30. The child node 30 may be, for example, a user equipment, UE, or Integrated Access and Backhaul (IAB) node, as previously described. The wireless access node 22-1 and wireless access node 22-2 may be connected by a wired backhaul link 32. The other elements of FIG. 11 may be connected by wireless backhaul links, e.g., the wireless access node 22-1 may be connected by wireless backhaul link 34A to IAB-node 24A; the wireless access node 22-2 may be connected by wireless backhaul link 34B to IAB-node 24B; the IAB-node 24A may be connected by wireless backhaul link 36A to child node 30; and the IAB-node 24B may be connected by 36B to child node 30.

The example embodiments and modes of FIG. 11-FIG. 15 concern addressing problematic conditions on a wireless backhaul link using an autonomous handover. In general terms, the wireless access node 22-1 generates and sends to child node 30 a message which comprises information configured to facilitate a conditional handover of the wireless terminal. As used herein, the terms “handover” and “handoff” may be used interchangeably, and generally involve transfer of a connection or communication, at least partially, from one node or set of nodes to another node. Although the message may be of any appropriate type and bear any suitable name, in an example embodiment and mode described herein the message is a reconfiguration message and, for sake of illustration, is arbitrarily and not exclusively known, and shown in FIG. 11, as the conditional handover preparation message 40. The information comprising such message, e.g., the conditional handover preparation message 40, includes at least one identity of a target cell and one or more conditions which at least partially enable the wireless terminal to perform a conditional handover autonomously. In some configurations, the identity of a target cell may comprise one of or a combination of; a physical cell identity (PCI), CellIdentity (a cell identifier to unambiguously identify a cell within a PLMN), a PLMN-identity, a tracking area identity, and a RAN area code. As understood herein, the one or more conditions including a reception of a notification from the wireless relay node, e.g., from IAB-node 24A. Such notification is also known herein and shown in FIG. 11 as condition notification 42, and may be notification of a problematic condition on a wireless backhaul link. Upon reception of the condition notification 42, the child node 30 may perform an autonomous handover, depicted as event 44 in FIG. 11. The performance of the autonomous handover 44 is based on, e.g., enabled by using at least, the information provided in the conditional handover preparation message 40.

Various components and functionalities of the nodes shown in FIG. 11 are further shown in FIG. 12. FIG. 12 is a diagrammatic view showing an example, non-limiting more detailed implementation of at least portions of the system of FIG. 11. FIG. 12 shows wireless access node 22-1 as comprising central unit 50-1 and distributed unit 52-1. The central unit 50-1 and distributed unit 52-1 may be realized by, e.g., be comprised of or include, one or more processor circuits, e.g., node processor(s) 54-1. The one or more node processor(s) 54-1 may be shared by central unit 50-1 and distributed unit 52-1, or each of central unit 50-1 and distributed unit 52-1 may comprise one or more node processor(s) 54-1. Moreover, central unit 50-1 and distributed unit 52-1 may be co-located at a same node site, or alternatively one or more distributed units 52-2 may be located at sites remote from central unit 50-1 and connected thereto by a packet network. The distributed unit 52-1 may comprise transceiver circuitry 56, which in turn may comprise transmitter circuitry 57 and receiver circuitry 58. The transceiver circuitry 56 includes antenna(e) for the wireless transmission. Transmitter circuitry 57 includes, e.g., amplifier(s), modulation circuitry and other conventional transmission equipment. Receiver circuitry 58 comprises, e.g., amplifiers, demodulation circuitry, and other conventional receiver equipment.

As further shown in FIG. 12, node processor(s) 54-1 of wireless access node 22-1 may comprise message generator 60 and handover coordinator 62. The message generator 60 serves to generate, e.g., the conditional handover preparation message 40 as described herein. As mentioned above, the conditional handover preparation message 40 includes information comprising at least one identity of a target cell and one or more conditions for the wireless terminal performing the conditional handover autonomously. The handover coordinator 62 serves to communicate with the target cell, e.g., with another node which may be involved in the handover, so that suitable information and preparation can be obtained for the handover. In the example scenario described herein, the target cell will be a cell served by wireless access node 22-2.

As shown in FIG. 12 the IAB-node 24A, also known as wireless relay node 24A, in an example embodiment and mode comprises relay node mobile termination unit 70A and relay node distributed unit 72A. The relay node mobile termination unit 70A and relay node distributed unit 72A may be realized by, e.g., by comprised of or include, one or more processor circuits, e.g., relay node processor(s) 74A. The one or more relay node processor(s) 74A may be shared by relay node mobile termination unit 70A and relay node distributed unit 72A, or each of relay node mobile termination unit 70A and relay node distributed unit 72A may comprise one or more relay node processor(s) 74A. The relay node distributed unit 72A may comprise transceiver circuitry 76, which in turn may comprise transmitter circuitry 77 and receiver circuitry 78. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment.

FIG. 12 further shows that IAB-node 24A may comprise radio condition detector 80 and notification generator 82. Both condition detector 80 and notification generator 82 may be realized or comprised by relay node processor(s) 74. The notification generator 82 serves to generate the condition notification 42, based on a condition detected by condition detector 80.

It should be understood that, although not illustrated in FIG. 12, the wireless access node 22-2 and IAB-node 24B of FIG. 11 and of FIG. 15 may have similar components and functionalities as the wireless access node 22-1 and IAB-node 24A, respectively, but with differently numbered/alphabetized suffixes denoting comparable components.

FIG. 12 shows child node 30 as comprising, in an example, non-limiting embodiment and mode, transceiver circuitry 86. The transceiver circuitry 86 in turn may comprise transmitter circuitry 87 and receiver circuitry 88. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment. FIG. 12 further shows child node 30, which (as indicated before) may be a user equipment or Integrated Access and Backhaul (IAB) node, as also comprising node processor circuitry, e.g., one or more node processor(s) 90, and interfaces 92, including one or more user interfaces. Such user interfaces may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

In an example, non-limiting embodiment and mode shown in FIG. 12, the child node 30 may include frame/message generator/handler 94 and handover controller 96. As is understood by those skilled in the art, in some telecommunications system messages, signals, and/or data are communicated over a radio or air interface using one or more “resources”, e.g., “radio resource(s)”. The frame/message generator/handler 94 serves to handle messages, signals, and data received from other nodes, including but not limited to the conditional handover preparation message 40 and condition notification 42 described herein.

In a most basic example embodiment and mode, a wireless access node of the technology disclosed herein transmits a message which comprises information configured to facilitate a conditional handover of the wireless terminal, the information comprising at least one identity of a target cell and one or more conditions for the wireless terminal performing the conditional handover autonomously, the conditions including a reception of a notification from the wireless relay node. In a most basic example embodiment and mode of the technology disclosed herein, the wireless terminal, e.g., child node 30, receives such message.

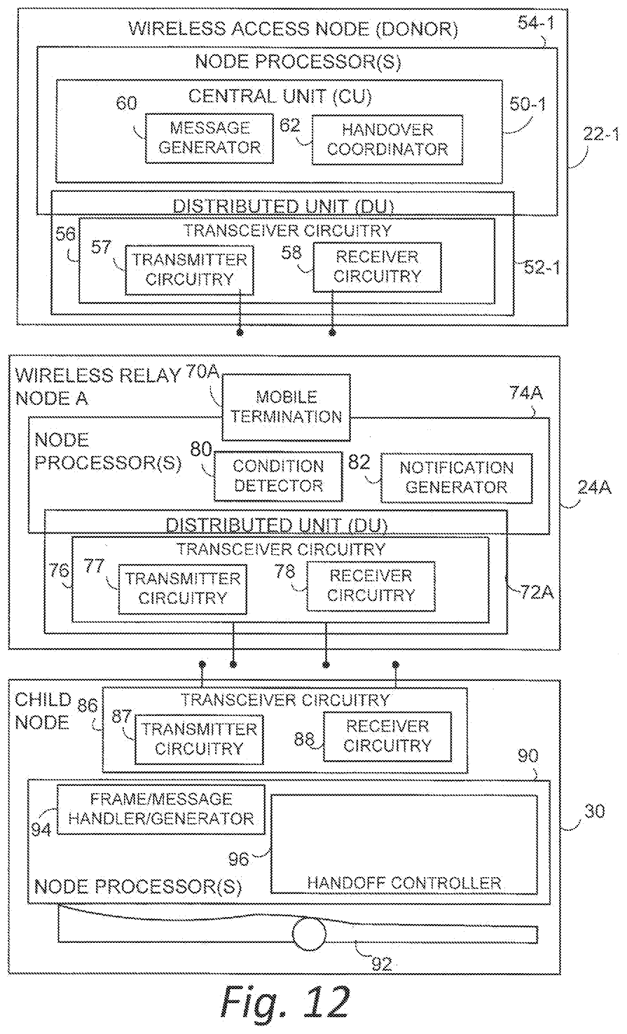

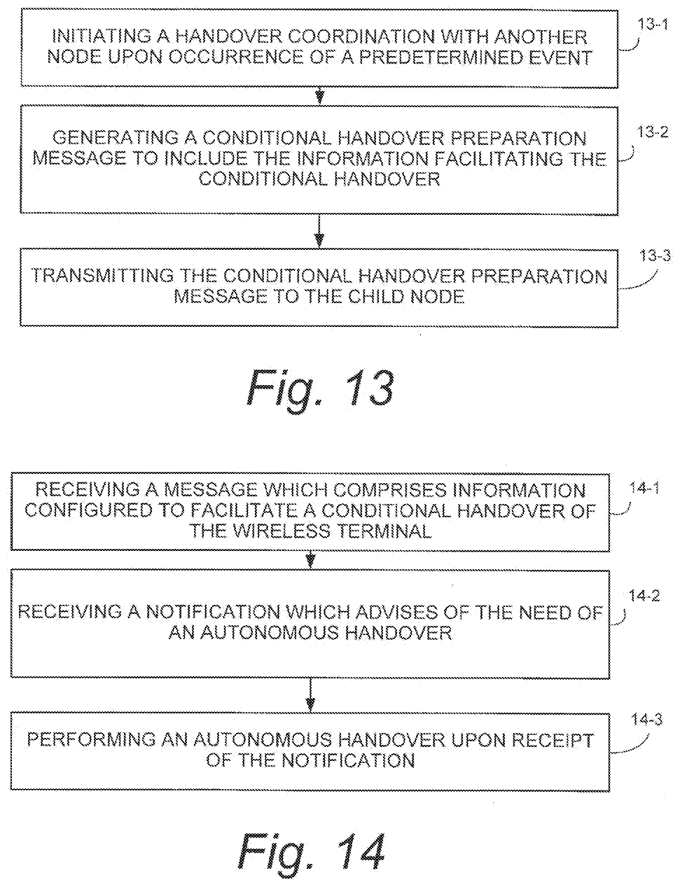

Beyond the basic example embodiment and mode mentioned above, FIG. 13 is a flowchart showing example, optional, non-limiting, basic acts or steps that may be performed by the wireless access node 22-1 of FIG. 11 and FIG. 12. Act 13-1 comprises initiating a handover coordination with another node upon occurrence of a predetermined event. In the example scenario described herein, the other node to be involved in the handover is wireless access node 22-2. The handover coordination of act 13-1 may be performed by handover coordinator 62, which works through a wired backhaul link interface to wireless access node 22-2. The predetermined event may be, for example, receipt of a measurement report from the wireless terminal, e.g., from child node 30, including a measurement regarding a signal received by the wireless terminal from another node, such as wireless access node 22-2. Act 13-2 comprises generating the conditional handover preparation message 40 to include the information facilitating the conditional handover 44. The conditional handover preparation message 40 may be generated, e.g., by message generator 60 of node processor(s) 54-1. Act 13-3 comprises sending or transmitting the conditional handover preparation message to child node 30, e.g., over the wireless backhaul links 34A and 36A and thus via IAB-node 24A.

Beyond the basic example embodiment and mode mentioned above, FIG. 14 is a flowchart showing example, optional, non-limiting, basic acts or steps that may be performed by child node 30 of FIG. 11 and FIG. 12. Act 14-1 comprises receiving a message which comprises information configured to facilitate a conditional handover of the wireless terminal. Such message may be, for example, the conditional handover preparation message 40 described herein, which comprises at least one identity of a target cell and one or more conditions for the wireless terminal performing the conditional handover autonomously. Act 14-2 comprises receiving the condition notification 42 from an appropriate node, such as IAB-node 24A, which advises of the possible need of an autonomous handover. Act 14-3 comprises, upon receipt of the condition notification 42, performing an autonomous handover 44 to another node, e.g., to wireless access node 22-2 through IAB-node 24B.

In an example scenario shown in FIG. 11, IAB-node 24A, also known as Node A or wireless access node 24A, may detect a radio condition, such as a radio link failure, RLF, on the upstream link to its parent node, e.g. wireless access node 22-1 or Donor 1. In the example scenario of FIG. 11, the Child Node 30, which may be an IAB-node or an UE, was configured by the donor-node wireless access node 22-1 with a conditional handover, e.g., conditional handover preparation message 40 which may be a reconfiguration with sync, in advance, which allows the child node 30 to autonomously perform a handover to a designated cell when one or more conditions configured by the RRC of the Donor 1 are satisfied. In some configurations, the conditions may include reception of some of the aforementioned notifications from a parent node, such as Upstream RLF notification. When such conditions are met, the Child Node 1, e.g., child node 30, may start accessing the designated cell (e.g. Node B/Donor 2, also called IAB-node 24B/wireless access node 22-2) and perform a handover procedure. In one example embodiment and mode, the Donor nodes 1 and 2 may be physically collocated or even the same entity. In another example embodiment and mode, these two donor nodes, e.g., wireless access node 22-1 and wireless access node 22-2, may be separate nodes, mutually connected by a wired backhaul link (as shown in FIG. 11). It is assumed that prior to providing the configuration for the conditional handover to Child node 30, the two donor nodes wireless access node 22-1 and wireless access node 22-2 may perform negotiations/coordination with regard to the handover, e.g., act 11-3, described above.

FIG. 15 depicts an example message flow for the scenario shown in FIG. 11. In the situation of FIG. 15, the child node 30 is in connected mode as shown by act 15-1. As act 15-3 the currently serving donor node, Donor 1 or wireless access node 22-1, may start a handover coordination with a node serving a potential target cell, e.g., Donor 2 or wireless access node 22-2. The coordination of act 15-3 may comprise sharing of identifications of the Child Node 1, e.g., child node 30; security parameters; and radio link configurations. As shown in FIG. 15, the coordination of act 15-3 may be triggered by act 15-2, e.g., receipt of a measurement report(s) transmitted by the Child Node 1, wherein the child node 30 reports sufficient signal quality observed from the Node B, e.g., from IAB-node 24B.

After the coordination of act 15-3 is completed, as act 15-4 the Child Node 30 (in the RRC_CONNECTED state, as indicated by act 15-1) may receive the conditional handover preparation message 40. In an example embodiment and mode, the conditional handover preparation message 40 may be a RRCReconfiguration message comprising potential target cells, e.g. the cell served by Node B or IAB-node 24B, and one or more conditions for an autonomous handover. In the example flow of FIG. 15, the conditions may include a reception of the Upstream RLF notification. The other non-limiting examples of conditions may include or comprise signal quality thresholds for the downlink signals from the currently serving node, e.g., Node A=IAB-node 24A), as well as some of the other aforementioned notifications, such as Upstream Disconnect notification.

In the example flow shown in FIG. 15, as act 15-5 the Node A, e.g., IAB-node 24A, may detect an RLF on the upstream link, e.g., on wireless backhaul link 32. The condition on the wireless backhaul link 32 may be detected by the condition detector 80 of IAB-node 24A. The Node A may then send the Upstream RLF notification 42 to its child nodes/UEs, including the Child node 30. The condition notification 42 may be generated by notification generator 82. As optional act 15-7, Child node 30 may send back an acknowledgement. Moreover, due to the configured conditions, as act 15-8 the child node 30 may initiate a conditional handover to the configured target cell, e.g., in the example scenario, the cell served by IAB-node 24B, by performing a random access procedure. The random access procedure in which child node 30 participates comprises, as act 15-8, sending a Random Access Preamble message to IAB-node 24B and, as act 15-9, receiving a Random Access Response message from IAB-node 24B. Act 15-10 comprises the child node 30 sending a RRCReconfigurationComplete message to the donor of the target cell, e.g., Donor 2=wireless access node 22-2 via Node B=IAB-node 24B. As act 15-11 wireless access node 22-2 may use F1-AP* to update the routing configurations at the Node B for the Child Node 1, e.g., at IAB-node 24B for child node 30, and as act 15-12 may interact with wireless access node 22-1 to report the completion of the conditional handover. The wireless access node 22-1 may then release the resources saved for child node 30.

Accordingly, in the example embodiment and mode of FIG. 11-FIG. 15, an IAB-node or a UE may be configured with a conditional handover with conditions, comprising a reception of a notification representing the radio condition of the upstream radio link of the parent node and at least one identification of a target node. Upon receiving such a notification, the IAB-node or the UE may then perform an autonomous handover to the cell served by the target node.

Addressing Backhaul Conditions Involving Redundant Connections

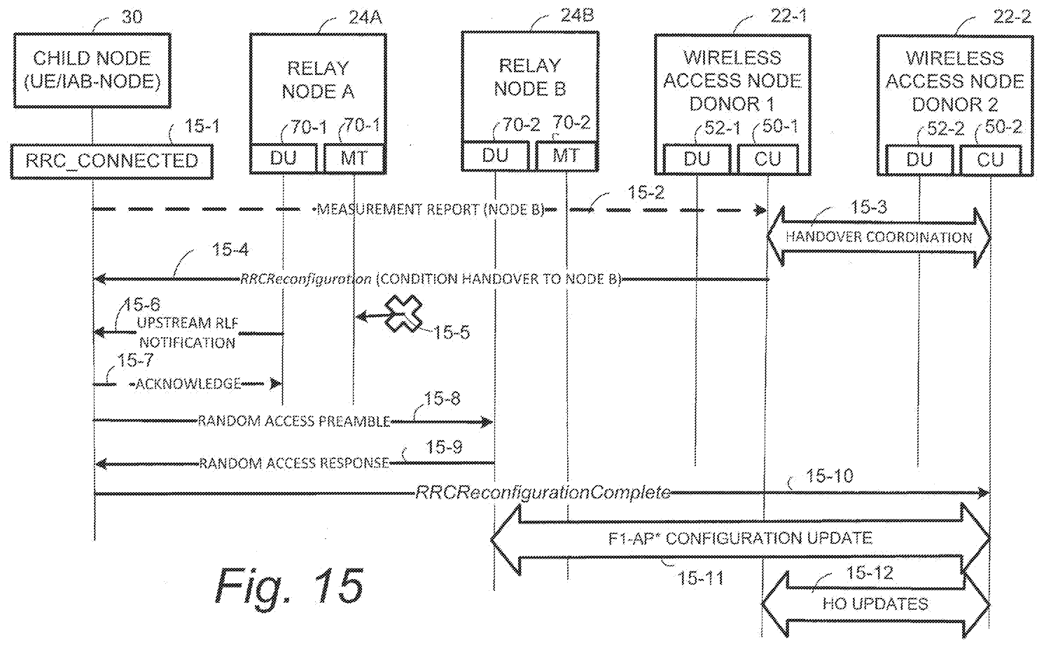

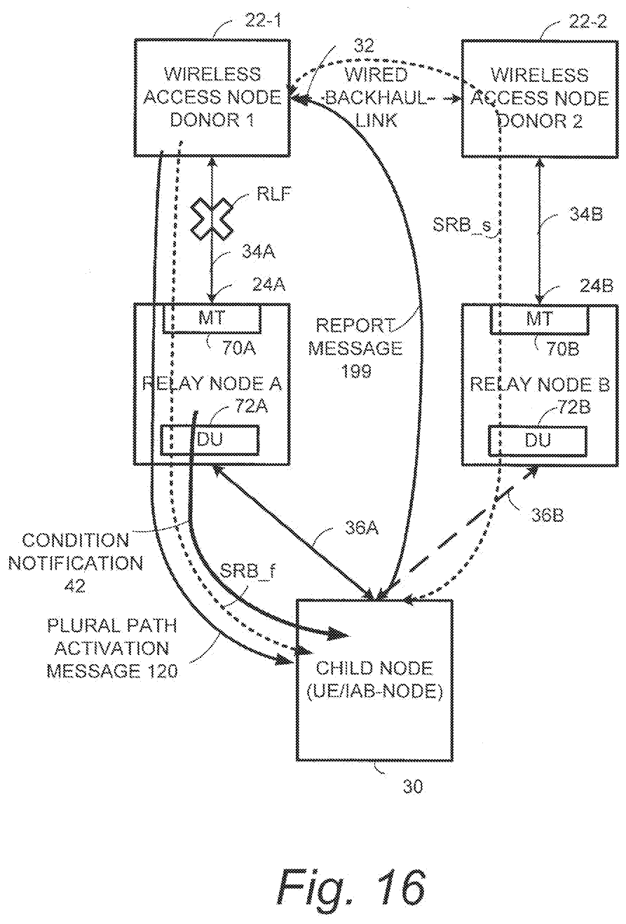

FIG. 16 is a diagrammatic view showing another example telecommunications system in which a wireless link backhaul condition may be resolved when redundant links are utilized. FIG. 16 shows yet another example diagram of a telecommunications system 20 which, like the telecommunications system 20 of FIG. 15, comprises wireless access node 22-1, also known as Donor node 1; wireless access node 22-2, also known as Donor node 2; IAB-node 24A, also known as Node A or relay node A; IAB-node 24B, also known as Node B or relay node B; and child node 1, also known as child node 30. The child node 30 may be, for example, a user equipment, UE, or Integrated Access and Backhaul (IAB) node, as previously described. The wireless access node 22-1 and wireless access node 22-2 may be connected by a wired backhaul link 32. The other elements of FIG. 16 may be connected by wireless backhaul links, e.g., the wireless access node 22-1 may be connected by wireless backhaul link 34A to IAB-node 24A; the wireless access node 22-2 may be connected by wireless backhaul link 34B to IAB-node 24B; the IAB-node 24A may be connected by wireless backhaul link 36A to child node 30; and the IAB-node 24B may be connected by 36B to child node 30.

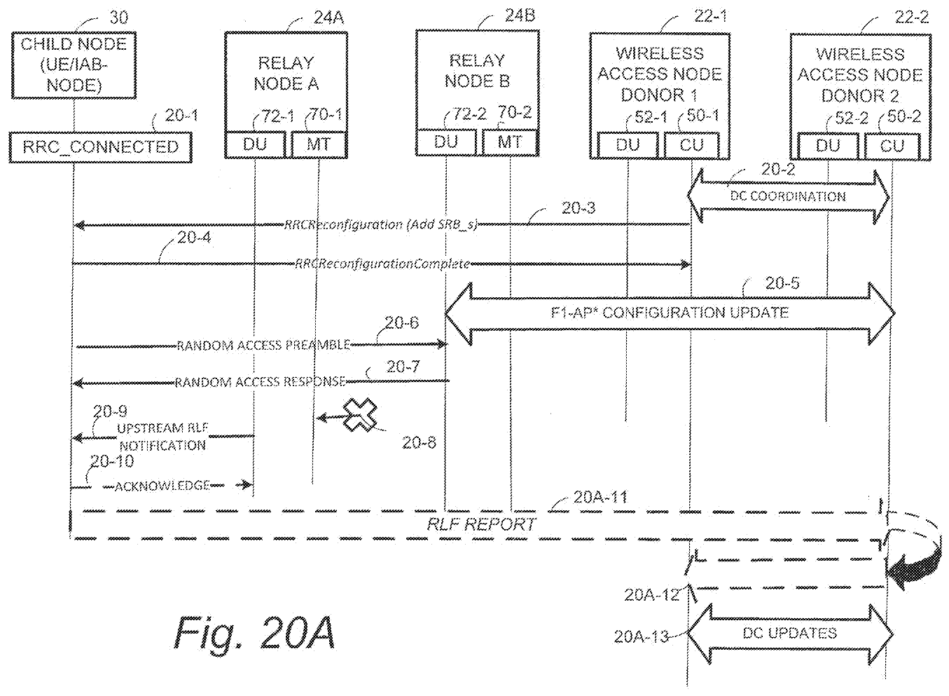

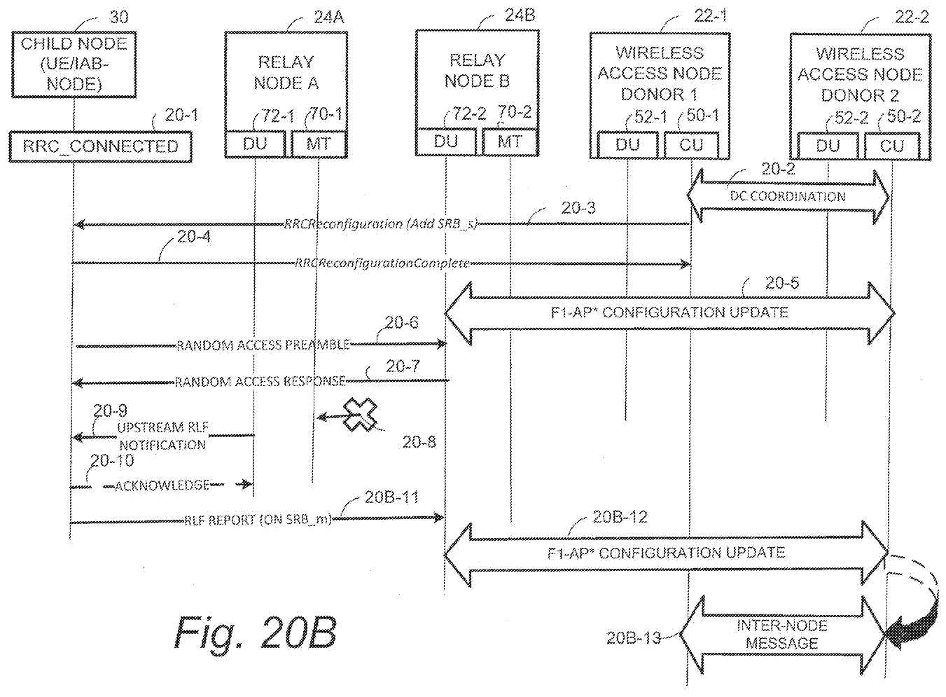

The example embodiments and modes of FIG. 16-FIG. 20A, FIG. 20B concern addressing problematic conditions on a wireless backhaul link using redundant links. In general terms, the wireless access node 22-1 generates and sends to child node 30 at message which comprises information configured to activate plural signaling data path, such as first signaling data path SRB_f and second signaling data path SRB_s shown in FIG. 16. The first signaling data path SRB_f is established between wireless access node 22-1 and the wireless terminal also known as child node 30, and has its signaling data routed via wireless access node 22-1 and IAB-node 24A. In one configuration, the second signaling data path SRB_s may be established between wireless access node 22-2 and child node 30 and has its signaling data relayed by IAB-node 24B. In another configuration (not shown in FIG. 16), the second signaling data path SRB_s may be established directly established between wireless access node 22-2 and child node 30 without being relayed by an IAB-node. It should be noted that either of the first or second signaling data path may be a master signaling radio bearer, e.g., the signaling data bearer that is established first, and the other signaling data path may be a secondary signaling radio bearer that may be added after the master signaling radio bearer is established.

Although the message(s) configured to activate the plural signaling data paths may be of any appropriate type and bear any suitable name, in an example embodiment and mode described herein the message is a reconfiguration message and, for sake of illustration, is arbitrarily and not exclusively known, and shown in FIG. 16, as the plural path activation message 120. The plural path activation message 120 is received by the child node 30, after which both the first signaling data path SRB_f and the second signaling data path SRB_s are activated. Should the child node 30 thereafter receive a notification from the IAB-node 24A, the child node 30 may generate a report message (also referred as a failure information message) and transmit the message through the second signaling path SRB_s. The report message may include information based on the notification, and the notification may be based on a radio condition detected on the first signaling data path.

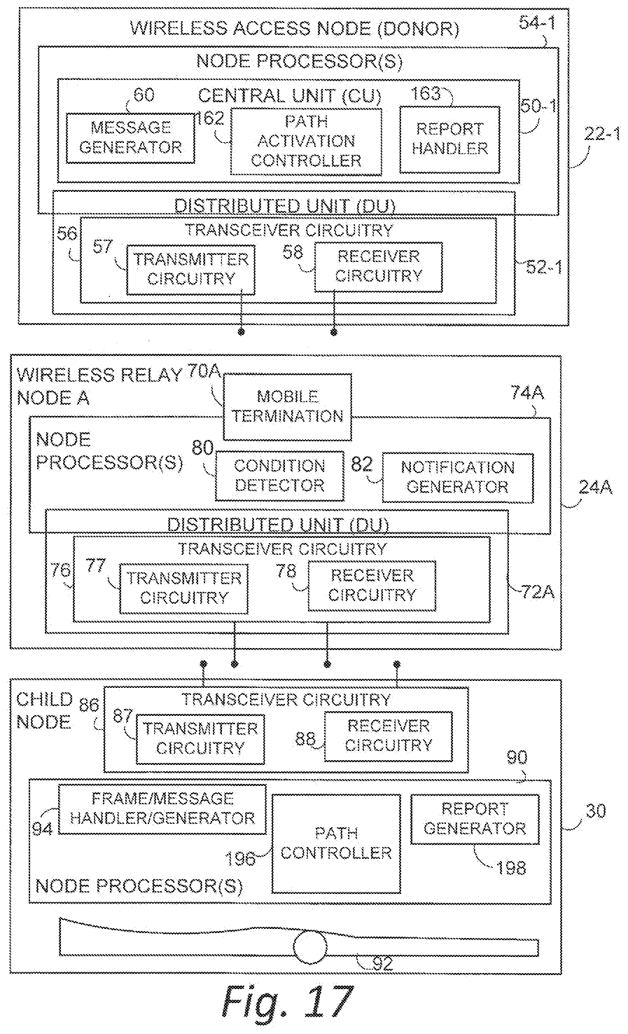

Various components and functionalities of the nodes shown in FIG. 16 are further shown in FIG. 17. FIG. 17 is a diagrammatic view showing an example, non-limiting more detailed implementation of at least portions of the system of FIG. 16. Components of FIG. 17 which have similar names to the components of FIG. 12 also have comparable function. FIG. 17 shows wireless access node 22-1 as comprising central unit 50-1 and distributed unit 52-1. The central unit 50-1 and distributed unit 52-1 may be realized by, e.g., by comprised of or include one or more processor circuits, e.g., node processor(s) 54-1. The one or more node processor(s) 54-1 may be shared by central unit 50-1 and distributed unit 52-1 or each of central unit 50-1 and distributed unit 52-1 may comprise one or more node processor(s) 54-1. Moreover, central unit 50-1 and distributed unit 52-1 may be co-located at a same node site, or alternatively one or more distributed units 52-2 may be located at sites remote from central unit 50-1 and connected thereto by a packet network. The distributed unit 52-1 may comprise transceiver circuitry 56, which in turn may comprise transmitter circuitry 57 and receiver circuitry 58. The transceiver circuitry 56 includes antenna(e) for the wireless transmission. Transmitter circuitry 57 includes, e.g., amplifier(s), modulation circuitry and other conventional transmission equipment. Receiver circuitry 58 comprises, e.g., amplifiers, demodulation circuitry, and other conventional receiver equipment.

As further shown in FIG. 17, node processor(s) 54-1 of wireless access node 22-1 may comprise message generator 60; path activation controller 162; and report handler 163. The message generator 60 serves to generate, e.g., plural path activation message 120 as described herein. The path activation controller 162 serves, e.g., to activate the plural paths, including first signaling data path SRB_f and second signaling data path SRB_s. The report handler 163 is configured to receive and process a report from child node 30 which is based on a notification representing a radio condition detected on one of the signaling data paths.

As shown in FIG. 17 the IAB-node 24A, also known as wireless relay node 24A, in an example embodiment and mode comprises relay mobile termination unit 70A and relay distributed unit 72A. The relay mobile termination unit 70A and relay distributed unit 72A may be realized by, e.g., by comprised of or include one or more processor circuits, e.g., relay node processor(s) 74A. The one or more relay node processor(s) 74A may be shared by relay mobile termination unit 70A and relay distributed unit 72A, or each of mobile termination unit 70A and distributed unit 72A may comprise one or more relay node processor(s) 74A. The relay node distributed unit 72A may comprise transceiver circuitry 76, which in turn may comprise transmitter circuitry 77 and receiver circuitry 78. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment.

FIG. 17 further shows that IAB-node 24A may comprise radio condition detector 80 and notification generator 82. Both condition detector 80 and notification generator 82 may be realized or comprised by relay node processor(s) 74. The notification generator 82 serves to generate the condition notification 42, based on a condition detected by condition detector 80.

It should be understood that, although not illustrated in FIG. 17, the wireless access node 22-2 and IAB-node 24B of FIG. 16 may have similar components and functionalities as the wireless access node 22-1 and IAB-node 24A of FIG. 17, respectively, but with differently numbered/alphabetized suffixes denoting comparable components.

FIG. 17 shows child node 30 as comprising, in an example, non-limiting embodiment and mode, transceiver circuitry 86. The transceiver circuitry 86 in turn may comprise transmitter circuitry 87 and receiver circuitry 88. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment. FIG. 17 further shows child node 30, which (as indicated before) may be a user equipment or Integrated Access and Backhaul (IAB) node, as also comprising node processor circuitry, e.g., one or more node processor(s) 90, and interfaces 92, including one or more user interfaces. Such user interfaces may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

In an example, non-limiting embodiment and mode shown in FIG. 17, the child node 30 may include frame/message generator/handler 94; path controller 196; and report generator 198. As is understood by those skilled in the art, in some telecommunications system messages, signals, and/or data are communicated over a radio or air interface using one or more “resources”, e.g., “radio resource(s)”. The frame/message generator/handler 94 serves to handle messages, signals, and data received from other nodes, including but not limited to incoming messages such as the plural path activation message 120 and condition notification 42 as described herein, as well as outgoing messages such as a report message 199 generated by report generator 198. The path controller 196 works in conjunction with establishing, activating, and de-activating signaling data paths in which child node 30 participates, such as first signaling data path SRB_f and second signaling data path SRB_s.

In a most basic example embodiment and mode, a wireless access node of the technology disclosed herein transmits at least one message which activates a first signaling data path and a second signaling data path. The first signaling data path, e.g., first signaling data path SRB_f, and the second signaling data path, e.g., second signaling data path SRB_s, are both established between the wireless access node, e.g., wireless access node 22-1, and the wireless terminal, e.g., child node 30. Signaling data on the first signaling data path is relayed by a wireless relay node, e.g., IAB-node 24A. In a most basic example embodiment and mode of the technology disclosed herein, the wireless terminal, e.g., child node 30, receives such message. Further, the child node 30 may, as a condition on the first signaling data path SRB_f arises, processes a notification received from the wireless relay node and, upon reception of the notification, transmit a report message to the wireless access node on the second signaling data path. The report message comprises information based on the notification, and the notification is based on a radio condition detected on the first signaling data path.

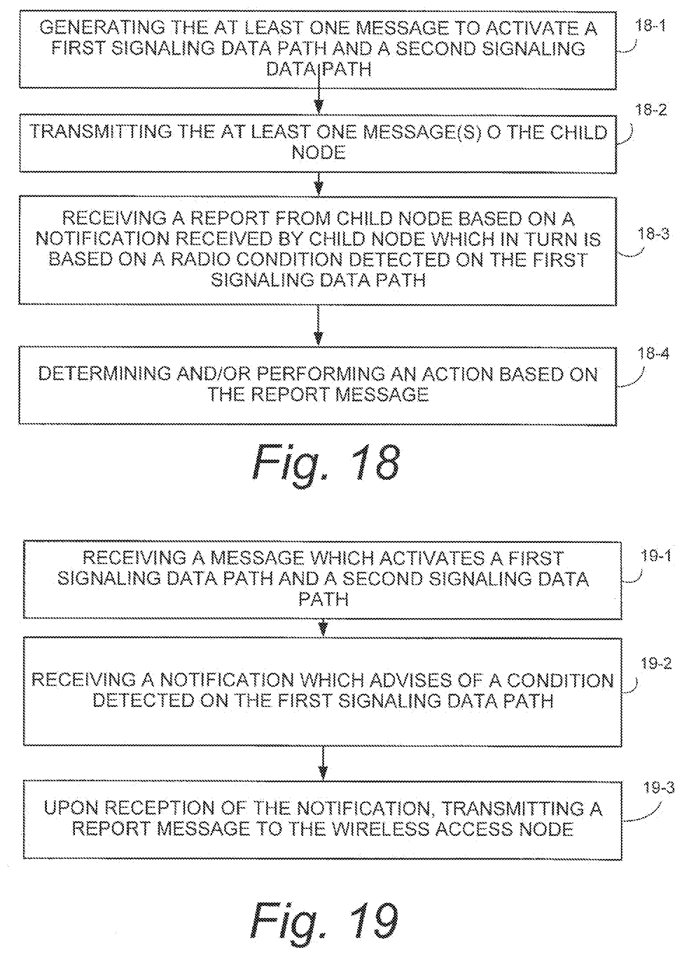

Beyond the basic example embodiment and mode mentioned above, FIG. 18 is a flowchart showing example, non-limiting, basic acts or steps that may be performed by the wireless access node 22-1 of FIG. 16 and FIG. 17. Act 18-1 comprises generating the at least one message, e.g., the message(s) being configured to activate a first signaling data path and a second signaling data path. As mentioned above, the first signaling data path and the second signaling data path are established between the wireless access node and the wireless terminal, and the signaling data on the second signaling data path is relayed by a wireless relay node. The message(s) of act 18-1, which may be termed as the plural path activation message(s) 120, may be generated by message generator 60. Act 18-2 comprises transmitting the at least one message(s), e.g., the plural path activation message 120, to the child node 30. The plural path activation message 120 may be transmitted by the transmitter circuitry 57 of wireless access node 22-1.

A problematic condition may thereafter arise, and for sake of example is illustrated herein as a radio link failure occurring on first signaling data path SRB_f. Act 18-3 comprises the wireless access node 22-1 receiving a report from child node 30, and in particular receiving a report message comprising information based on a notification received by child node 30. The notification is preferably based on a radio condition detected on the first signaling data path. Such notification may be the condition notification 42 described herein. The report message, e.g., report message 199, may be received by receiver circuitry 58 and handled by report handler 163. Act 18-4 comprises determining and/or performing an action based on the report message. An example of such an action for act 18-4 may be, for example, deactivating the first signaling data path SRB_f.

Beyond the basic example embodiment and mode mentioned above, FIG. 19 is a flowchart showing example, non-limiting, basic acts or steps that may be performed by a child node 30 of FIG. 16 and FIG. 17. Act 19-1 comprises receiving a message which activates a first signaling data path and a second signaling data path, e.g., the first signaling data path SRB_f and the second signaling data path SRB_s. Act 19-2 comprises receiving a notification of a condition detected on the first signaling data path SRB_f. The message of act 19-1 may be the plural path activation message 120 described herein, generated by wireless access node 22-1; the message of act 19-2 may be the condition notification 42 described herein, generated by IAB-node 24A. The messages of both act 19-1 and act 19-2 may be received through receiver circuitry 88 and processed by frame/message generator/handler 94. Act 19-3 comprises, upon reception of the notification of act 19-2, transmitting a report message to the wireless access node. The report message comprises information based on the notification; the notification is based on a radio condition detected on the first signaling data path.

In an example scenario shown in FIG. 16, child node 30, e.g., Child Node 1, which may be an IAB-node or a UE, establishes redundant connections (i.e. multiple connections or simultaneous connections, such as Dual Connectivity (DC)) for at least the signaling radio bearer (SRB) (and possibly the data radio bearers (DRBs) as well). In the scenario of FIG. 16, the SRB may be carried by two (or more) separate paths: (1) signaling data path SRB_f which includes wireless access node 22-1, IAB-node 24A, and child node 30, e.g., Donor 1—Node A—Child Node 1 (SRB_f) and (2) signaling data path SRB_s which involves wireless access node 22-1, wireless access node 22-2, IAB-node 24B, and 30, e.g., Donor1—Donor2—Node B—Child Node 1 (SRB_s). In one configuration, the wireless access node 22-1, e.g., Donor 1, may act as a master node while wireless access node 22-2, e.g., Donor 2, may behave as a secondary (or slave) node. In another configuration, the wireless access node 22-1, e.g., Donor 1, may act as a secondary (or slave) node while wireless access node 22-2, e.g., Donor 2, may behave as a master node. In one configuration, signaling data may duplicated and transmitted on the multiple paths, e.g., on first signaling data path SRB_f and second signaling data path SRB_s. In another configuration, packets for signaling data are split into the two paths, e.g., first signaling data path SRB_f and second signaling data path SRB_s, for increased throughput.

After establishing an RRC connection to wireless access node 22-1, e.g., to Donor 1, the Child Node 30 may be provisioned with a configuration with a secondary cell served by the wireless access node 22-2 and IAB-node 24B. Following the configuration, the Child Node 30 may use the multiple paths for transmitting/receiving signaling bearer (and possibly data bearers). In the present example embodiment and mode, at least one of the parent nodes of the Child node 30 may send some of the aforementioned notifications representing the radio condition of its upstream radio link. That is, either IAB-node 24A or IAB-node 24B may send such notifications as and when the radio condition(s) occur. For example, similar to the previously disclosed embodiments, when detecting a radio link failure (RLF) on the upstream radio link of IAB-node 24A, the IAB-node 24A may send the Upstream RLF notification to its child nodes including the Child Node 30. In this case, the Child Node 30 may attempt to report this event to at least one of the serving donors using a path not affected by the RLF. In the scenario shown in the FIG. 16, the Child Node 30 may use the path SRB_s to send the report to the wireless access node 22-2 through the IAB-node 24B. In some example configurations, the report may be also conveyed to the wireless access node 22-1, e.g., to Donor 1, which may decide to reconfigure updated redundant connections to the Child Node 30.

FIG. 20A depicts example, basic, representative acts or steps of a message flow for a first example system scenario shown in FIG. 16. FIG. 20A shows an example message flow for the scenario shown in FIG. 16, where the Child Node 30 may first establish an RRC connection with the Donor 1, which results in setting up the SRB_f. While the Child node 30 is in RRC_CONNECTED (depicted as act 20-1 in FIG. 20A), the wireless access node 22-1 may decide to configure an additional connection and, as represented by act 20-2, start a coordination with wireless access node 22-2. It should be noted that, similar to the previously disclosed embodiment, the wireless access node 22-1 and the wireless access node 22-2 may be physically collocated or separated entities, or even the same entity. As act 10-3 wireless access node 22-1 may send to the Child Node 30 RRCReconfiguration comprising a configuration to add a new SRB (SRB_s) and an identity of the cell to serve SRB_s, the identity of the cell served by IAB-node 24B. As act 20-Child Node 30 may then acknowledge to RRCReconfiguration by sending a RRCReconfigurationComplete message. As act 20-5 wireless access node 22-2 may use F1-AP* to update the routing configurations at the Node B, e.g., at IAB-node 24B, for the Child Node 30.

As act 20-6 the child node 30 may initiate a random access procedure by sending a Random Access Preamble message, and as act 20-7 may receive a Random Access Response message. The random access procedure of act 20-6 and act 207 serves to synchronize child node 30 to the IAB-node 24B.

Eventually, as act 20-8, IAB-node 24A may detect a specified radio condition on its upstream link. In the example scenario shown in FIG. 20A, the specified upstream condition may be a radio link failure (RLF), but could be other radio link condition(s) as well. Act 20-9 comprises IAB-node 24A sending a notification, e.g., condition notification 42, to child node 30. In the example scenario shown in FIG. 20A, in which the specified upstream condition may be a radio link failure (RLF), the condition notification 42 may be an Upstream RLF notification which may be sent to child nodes/UEs of IAB-node 24A, including but not necessarily limited to Child Node 30. As act 20-10 Child Node 30 may send back an acknowledgement of the condition notification 42 to IAB-node 24A. Further, upon receipt of the notification of act 20-9, e.g., upon receipt of condition notification 42, as act 20-11 the child node 30 may generate and transmit a report message reporting the RLF occurring on the path for SRB_f. The report message 199 may be generated by report generator 198 upon receipt of the condition notification 42.

In one example embodiment and mode shown in FIG. 20A, the report message of act 20-11 is an RRC message of act 20-11 directed to the Donor 1, e.g., to wireless access node 22-1. As Act 20A-12, the Donor 2, e.g., wireless access node 22-2, may transfer the report message to the Donor 1 using an inter-node message on the wired backhaul link 32. Upon receipt of the report message, the Donor 1 may coordinate with the Donor 2 to deactivate the problematic signaling data path (e.g. the first signaling data path SRB_f), as shown in Act 20A-13. In one implementation, the wireless access node 22-1 aka Donor 1, now recognizing that SRB_f is torn down, may reconfigure the Child Node 30 with a new SRB configuration, e.g. releasing SRB_f. by sending another RRCReconfiguration. In parallel, wireless access node 22-1 may also use the F1-AP* to update the routing configuration of the Child Node 30, if the Child Node 30 is an IAB-node.

FIG. 20B depicts example, basic, representative acts or steps of a message flow for a first example system scenario shown in FIG. 16. In another example embodiment and mode shown in FIG. 20B, the report message 42 of act 20B-11 is addressed to the parent node, e.g., IAB-node 24B using the Adaptation Layer, the RLC Layer, the MAC Layer or the physical layer signaling. Then, as act 20B-12, the parent node IAB-node 24B may convey the report message using a protocol, e.g., F1-AP*, to the Donor 2, e.g., to wireless access node 22-2. As act 20B-13 the wireless access node 22-2 may redirect the report message to the Donor 1, e.g., wireless access node 22-1, using an inter-node message on the wired backhaul link 32. Similar to the previous embodiment and mode shown in FIG. 20A, in one implementation, the wireless access node 22-1 aka Donor 1, now recognizing that SRB_f is torn down, may reconfigure the Child Node 30 with a new SRB configuration, e.g. releasing SRB_f. by sending another RRCReconfiguration. In parallel, wireless access node 22-1 may also use the F1-AP* to update the routing configuration of the Child Node 30, if the Child Node 30 is an IAB-node.

In either the example embodiment and mode of FIG. 20A or the example embodiment and mode of FIG. 20B, upon receipt of the report message 199 the wireless access node 22-1 may take appropriate action, such as for example, deactivating the first signaling data path SRB_f.

In one example embodiment and mode, the Child Node is preconfigured to send the report message upon receiving one of designated notifications from the parent node, e.g., from IAB-node 24A. In another example embodiment and mode, the Child Node is configured by an IAB-donor node to send the report message upon receiving one of designated notifications. In this latter case, RRCReconfiguration may be used to configure the designated notifications for sending report message.

Accordingly, in the example embodiment and mode of FIG. 16-FIG. 20A and FIG. 20B, an IAB-node or a UE configured with multiple radio paths for the signaling radio bearer(s) may receive from one parent node a notification representing the radio condition of the upstream radio link of one of the parent nodes. The IAB-node or the UE may use one or more other radio paths to send a report message reporting the radio condition to at least one IAB-donor node. The IAB-donor node that receives the report message may initiate reconfiguration for updated topology and/or routing of the relay network accordingly.

Preventing Routing Loops in Cell Selection

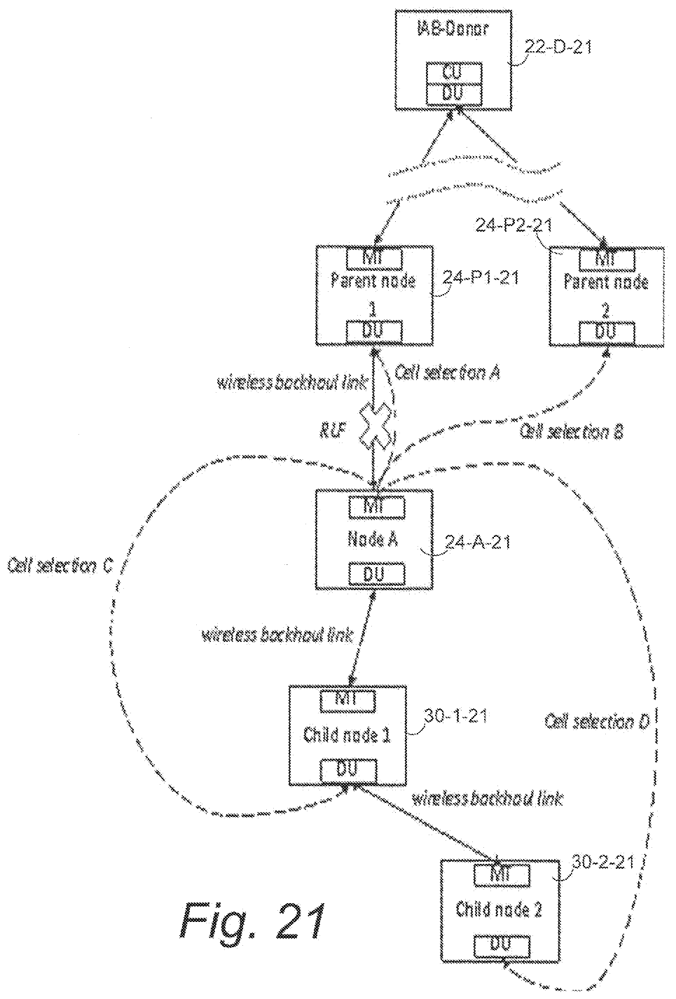

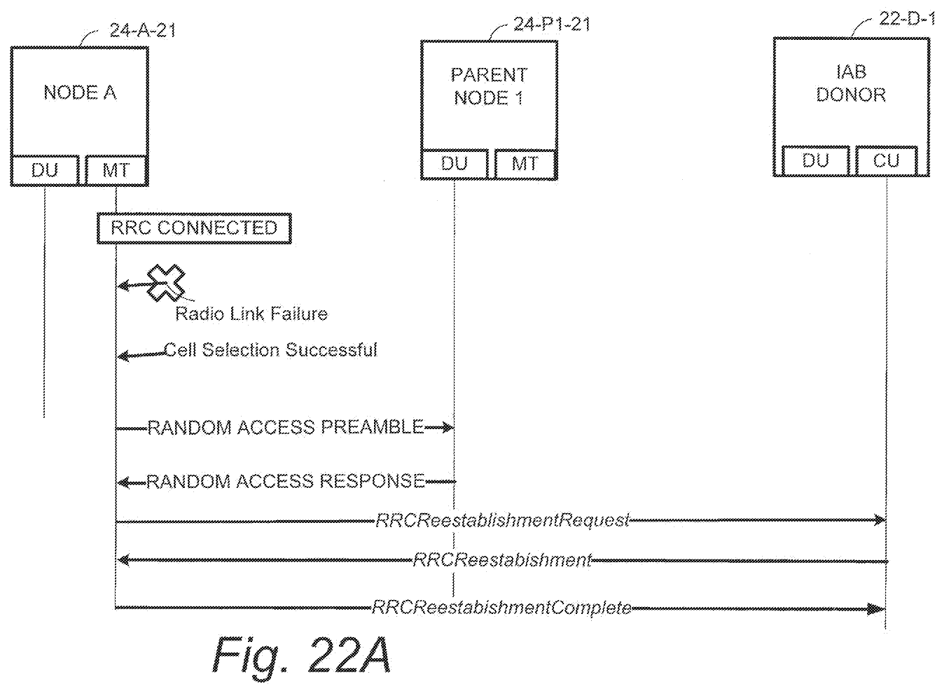

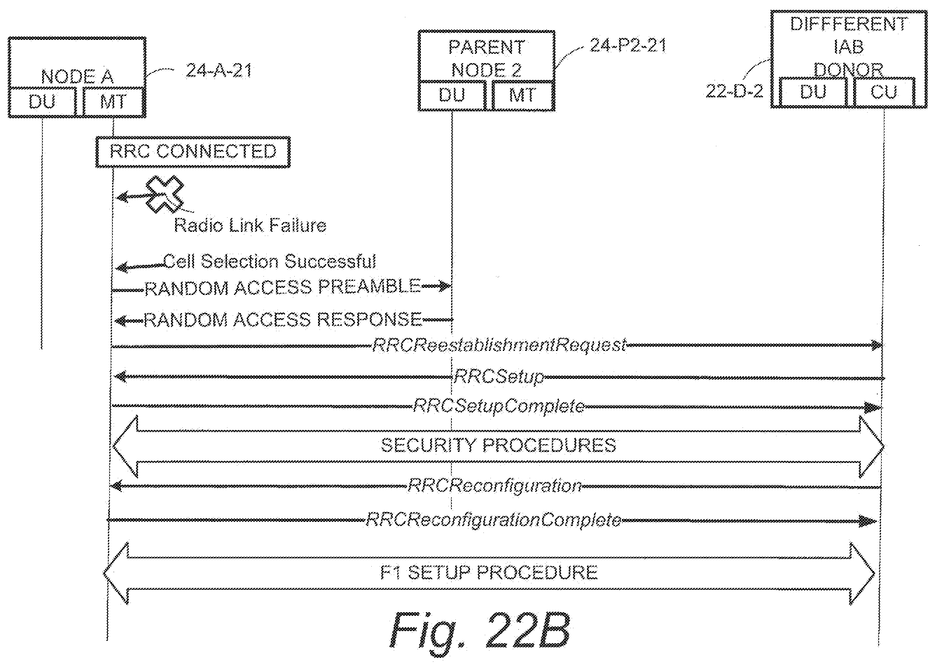

As disclosed in the aforementioned embodiments and modes, the MT part of an IAB-node may perform a cell selection procedure upon detecting a Radio Link Failure, RLF, on its upstream radio link. FIG. 21 is a diagrammatic view showing another example telecommunications system in which a routing loop may occur upon cell selection. FIG. 22A depicts example, basic, representative acts or steps of a message flow in a situation in which an IAB node of FIG. 21 may recover from a broken upstream link by an RRC reestablishment procedure with a first parent IAB node. FIG. 22B depicts example, basic, representative acts or steps of a message flow in a situation in which an IAB node of FIG. 21 may recover from a broken upstream link by an RRC reestablishment procedure with a second parent IAB node. FIG. 21 illustrates an example scenario, where Node 24-A-21, an IAB-node, detects an RLF on the backhaul radio link to the current parent node (Parent node 22-P1-21). Eventually Node 24-A-21 may start to perform the cell selection procedure, attempting to find a suitable cell with sufficient signal quality. As a result of the cell selection, the MT part of Node 24-A-21 may be able to find the original parent node (Parent node 24-P1-21) that served before the RLF (Cell Selection A in FIG. 21). In this case, Node 24-A-21 may initiate the RRC reestablishment procedure shown in FIG. 22A by sending RRCReestablishmentRequest to the IAB-donor 22-D-21 via Parent node 22-P1-21, in order to recover the broken upstream link. Upon receiving the RRCReestablishmentRequest, the IAB-donor 22-D-21 may retrieve the connection context (e.g. security keys, etc.) for the MT part of Node 24-A-21, and then may respond to Node 24-A-21 with RRCReestablishment, Node 24-A-21 may complete the RRC reestablishment procedure by sending RRCReestablishmentComplete.

If Node 24-A-21 fails to find the original parent and selects another parent node (e.g. Cell selection B to Parent node 24-P2-21 in FIG. 21), the MT part of Node 24-A-21 may initiate the RRC reestablishment procedure, similar to the cell selection case of FIG. 22A. In this case, if Parent node 24-P2-21 is connected to the same IAB-donor 22-D-21, or if Parent node 24-P2-21 is connected to a different IAB-donor (not illustrated) and the different IAB-donor is able to retrieve the connection context for the MT part of Node 24-A-21, the RRC establishment procedure may be successfully performed in a way similar to the flow shown in FIG. 22A. If the different IAB-donor fails to retrieve the connection context, the different IAB-donor and Node 24-A-21 may follow the message flow shown in FIG. 22B where the IAB-donor may respond back to Node 24-A-21 with RRCSetup, to setup a brand-new RRC connection, and in turn, Node 24-A-21 may send RRCSetupComplete, followed by the security procedure, similar to the flow shown in FIG. 6B.

It should be noted that, upon detecting the RLF, Node 24-A-21 may or may not immediately transmit the aforementioned upstream RLF notification to its child nodes (e.g. Child node 30-1-21 in FIG. 21). Transmission of the upstream RLF notification may be determined based on the previously disclosed embodiments.

FIG. 21 also serves to illustrate a potential problematic situation wherein, during the cell selection procedure, Node 24-A-21 ends up with discovering downlink broadcast transmission (synchronization signals, system information, etc.) from the DU parts of its child nodes (e.g., Child node 30-1-21, as shown by the arrow labeled “Cell selection C”) or from the DU parts of its grandchild nodes (Child node 30-2-21, as shown by the arrow labeled “Cell selection D”). In such a situation, without proper configurations, Node 24-A-21 may not be able to recognize that the downlink broadcast transmission is indeed from a (grand)child IAB-node in its own downstream path. As a result, if the signal quality is sufficient, Node 24-A-21 may choose to camp on the (grand)child node, and eventually any signaling (e.g. RRC, F1AP, etc.) addressed to the IAB-donor would be circulated in a closed loop. A closed loop in a relay network may be referred as a “routing loop”, and the network topology that forms a routing loop may be referred as loop topology.

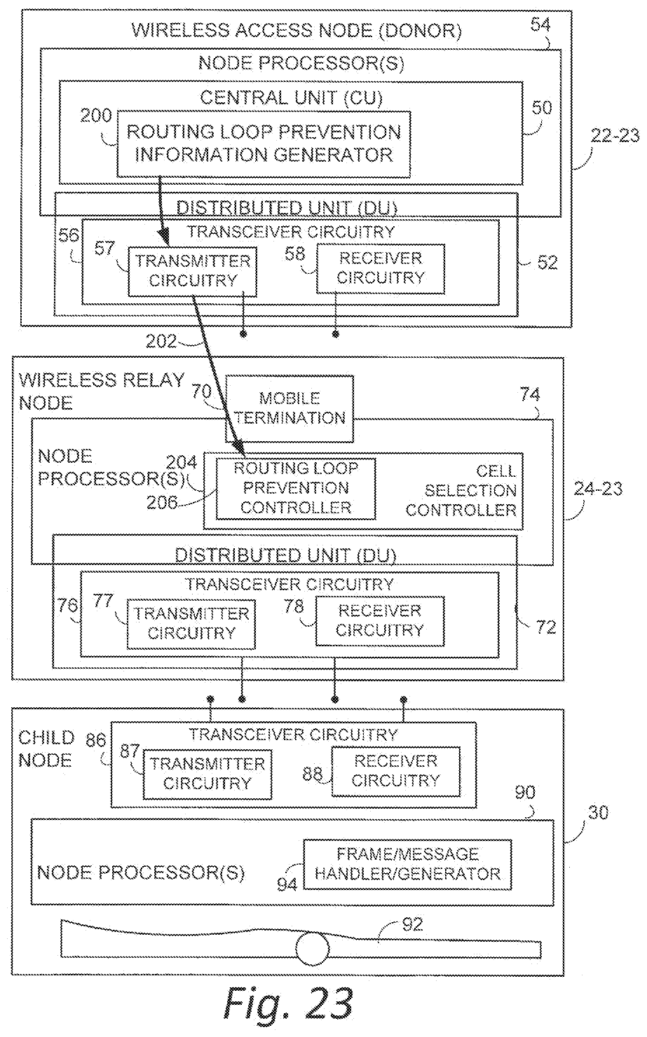

Various embodiments and modes described herein are configured to address and/or combat the routing loop problem. FIG. 23 shows a telecommunication system 20-23 which generically addresses a potential routing loop situation using routing loop prevention information that may be utilized by an Integrated Access and Backhaul (IAB) node in order to prevent the node from selecting a cell of one of its children or grandchildren nodes. Components of FIG. 23 which have similar names to the components of FIG. 12 and/or FIG. 17 also have comparable function, unless otherwise noted or clear from the context.

FIG. 23 is a diagrammatic view showing another example telecommunications system, and particularly an example telecommunications system in which generic routing loop prevention information is used to address a potential routing loop problem. FIG. 23 shows wireless access node 22-23, also known as IAB-donor node 22-23, as comprising central unit 50 and distributed unit 52. The central unit 50 and distributed unit 52 may be realized by, e.g., by comprised of or include one or more processor circuits, e.g., node processor(s) 54-1. The one or more node processor(s) 54-1 may be shared by central unit 50 and distributed unit 52 or each of central unit 50 and distributed unit 52 may comprise one or more node processor(s) 54. Moreover, central unit 50 and distributed unit 52 may be co-located at a same node site, or alternatively one or more distributed units 52 may be located at sites remote from central unit 50 and connected thereto by a packet network. The distributed unit 52 may comprise transceiver circuitry 56, which in turn may comprise transmitter circuitry 57 and receiver circuitry 58. The transceiver circuitry 56 includes antenna(e) for the wireless transmission. Transmitter circuitry 57 includes, e.g., amplifier(s), modulation circuitry and other conventional transmission equipment. Receiver circuitry 58 comprises, e.g., amplifiers, demodulation circuitry, and other conventional receiver equipment.

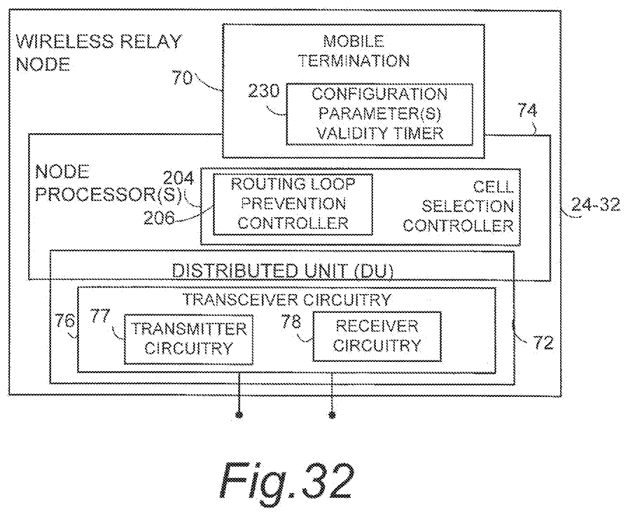

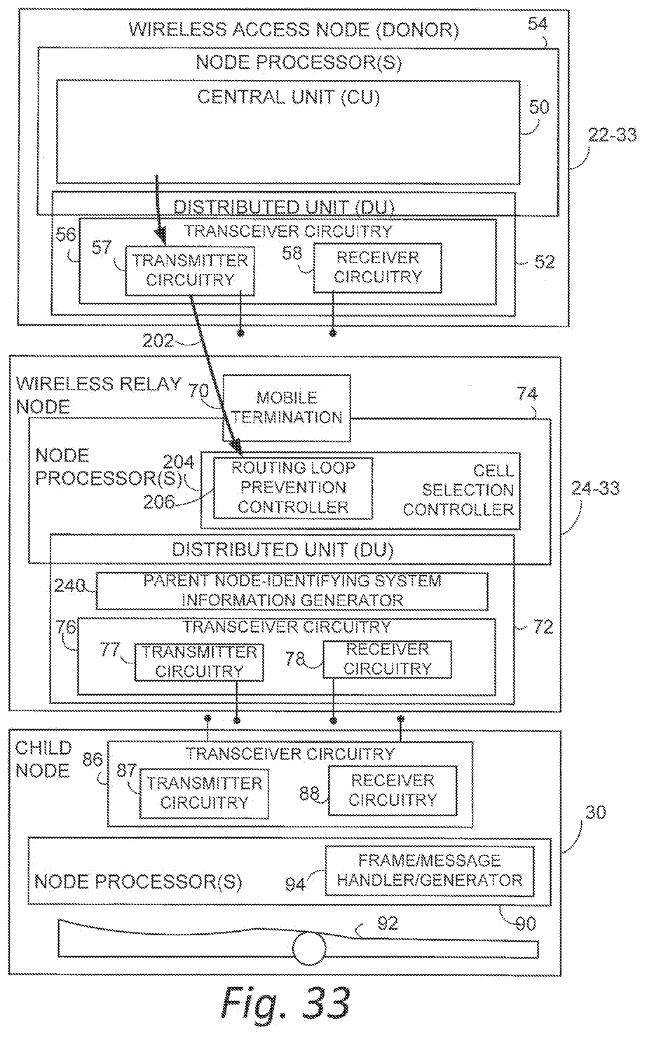

As further shown in FIG. 23, node processor(s) 54 of wireless access node 22-23 may comprise routing loop prevention information generator 200. The routing loop prevention information generator 200 generates routing loop prevention information that, when received by an Integrated Access and Backhaul (IAB) node, may be used by the Integrated Access and Backhaul (IAB) node to avoid selecting any of its children or grandchildren nodes in a cell selection procedure. Differing types of routing loop prevention information are described herein in differing embodiments and modes. For example, in the example embodiment and mode of FIG. 23C the routing loop prevention information is configuration information, whereas in the example embodiment and mode of FIG. 33-FIG. 37 the routing loop prevention information is carried by system information. FIG. 23 further shows that the transmitter circuitry 57 of wireless access node 22-23 may transit a signal or message 202 comprising the routing loop prevention information, e.g., routing loop prevention information message 202, over a radio interface to other Integrated Access and Backhaul (IAB) nodes.

As shown in FIG. 23 the IAB-node 24-23, also known as wireless relay node 24-23, in an example embodiment and mode comprises relay mobile termination unit 70 and relay distributed unit 72. The relay mobile termination unit 70 and relay distributed unit 72 may be realized by, e.g., by comprised of or include one or more processor circuits, e.g., relay node processor(s) 74. The one or more relay node processor(s) 74 may be shared by relay mobile termination unit 70 and relay distributed unit 72, or each of mobile termination unit 70 and distributed unit 72 may comprise one or more relay node processor(s) 74. The relay node distributed unit 72 may comprise transceiver circuitry 76, which in turn may comprise transmitter circuitry 77 and receiver circuitry 78. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment.

FIG. 23 further shows that IAB-node 24-23 may comprise cell selection procedure controller 204. The cell selection procedure controller 204 serves to initiate and perform a cell selection procedure when the IAB node 24-23 has detected or experienced, e.g., a radio link failure (RLF), and therefore needs to select another cell or, if the RLF is temporary, attempt to re-select the same cell if able to do so. In addition, the IAB node 24-23 comprises cell selection routing loop prevention controller 206. The cell selection routing loop prevention controller 206 may comprise or be included in cell selection procedure controller 204, which may in turn be realized or comprised by relay node processor(s) 74.

FIG. 23 shows child node 30 as comprising, in an example, non-limiting embodiment and mode, transceiver circuitry 86. The transceiver circuitry 86 in turn may comprise transmitter circuitry 87 and receiver circuitry 88. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment. FIG. 23 further shows child node 30, which (as indicated before) may be a user equipment or Integrated Access and Backhaul (IAB) node, as also comprising node processor circuitry, e.g., one or more node processor(s) 90, and interfaces 92, including one or more user interfaces. Such user interfaces may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

In an example, non-limiting embodiment and mode shown in FIG. 23, the child node 30 may include frame/message generator/handler 94. As is understood by those skilled in the art, in some telecommunications system messages, signals, and/or data are communicated over a radio or air interface using one or more “resources”, e.g., “radio resource(s)”. The frame/message generator/handler 94 serves to handle messages, signals, and data received from other nodes.

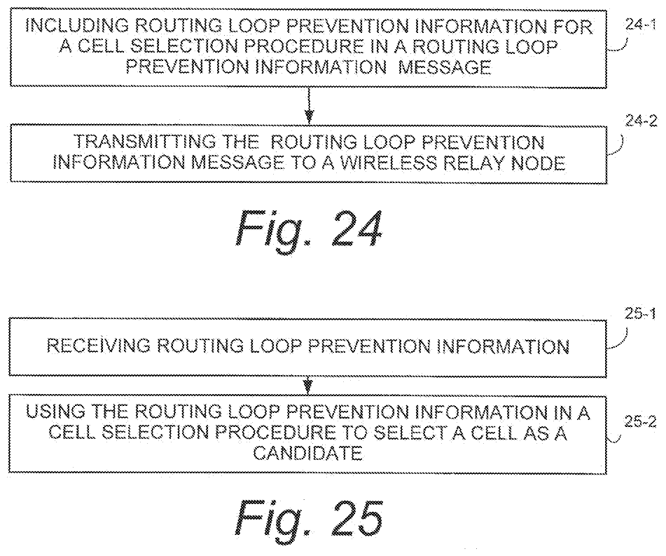

FIG. 24 is a flowchart showing example, representative acts or steps performed by the wireless access donor node 22-23 of FIG. 23. Act 24-1 comprises including routing loop prevention information for a cell selection procedure in a message. The routing loop prevention information may be generated, for example, by node processor(s) 54 and the routing loop prevention information generator 200 in particular. Alternatively, the routing loop prevention information may be generated by a network entity, such a network server that comprises either the radio access network or a core network. In the event that the routing loop prevention information is generated by a network server, the node processor(s) 54 may serve to include the server-generated routing loop prevention information into a routing loop prevention information message. Act 24-2 comprises transmitting the routing loop prevention information message to a wireless relay node, such as in routing loop prevention information message 202, for example.

FIG. 25 is a flowchart showing example, non-limiting, basic acts or steps that may be performed by a non-donor Integrated Access and Backhaul (IAB) node of FIG. 23. FIG. 25 shows example, representative acts or steps performed by the IAB node 24-23 of FIG. 23. Act 25-1 comprises receiving routing loop prevention information, e.g., receiving routing loop prevention information message 202. Act 25-2 comprises using the routing loop prevention information in a cell selection procedure to select a cell as a candidate. The routing loop prevention information precludes the IAB node 24-23 from selecting a cell of one of its child or grandchild nodes.

Various example embodiments and modes generically covered by the example embodiment and mode of FIG. 23 are now further described. In the ensuing descriptions of the nodes of the telecommunications systems of the further example embodiments and modes, any suffixes affixed to node descriptors are done so for sake of simplicity of reference, it being understood that such nodes are still subsumed under the general and generic embodiment and mode and that comments directed to such suffixed node appellations are not necessarily and generally are not confined to that particular example embodiment and mode. Moreover, it should be understood that features and/or components of the various example embodiments and modes and implementations described herein may be combined with one another.

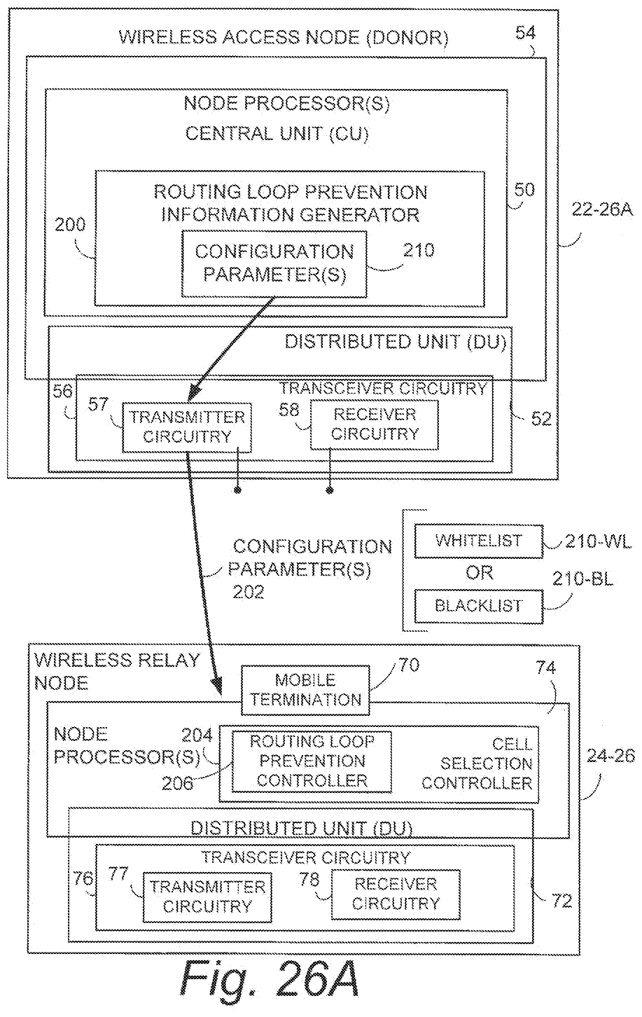

Preventing Routing Loops in Cell Selection: Using Configuration Parameter(s) FIG. 26A is a diagrammatic view showing an example implementation of the generic telecommunications system of FIG. 23 in which the routing loop prevention information comprises configuration information, e.g., configuration parameter(s), generated by a donor Integrated Access and Backhaul (IAB) node. FIG. 26B is a diagrammatic view showing an example implementation of the generic telecommunications system of FIG. 23 in which the routing loop prevention information comprises configuration information, e.g., configuration parameter(s), generated by a network server entity. In order to prevent a routing loop from happening, in some example embodiments and modes illustrated in FIG. 26A and FIG. 26B, the routing loop prevention information may be configuration information. Accordingly, an IAB-node 24-26 (e.g., a node such as 24-A-21 of FIG. 21 or IAB node 24-23 of FIG. 23) may be configured with configuration parameters 210 to provide guidelines (or policies, rules, restrictions, etc.) to help the IAB-node 24-26 to perform cell selections after an event such as an RLF.

In the example implementation of FIG. 26A the configuration parameters may be generated by routing loop prevention information generator 200 of wireless access node 22-26A, and may be included in the routing loop prevention information message 202 provided to an IAB-node 24-26 while the IAB-node is connected with IAB-donor 22-26A (e.g., before an RLF). In one example configuration or implementation shown in FIG. 26A, the configuration parameters 210 may be generated by the CU part of the IAB-donor 22-26 and transmitted by its DU part via (broadcast or dedicated) signaling, such as RRC and F1AP.

In another example implementation shown in FIG. 26B the configuration parameters 210 may be generated and transmitted by a network entity, such as a network server 220. In an example embodiment and mode, the network entity 220 may comprise server configuration parameter(s) generator 222, which may comprise or be realized by processor circuitry, and network server interface 224. The server processor circuitry or server configuration parameter(s) generator 222 is configured to generate routing loop prevention information for a cell selection procedure in a message. The interface 224 is configured to transmit the routing loop prevention information message through a radio access network to a wireless relay node. The routing loop prevention information may be generated by a configuration parameter generator 222 of the network server 220 and transmitted to wireless access node 22-26B via IP data packets. The wireless access node 22-26B may then include the routing loop prevention information which was generated by network server 220 in the routing loop prevention information message 202. In the example embodiment and mode of FIG. 26B, the CU of wireless access node 22-26B may thus serve as a routing loop prevention information message generator 200B. The configuration parameters that were generated by the server configuration parameter(s) generator 222 of network entity 220 may thus be included in a routing loop prevention information message by message generator 200B, which may comprise the CU part of the IAB-donor 22-26B, and be transmitted by the DU part of wireless access node 22-26B via (broadcast or dedicated) signaling, such as RRC and F1AP. The IAB-node 24-26 that receives the configuration parameters may save them in its storage and may make use of them upon an event such as an RLF.

In one configuration or implementation of the example embodiments and modes such as FIG. 26A and FIG. 26B, for example, the configuration parameters may comprise a “whitelist” of cell/node identities, which white-listed cell/node identities the IAB-node 24-26 may be allowed to select during the cell selection procedure. The cell/node identities may be Physical Cell IDs (PCIs), NR Cell Identities (CellIdentities or NCIs), NR Cell Global Identifiers (NCGIs), gNB identifiers (gNB IDs), Global gNB identifiers (all specified in 3GPP TS 38.300, all existing versions thereof being incorporated herein by reference), or any other identifiers to identify cells/nodes. During RRC_CONNECTED state, the IAB-donor such as wireless access node 22-26A of FIG. 26A or a network entity such as network entity 220 of FIG. 26B may generate a whitelist 210-WL for the IAB-node, which may include identities of cells/nodes near by the IAB-node and may exclude the identities of cells served by the DU parts of the IAB-node's (grand)child nodes. The whitelist 210-WL may be updated and sent to the IAB-node, as necessary. For example, when an IAB-node nearby IAB node 24-26 (the nearby Integrated Access and Backhaul (IAB) node not being illustrated) becomes a (grand)child node of IAB node 24-26, the cell/node identity of the nearby IAB-node may be removed from the whitelist (if already included) and the updated whitelist may be sent to IAB node 24-26. Likewise, when a (grand)child node of IAB node 24-26 hands over to another IAB-node and no longer is a (grand)child node of IAB node 24-26, cell/node identity for such an IAB-node may now be added to the whitelist to be sent to IAB node 24-26. In one configuration, upon an update, the entire whitelist 210-WL may be delivered to IAB node 24-26. Additionally or alternatively, only updated parts of the whitelist may be delivered (such as a “to add”, “to modify” or “to remove” list).

In a case that the whitelist 210-WL comprises a list of PCIs (or one or more ranges of PCIs), upon an RLF the MT part of IAB node 24-26 may initiate the cell selection procedure, where the MT part attempts to acquire synchronization signals, such as Primary Synchronization Signal (PSS) and Secondary Synchronization Signal (SSS), from neighbor cells. If the PCI decoded from the synchronization signals broadcasted by one of the neighbor cells is included in the whitelist 210-WL, the MT part may proceed to further acquiring system information blocks (such as MIB and SIB1) from the cell. Otherwise, the MT part of Node A may consider the cell as not a candidate (“not suitable” or “barred”) and continue the cell selection process by searching for other cells. Meanwhile, in a case that the whitelist comprises a list of CellIdentity fields, the MT part of Node A may acquire the synchronization signals, MIB and SIB1, and if a CellIdentity(s) contained in SIB1 is included in the whitelist, the cell selection may be successfully completed. If the CellIdentity(s) is not in the whitelist, the MT part of Node A may continue the cell selection process, searching for other cells.

In an example, non-limiting implementation, the whitelist 210-WL may be a prioritized list. In such prioritized case, if IAB node 24-26 Node A finds a low-priority cell, it may continue to find higher priority cells in the whitelist 210-WL. In one configuration, cells served by IAB-nodes/IAB-donor may of higher priority than cells with no IAB capabilities.

In another configuration of the example embodiment and mode, the configuration parameters may comprise a “blacklist” 200-BL of cell/node identities, which the IAB-node 24-26 should avoid during cell selections. Similar to the previous configuration, the cell identities may be Physical Cell IDs (PCIs), NR Cell Identities (CellIdentitys or NCIs), NR Cell Global Identifiers (NCGIs), gNB identifiers (gNB IDs), Global gNB identifiers, or any other identifies to identify cells/nodes. During RRC_CONNECTED state, the IAB-donor such as wireless access node 22-26A of FIG. 26A or a network entity such as network entity 220 of FIG. 26B may generate a blacklist 200-BL for the IAB-node 24-26, which may include identities of cells served by (grand)child nodes of the IAB-node of concern. The blacklist 200-BL may further comprise identities of nearby cells served by nodes with no IAB capabilities. The blacklist may be updated and sent to the IAB-node 24-26 as necessary. For example, when another IAB-node (not illustrated) which is nearby IAB node 24-26 becomes a (grand)child node of IAB node 24-26, the cell/node identity of the nearby IAB-node may be added to the blacklist and the updated blacklist 200-BL may be sent to IAB node 24-26. Likewise, when a (grand)child node of IAB node 24-26 hands over to another IAB-node and no longer is a (grand)child node of IAB node 24-26, the cell/node identity of such an IAB-node may be removed from the blacklist and an updated blacklist may be sent to IAB node 24-26. Similar to the whitelist 200-WL, the entire blacklist 200-BL or only updated parts of the blacklist (such as a “to add”, “to modify” or “to remove” list) may be delivered.

In a case that the blacklist 200-BL comprises a list of PCIs (or one or more ranges of PCIs), upon an RLF the MT part of IAB node 24-26 may initiate the cell selection procedure, where the MT part attempts to acquire synchronization signals, such as Primary Synchronization Signal (PSS) and Secondary Synchronization Signal (SSS), from neighbor cells. If the PCI decoded from the synchronization signals broadcasted by one of the neighbor cells is not included in the blacklist 200-BL, the MT part may proceed to further acquiring system information blocks (such as SIB1) from the cell. Otherwise, the MT part of IAB node 24-26 may consider the cell as not a candidate (“not suitable” or “barred”) and continue the cell selection process by searching for other cells. Meanwhile, in a case that the blacklist comprises a list of CellIdentity fields, the MT part of IAB node 24-26 may acquire the synchronization signals, MIB and SIB1, and if a CellIdentity(s) contained in SIB1 is not included in the blacklist 200-BL, the cell selection may be successfully completed. If the CellIdentity(s) is in the blacklist 200-BL, the MT part of IAB node 24-26 may continue the cell selection process, searching for other cells.

In addition, the blacklist 200-BL may further include some topology information associated with cell/node identities. That is, the topology information may indicate parent-child relationship among entries of the blacklist 200-BL. For example, in the case of FIG. 21, after Child node 30-2-21 is attached to the relay network, the blacklist 200-BL may indicate Child node 30-2-21 as a direct child of Node 24-A-21 and Child node 30-2-21 as a direct child of Child node 30-1-21. A blacklist 200-BL with topology information may be referred as a routing table, or a topology table.

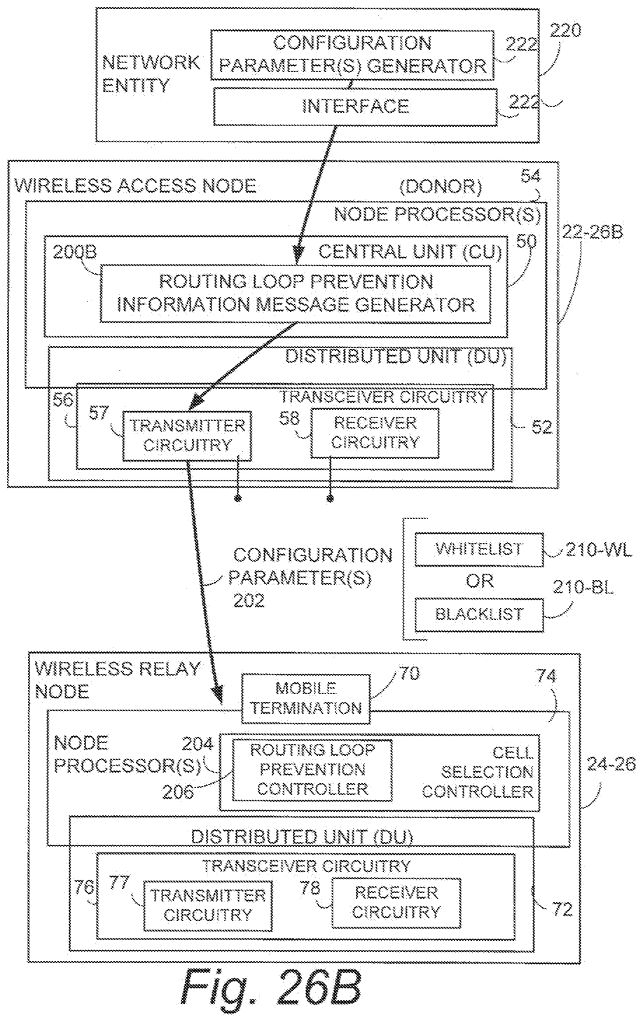

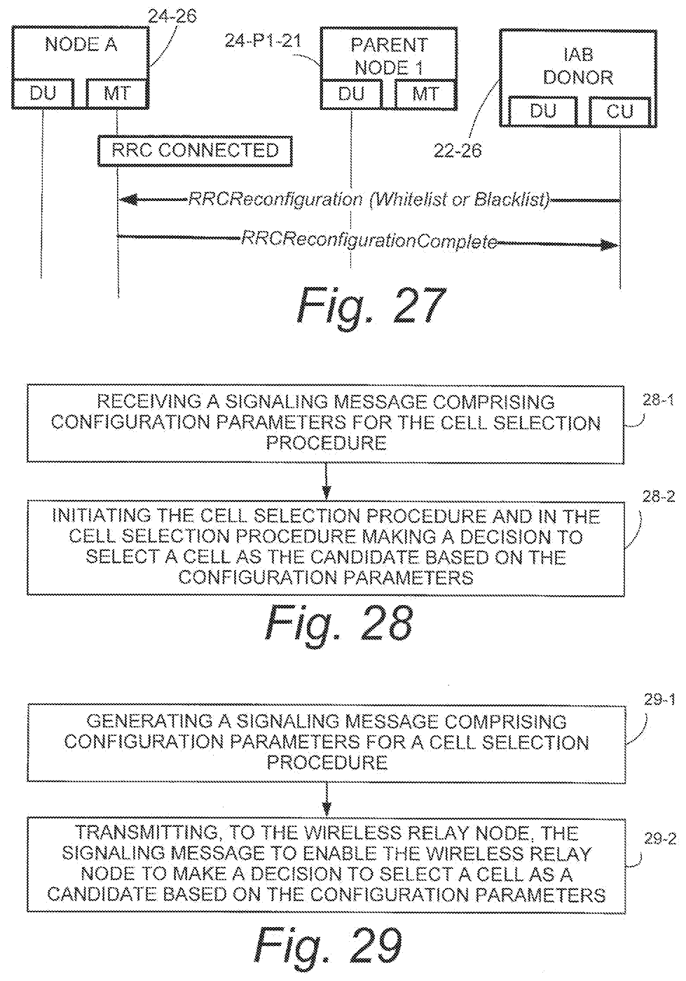

FIG. 27 is a diagrammatic view of an example message flow including a RRCReconfiguration message for sending a whitelist or blacklist of configuration parameter(s). Either the whitelist 200-WL or the blacklist 200-BL may be carried via RRCReconfiguration message to the MT part of an IAB-node as shown in the example message flow of FIG. 27. Alternatively, either the whitelist 200L or the blacklist 200-BL may be carried via an F1-AP message to the DU part of an IAB-node, then handed to a MT part collocated in the IAB-node. The MT part of IAB node 24-26 may save the list, e.g., either whitelist 200-WL or blacklist 200-BL, and upon a radio link failure (RLF) the MT part of the IAB node 24-26 may use the latest list, either whitelist 200-WL or blacklist 200-BL, for cell selections.

FIG. 28 is a flowchart showing example, representative acts or steps which may be performed by the IAB node 24-26 of FIG. 26A and FIG. 26B. Act 28-1 comprises receiving a signaling message comprising configuration parameters for the cell selection procedure. Act 28-2 comprises initiating the cell selection procedure and, in the cell selection procedure, deciding to select a cell as the candidate based on the configuration parameters.

FIG. 29 is a flowchart showing example, representative acts or steps which may be performed by the wireless access donor node 22-26A of FIG. 26A. Act 29-1 comprises generating a signaling message comprising configuration parameters for a cell selection procedure. Act 29-2 comprises transmitting, to the wireless relay node, the signaling message to enable the wireless relay node to decide to select a cell as a candidate based on the configuration parameters.

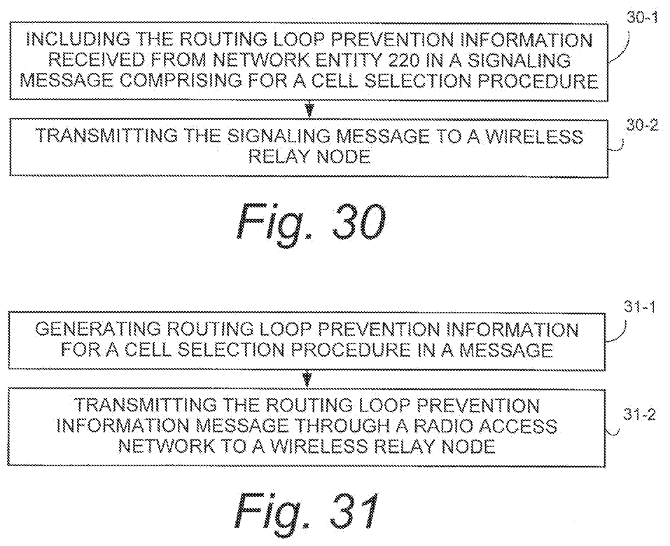

FIG. 30 is a flowchart showing example, representative acts or steps which may be performed by the wireless access donor node 22-26B of FIG. 26B. Act 30-1 comprises including the routing loop prevention information received from network entity 220 in a signaling message comprising for a cell selection procedure. Act 30-2 comprises transmitting, to the wireless relay node, the signaling message to enable the wireless relay node to decide to select a cell as a candidate based on the configuration parameters.

FIG. 31 is a flowchart showing example, representative acts or steps which may be performed by the network entity 220 of FIG. 26B. Act 31-1 comprises generating routing loop prevention information for a cell selection procedure in a message. Act 31-2 comprises transmitting the routing loop prevention information message through a radio access network to a wireless relay node.

In the above configurations of the example embodiments and modes, such as FIG. 26A and FIG. 26B, for example, the configuration parameters 210 may further comprise one or more radio-related parameters, such as frequency band lists, which the MT part of the IAB-node 24-26 may be directed to search on or not to search on upon an RLF.

Moreover, in the foregoing example embodiments and modes such as FIG. 26A and FIG. 26B, validity of the configuration parameters 210 may be limited in time. In other words, for example, once configured, the configuration parameters 210 may be valid within a (pre)configured time period. The MT part of an IAB-node such as IAB node 24-26 may start a timer, e.g., configuration parameter(s) validity timer 230 as shown in FIG. 32, and may invalidate the configuration parameters upon the timer expiring. In one example implementation, the timer 230 is started when the configuration parameters are configured. FIG. 32 is a schematic view of an IAB node which further comprises a configuration parameter(s) validity timer. In another example implementation, the timer 230 is started when an event (such as an RLF) triggering the cell selection procedure occurs. The value of the timer 230 may be pre-configured or configured by a network node (a parent IAB-node, an IAB-donor, or any other network entity) by dedicated signaling (e.g. RRC, F1-AP) or broadcast signaling (e.g. system information (MIB, SIB1 or other SIB(s))). In addition, a stored set of configuration parameters may become invalid when a new set of configuration parameters is received.

Preventing Routing Loops in Cell Selection: Using System Information

FIG. 33 is a diagrammatic view showing an example implementation of the generic telecommunications system of FIG. 23 in which an Integrated Access and Backhaul (IAB) node broadcasts system information as routing loop prevention information, which announces parent nodes. FIG. 33 shows an example embodiment and mode wherein the same issue of “routing loops” is addressed by an alternative approach, e.g., using system information. In the example embodiment and mode of FIG. 33, a distributed unit 72 of each IAB-node, such as IAB node 24-33, may broadcast system information (SI) comprising a list of identifiers to identify the (grand)parent cells/nodes located on the upstream path of the SI-broadcasting IAB-node, in addition to a cell/node identification of its own. FIG. 33 particularly shows that distributed unit 72 of IAB node 24-33 includes parent node-identifying system information generator 240 which includes, in the system information broadcast by IAB node 24-33, the list of identifiers to identify the (grand)parent cells/nodes located on the upstream path. In the example embodiment of FIG. 33, system information in which the parent node list is included may comprise synchronization signals (e.g. PSS/SSS), Physical Broadcast Channel (PBCH), Physical Downlink Control Channel (PDCCH), MIB, SIB1, other SIB(s) or any combination of one or more thereof.

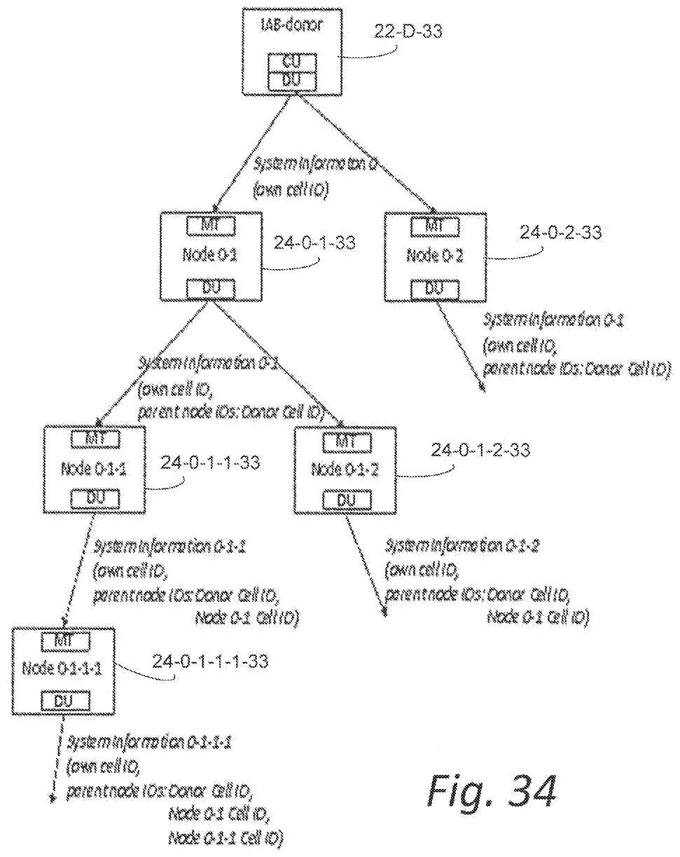

Operation of the example embodiment and mode of FIG. 33 is illustrated in FIG. 34. FIG. 34 is a diagrammatic view illustrating a mode of operation of a telecommunications network that includes Integrated Access and Backhaul (IAB) nodes that broadcast system information which announces parent nodes in the manner of FIG. 33. FIG. 34 shows a telecommunications system comprising wireless access donor node 22-D-33, IAB node 24-0-1-33; IAB node 24-0-2-33; IAB node 24-0-1-1-33; IAB node 24-0-1-2-33; and IAB node 24-0-1-1-1-33. Each of the IAB nodes 24-33 of FIG. 34 include a mobile termination unit 70 and a distributed unit 72, with the distributed unit 72 including the aforementioned parent node-identifying system information generator 240.

FIG. 34 illustrates an example operation and mode of the example embodiment and mode of FIG. 33. First, the DU part of an IAB-donor may broadcast its own cell/node identification (e.g. PCI, CellIdentity(s), or other identification(s)) via system information (System Information 0 in FIG. 34).

Next in FIG. 34, two child nodes, IAB node 24-0-1-33 and IAB node 24-0-2-33 of FIG. 34, attach to the relay network. The two nodes IAB node 24-0-1-33 and IAB node 24-0-2-33 are in RRC_IDLE or RRC INACTIVE state, acquiring the system information broadcast from the IAB-donor 22-D-33, and then performing the RRC connection setup procedure (as previously disclosed). During the system information acquisition, the two nodes IAB node 24-0-1-33 and IAB node 24-0-2-33 may obtain the cell/node identification of the IAB-donor 22-D-33. In a case that some of the two child nodes have already been in RRC_CONNECTED state and handover to the IAB-donor, the system information (at least some essential parts including at least the cell identification of a target cell (i.e. the IAB-donor)) may be provided to the nodes IAB node 24-0-1-33 and IAB node 24-0-2-33 by dedicated signaling (e.g. RRCReconfiguration message) before or after the handover.

After establishing an RRC connection, followed by F1-AP setting up their respective DU parts, each of the nodes IAB node 24-0-1-33 and IAB node 24-0-2-33 may start broadcasting its own system information. In the example embodiment of FIG. 34, this system information may include its own cell/node identification and may further include a list of cell/node identifications for parent nodes. For example, the DU part of IAB node 24-33-0-1-33 may broadcast system information (System Information 0-1) comprising the cell/node identification of Node 24-0-1-33 and a list of parent cell identification including the cell/node identification for the IAB-donor 22-D-33.

Next in FIG. 34, other two nodes, Node 24-0-1-1-33 and Node 24-0-1-2-33, may attach to the relay network via Node 24-0-1-33. Each of Node 24-0-1-1-33 and Node 24-0-1-2-33 perform the same action(s) as Node 24-0-1-33 or Node 24-0-2-33. In this case the system information (System Information 0-1) additionally includes the list of cell/node identifications for the parent nodes of Node 24-0-1-33 (e.g., includes the identification of the IAB-donor 22-D-33).

When broadcasting system information (System Information 0-1-1 and System Information 0-1-2, respectively), the Node 24-0-1-1-33 and Node 24-0-1-2-33 may compose a list comprising the parent cell identifications received from Node 24-0-1-33 and the cell identification of Node 24-0-1-33. Similarly, any (grand)child node attaching to the relay network may perform the same acts.

In the operation and mode described above, it is assumed that the MT part of an IAB-node informs the collocated DU part of necessary information, e.g. parent node identifications, received in the system information.

When an IAB-node detects a radio link failure (RLF) on its upstream radio link, the MT part of the IAB-node may initiate the cell selection procedure as described in the previous embodiments, and determine suitability of any discovered cells by acquiring system information (at least synchronization signals, MIB and SIB1, possibly other SIB(s)). In the operation and mode of the example embodiment of FIG. 34, the MT part of the IAB-node may decode the system information to ensure that the selected cell is not served by a child node of its own. In order to do this, the MT part of the IAB-node may examine the list of parent node identifications included in the system information and check if its own cell/node identification is in the list. If the check is positive, the MT part of the IAB-node may determine the selected cell served by its own child node and therefore attempt to look for other cells. Otherwise, the MT part of the IAB-node may examine other parameters in the system information, such as barring status, and may further proceed to the RRC reestablishment procedure as disclosed earlier.

In another example operation and mode, a different type of identifications may be used for the list of identifiers identifying (grand)parent nodes to be included in the system information. For example, Physical Cell IDs (PCIs), NR Cell Identities (CellIdentitys or NCIs), NR Cell Global Identifiers (NCGIs), gNB identifiers (gNB IDs), Global gNB identifiers, gNB-ID (specified in 3GPP TS 38.473) or any other identifies to identify cells/nodes may be used.

At least some of the example operations and modes disclosed above in the example embodiment of FIG. 33 and FIG. 34 assume that each IAB-node is implemented in such a way that the identifications of (grand)parent nodes on its upstream path towards an IAB-donor are retrieved from received system information by the MT part and transferred to the collocated DU part, where the identifications are further used in the system information that the collocated DU part may broadcast. For example, the cell selection routing loop prevention controller 206 of the Integrated Access and Backhaul (IAB) node may include or have access to the upstream node identifications.

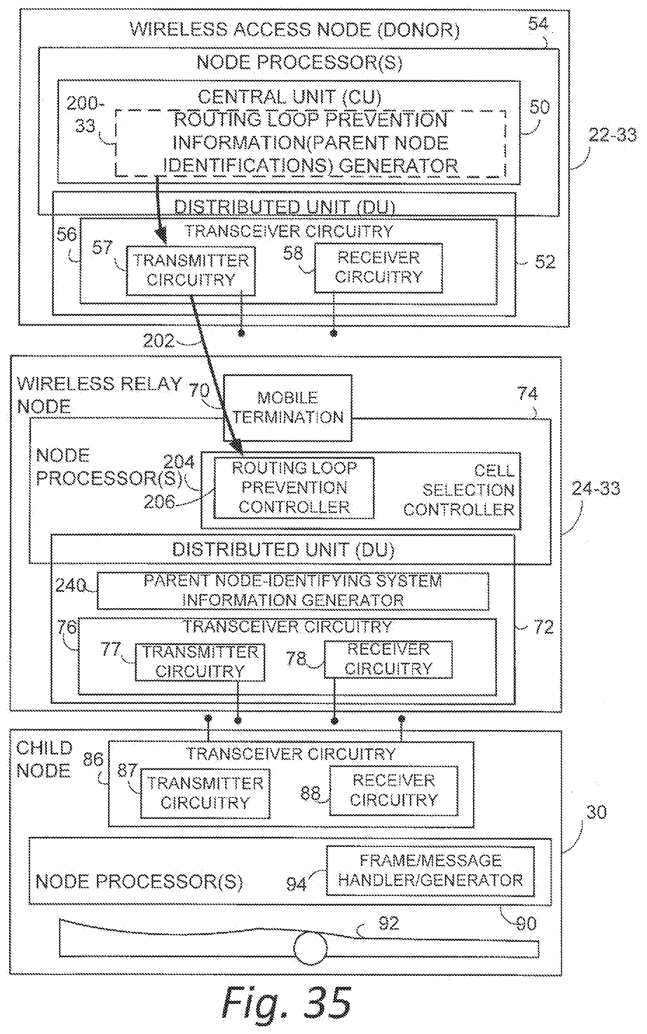

FIG. 35 is a diagrammatic view showing an example implementation of the generic telecommunications system of FIG. 23 in which an Integrated Access and Backhaul (IAB) node broadcasts system information as routing loop prevention information, which announces parent nodes, and in which a routing loop prevention information generator takes the form of a parent node identification generator. In an alternative approach shown in FIG. 35, the IAB-donor 22-D-33 (or any other network entity) may configure each IAB-node with a set of parent node identifications to be broadcasted by the IAB-node. In this case, during IAB-node being attached to the IAB-donor, the set of parent node identifications may be configured by an RRC message (e.g. RRCReconfiguration message) or an F1-AP message. FIG. 33 shows such optional alternative by the routing loop prevention information generator takes the form of a parent node identifications generator 200-33.

FIG. 36 is a flowchart showing example, representative acts or steps which may be performed by the wireless access donor node of FIG. 33-FIG. 35. FIG. 36 shows example, representative acts of steps that may be performed by an IAB node 24-33 of the example embodiment and mode of FIG. 33-FIG. 35. Act 36-1 comprises receiving or obtaining first system information including a first list comprising at least one identification of a donor node and identifications of zero or more intermediate relay nodes located between the donor node and the wireless relay node. Act 36-2 comprises transmitting second system information including a second list comprising an identification of the wireless relay node, the at least one identification of the donor node and the identifications of zero or more intermediate relay nodes. Act 36-3 comprises initiating a cell selection procedure. Act 36-4 comprises, in the cell selection procedure, further receiving, from a selected cell during the cell selection procedure, third system information including a third list comprising one or more identifications of nodes. Act 36-5 comprises, in the cell selection procedure, making a decision to select the selected cell/node as a candidate based on whether a third list includes the identification of the wireless relay node.

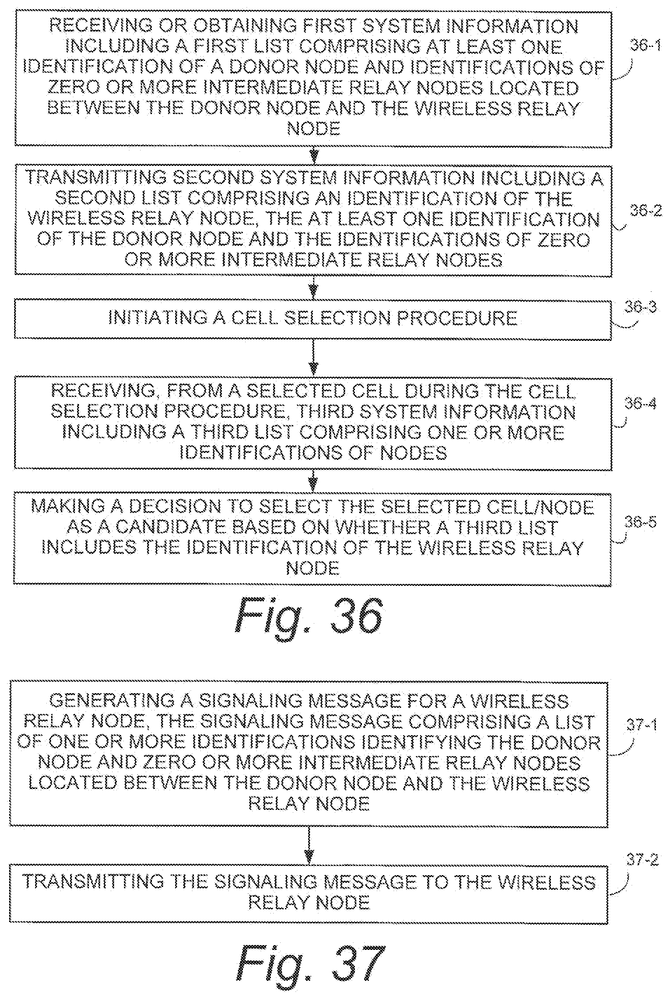

FIG. 37 is a flowchart showing example, representative acts or steps which may be performed by the wireless access donor node of FIG. 33-FIG. 35. FIG. 37 shows example, representative acts of steps that may be performed by a wireless access donor node such as node 22-D-33 of the example embodiment and mode of FIG. 33-FIG. 35. Act 37-1 comprises generating a signaling message for a wireless relay node, the signaling message comprising a list of one or more identifications identifying the donor node and zero or more intermediate relay nodes located between the donor node and the wireless relay node. Act 37-2 comprises transmitting the signaling message to the wireless relay node. As understood from the foregoing, the list of one or more identifications is configured to enable the wireless relay node to make a decision to select a cell/node as a candidate during a cell selection procedure.

### Upstream RLF Notification: Specific Signaling Embodiments

In various example embodiments and modes described above an IAB node or relay node generates a notification of a radio condition concerning a radio link that is upstream from such IAB node or relay node. In some example embodiments and modes, such notification may be termed, when appropriate, as an Upstream Radio Link Failure (RLF) notification. For example, in the example embodiment and mode of FIG. 11, which addresses a backhaul condition by implementing an autonomous handover, notification generator 98 of IAB-node 24A generates a condition notification 42 which is transmitted, e.g., to a child node or UD/IAB node 30, as illustrated, e.g., in FIG. 11. Similarly, in the example embodiment and mode of FIG. 17, which addresses a backhaul condition in a redundant connection situation, notification generator 98 of IAB-node 24A generates a condition notification 42 which is transmitted, e.g., to a child node or UD/IAB node 30, as illustrated, e.g., in FIG. 16.

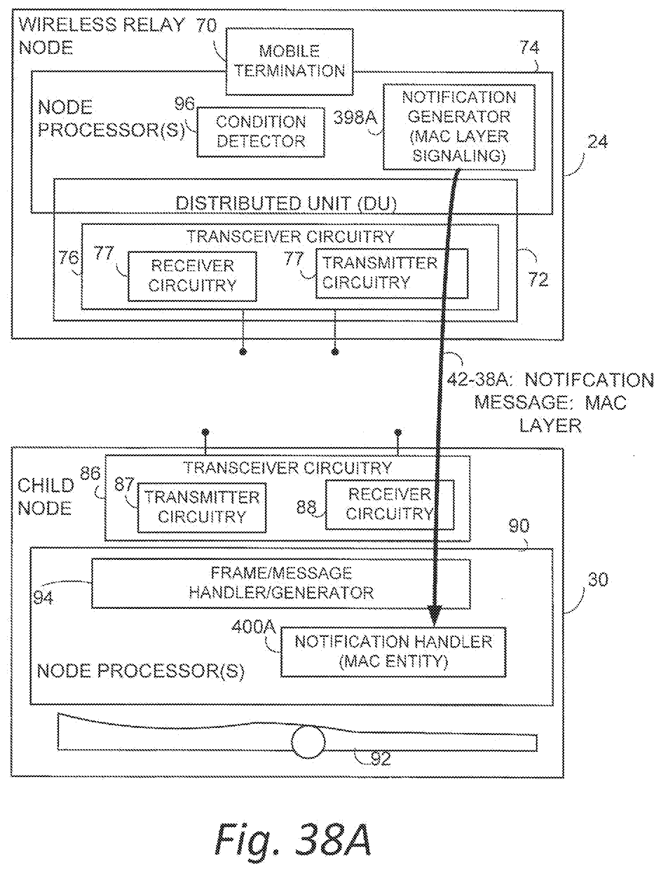

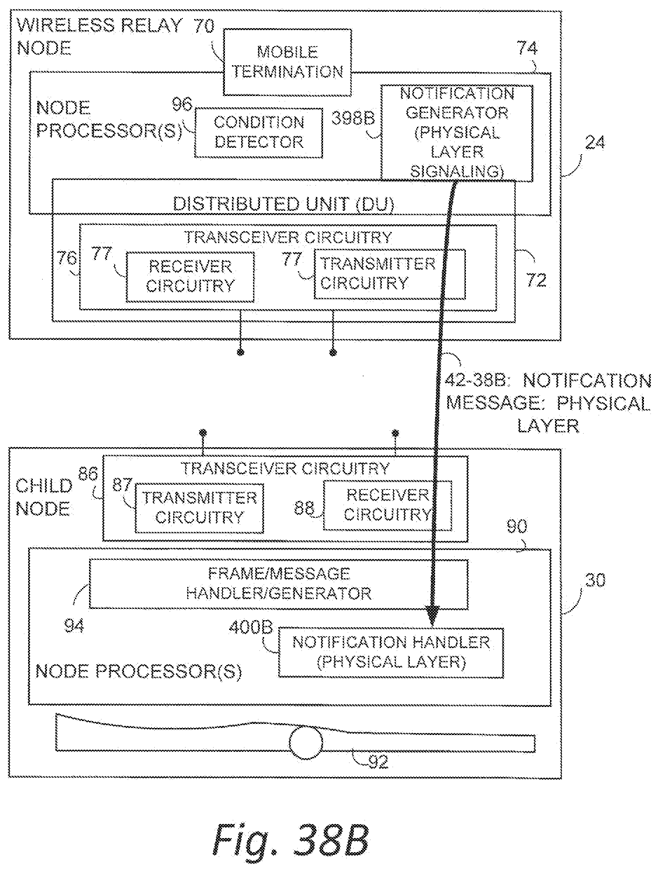

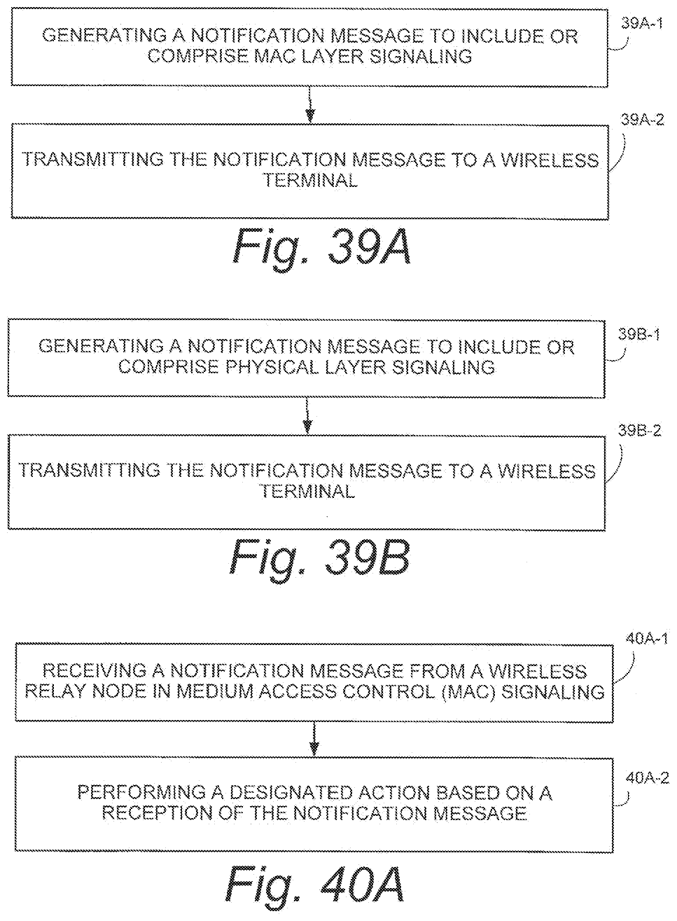

Other example embodiments and modes described herein including those of FIG. 38 and FIG. 39 pertain to type of signaling and, in some instances, content of the signaling, used for radio link condition notification messages. The radio link condition notification messages may also herein and elsewhere be referred to as a “notification message”; an “upstream RLF notification”, since the message informs of a radio link failure on an upstream link); and/or a “downstream notification of backhaul RLF”, which is mentioned in 3GPP TR 38.874 V16.0.0 (2018-12), which is incorporated herein by reference.

FIG. 38A is a diagrammatic view showing portions of an example telecommunications system in which an uplink condition notification message includes or comprises MAC layer signaling. FIG. 38A specifically illustrates an example embodiment and mode in which the notification message includes or comprises MAC layer signaling. FIG. 38B a diagrammatic view showing portions of an example telecommunications system in which an uplink condition notification message includes or comprises physical layer signaling. FIG. 38B specifically illustrates an example embodiment and mode in which the notification message includes or comprises physical layer signaling. In view of the fact that the example embodiments and modes of FIG. 38A and FIG. 38B may be used separately or used together, the technology disclosed herein encompasses nodes, and processor circuitry within such nodes, configured to generate a notification message for transmission on Medium Access Control (MAC) layer signaling or physical layer signaling. For example, the notification message may be generated for transmission on one of Medium Access Control (MAC) layer signaling and physical layer signaling, or a combination of Medium Access Control (MAC) layer signaling and physical layer signaling, or at least one of Medium Access Control (MAC) layer signaling and physical layer signaling.

### Upstream RLF Notification: Specific Signaling Embodiments: Mac Layer Signaling

FIG. 38A shows an example embodiment and mode wherein a notification message 42-38A includes or comprises MAC layer signaling. In FIG. 38, the notification message 42-38A is generated by notification message generator 398A of IAB-node 24. The notification message generator 398A may comprise or be included in the node processor(s) 74 of IAB-node 24, and further may be considered as part of distributed unit 72 of IAB-node 24. FIG. 38A further shows that the notification message 42-38A may be transmitted by transmitter circuitry 77 of IAB-node 24 over a radio interface to other nodes, such as child node or UE/IAB node 30 of FIG. 38A. In an example implementation discussed below, IAB-node 24 of FIG. 38A includes processor circuitry configured to generate a notification message for transmission on a Medium Access Control (MAC) subPDU in a MAC PDU, with the notification message comprising information representing a radio condition, as well as transmitter circuitry configured to transmit the notification message to a wireless terminal.

The notification message 42-38A is received by receiver circuitry 88 of UE/IAB node 30, is processed by frame/message handler/generator 94 of UE/IAB node 30, and is more particularly handled by a MAC protocol entity such as MAC notification handler 400A of UE/IAB node 30. In an example implementation described herein, the receiver circuitry is configured to receive a notification message from a wireless relay node, the notification message comprising information representing a radio condition of the wireless relay node's upstream radio link, and the notification message being received on a Medium Access Control (MAC) subPDU in a MAC PDU. The UE/IAB node 30 further comprises processor circuitry configured to perform a designated action based on a reception of the notification message. Non-limiting examples of such designated action may be, for example, to engage in a handoff or handover, or to participate in a connection through one of previously redundant upstream links.

The notification message 42-38A of FIG. 38A may be generated by notification message generator 398A upon occurrence of any upstream link condition as described herein, e.g., in conjunction with the situations of any of the example embodiment and modes described herein, such as upstream radio link failure (RLF). For example, generation of notification message 42-38A may occur in context of the example embodiment and mode of FIG. 11, which addresses a backhaul condition by implementing an autonomous handover, in the context of the example embodiment and mode of FIG. 17, which addresses a backhaul condition in a redundant connection situation. These are non-limiting, non-exhaustive example contexts which may utilize a notification message 42-38A. Various components and functionalities of IAB-node 24 and UE/IAB node 30 illustrated in FIG. 38A may be understood with reference to similarly numbered components and functionalities of preceding example embodiments and modes.

In some example embodiments and modes the occurrence of the upstream link condition may be detected by the IAB-node 24, for which reason FIG. 38A shows inclusion of condition detector 96. FIG. 38A does not particularly illustrate units of the UE/IAB node 30 which may take various actions upon receipt of notification message 42-38A, but non-exhaustive and non-limiting examples of such units and actions are provided in other example embodiments and modes described herein and elsewhere. For example, in terms of actions, the UE/IAB node 30 may engage in a handoff or handover, or to participate in a connection through one of previously redundant upstream links.

FIG. 39A is a flowchart showing example, representative acts or steps performed by the IAB-node 24 of FIG. 38A. Act 39A-1 comprises generating a notification message to include or comprise MAC layer signaling. In an example implementation, act 39A-1 may be implementation by representing the radio condition(s) on a Medium Access Control (MAC) subPDU in a MAC PDU. The notification message 42-38A may be generated by notification message generator 398A. Act 39A-2 comprises transmitting the notification message to a wireless terminal.

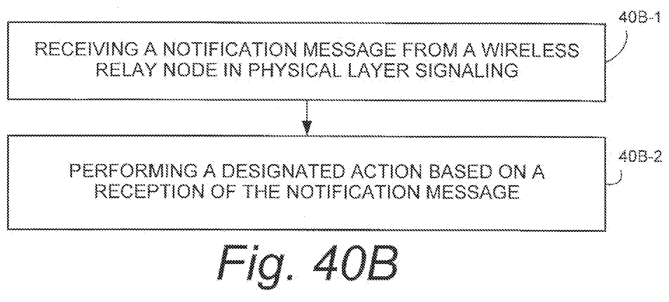

FIG. 40A is a flowchart showing example, representative acts or steps performed by the UE/IAB node 30 of FIG. 38A. Act 40A-1 comprises receiving a notification message from a wireless relay node. As explained above, the notification message comprises information representing radio condition(s) of the wireless relay node's upstream radio link, and is included in or comprises MAC layer signaling. For example, the notification message may be received on a Medium Access Control (MAC) subPDU in a MAC PDU. Act 40A-2 comprises performing a designated action based on a reception of the notification message. As mentioned above, non-limiting examples of such designated action may be performing, or at least attempting to perform, a handoff or handover, or utilizing a select one of possibly previously redundant upstream links.

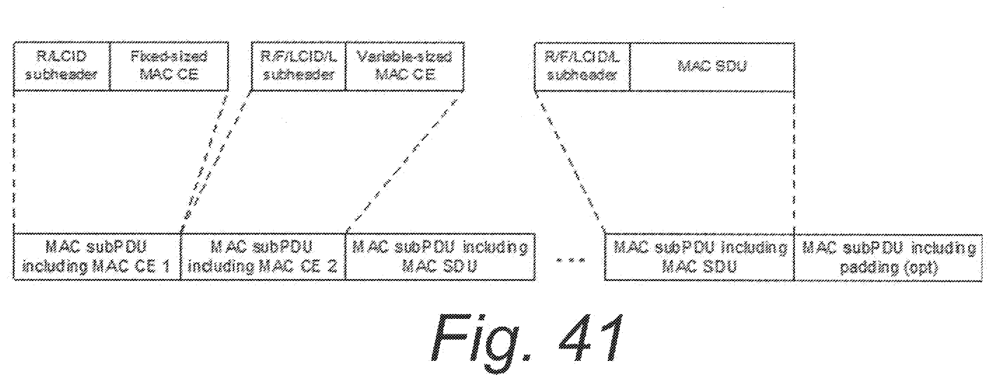

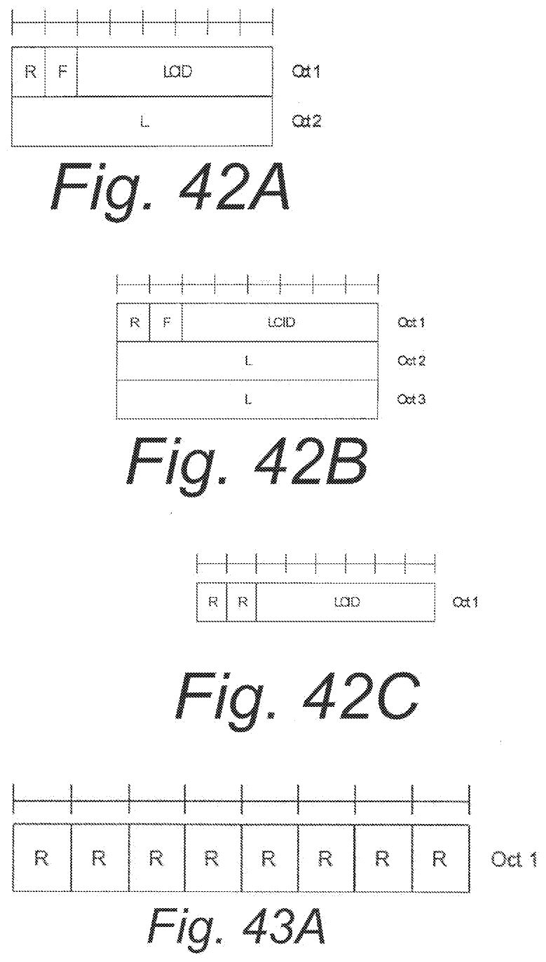

As mentioned above, the example embodiment and mode of FIG. 38A, FIG. 39A, and FIG. 40A concerns implementing an upstream RLF notification, e.g., notification message 42-38A, in the MAC layer. FIG. 41 is a diagrammatic view showing an example format of a MAC downlink PDU. FIG. 42A is a diagrammatic view showing three different MAC subheader formats. FIG. 42B is a diagrammatic view showing three different MAC subheader formats. FIG. 42C is a diagrammatic view showing three different MAC subheader formats. FIGS. 42A, 42B and 42C show three different MAC subheader formats. The format shown in FIG. 42A may be used for a variable-sized MAC CE or MAC SDU with an 8-bit length field. The format shown in 42B may be used for a variable-sized MAC CE or MAC SDU with a 16-bit length field. The format shown in FIG. 42C may be used for a fixed sized MAC CE. The “F” bit indicates the size of the length field. For example, F=0 may indicate an 8-bit length field, whereas F=1 may indicate a 16-bit length field.

The upstream RLF notification may be assigned with a designated logical channel ID (LCID). In other words, a particular logical channel identifier (LCID) may be reserved for or used to represent a condition reported by the notification message. For example, as shown in Table 1, the LCID value of Index 46 of Table 1 may be used to represent the link condition, e.g., a backhaul (BH) radio link failure. When transmitting the upstream RLF notification, the DU part of an IAB-node may set the LCID to a MAC subheader.

TABLE 1

| Index | LCID values |
|---|---|
| 0 | CCCH |
| 1-32 | Identity of the logical channel |
| 33-45 | Reserved |
| 46 | Downstream notification of BH RLF |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific |
| | PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octet) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

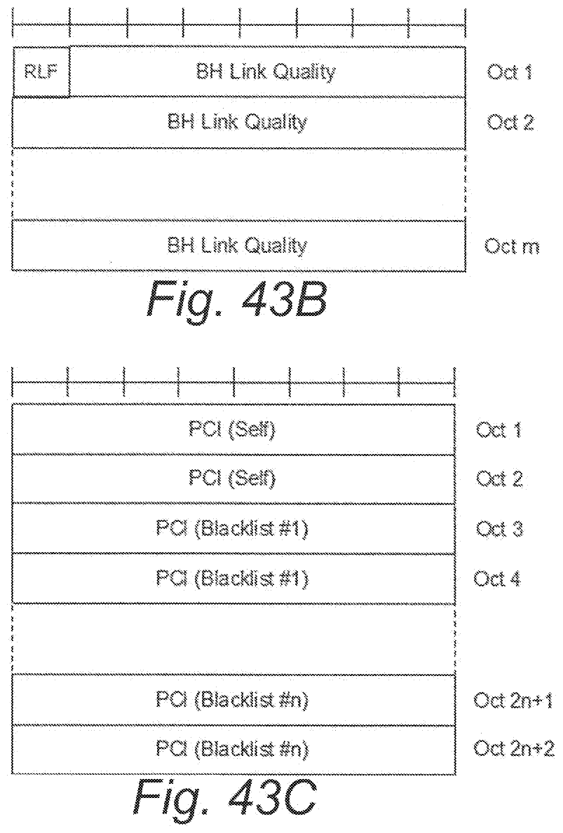

In one example configuration, the upstream RLF notification, e.g., the notification message 42-38A, may not need to carry any other information. In one example case of this example configuration, the MAC subPDU that includes the MAC subheader with the designated LCID may include no MAC CE (i.e. 0-length MAC CE). In an alternative example case of this example configuration, the MAC subPDU may include a MAC CE of a fixed length with reserved (“R”) bits, such as the example shown in FIG. 43A. FIG. 43A is a diagrammatic view showing an example format in which a MAC layer signaled notification message does not carry other information.

In another example configuration, the MAC subPDU that includes the MAC subheader with the designated LCID may also contain a MAC CE that indicates the status of the upstream backhaul link of the IAB-node. FIG. 43B is a diagrammatic view showing an example format in which a MAC layer signaled notification message additionally carries status information of the upstream backhaul link of the IAB-node. For example, as depicted in FIG. 43B, the MAC CE may be of m number of octets, comprising an RLF indication (“RLF” bit) and may further comprise one or more bits of a backhaul link quality field(s).

In yet another example configuration, the upstream RLF notification, e.g., notification message 42-38A, may also carry other types of information. For example, a MAC CE transmitted in conjunction with the designated LCID may comprise a whitelist or a blacklist disclosed in the previous embodiments, such as the example embodiments and modes of FIG. 26A and FIG. 26B, for example. In this case, the MAC CE may comprise a list of cell/node identities and may also comprise the (self) cell/node identity of the transmitting IAB-node. FIG. 43C is a diagrammatic view showing an example format in which a MAC layer signaled notification message additionally carries types of information other than status information for the upstream backhaul link of the IAB-node. FIG. 43C illustrates an example MAC CE format comprising the self-cell/node identity and a blacklist, where PCIs are used to identify cells/nodes. In this case, a subheader to support a variable-sized MAC CE may be used, as understood with reference to FIG. 42A and/or FIG. 42B.

Similarly, a MAC CE transmitted in conjunction with the designated LCID may comprise a list of cell/node identifications of the (grand)parent nodes and its own (self) node, as shown in FIG. 34. In this configuration, instead of using only system information to transmit the list, a MAC CE is used to transmit the list, or a MAC CE is used in parallel with the system information.

Furthermore, in one example implementation or configuration, more than one LCID may be assigned or used in conjunction with reporting or affecting upstream link(s). As a non-limiting example, the aforementioned RLF recovery notification may use a LCID different from the LCID used for the RLF notification. Similarly, the MAC CE comprising a whitelist may be assigned with a separate LCID. In general, any or any combination of the types of information disclosed in this embodiment may form a MAC CE, associated with a separate or a shared LCID.

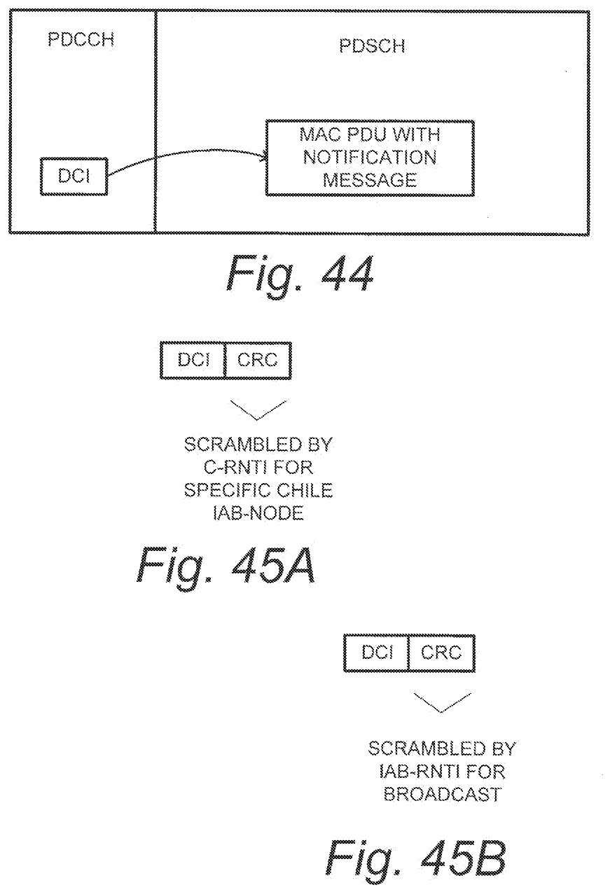

In an example embodiment and mode, a MAC PDU which carries the upstream RLF notification may be transmitted by the DU part of an IAB-node, e.g., Distributed Unit (DU) 52 of IAB-node 24 of FIG. 38A, using a Physical Downlink Shared Channel (PDSCH), associated with a Downlink Control Information (DCI) transmitted on a Physical Downlink Control Channel (PDCCH). The DCI may comprise the scheduling information for transmission of PDSCH containing the MAC PDU. FIG. 44 is a diagrammatic view showing a resource grid and a Physical Downlink Shared Channel (PDSCH) which comprise the downlink control information (DCI) which indicates scheduling of a Physical Downlink Shared Channel (PDSCH) which includes a MAC PDU that comprises or includes the link condition notification message. For example, FIG. 44 illustrates a resource grid wherein some resources comprise the Physical Downlink Control Channel (PDCCH) which comprises the downlink control information (DCI), and wherein the downlink control information (DCI) indicates, e.g., points to, scheduling of the Physical Downlink Shared Channel (PDSCH) which includes the MAC PDU that comprises or includes the link condition notification message.

In some configurations, Cyclic Redundancy Check, CRC, parity bits, also referred to simply as the CRC, may be attached to the DCI. After attachment, the CRC parity bits may be scrambled by a Radio Network Temporary Identifier(s), RNTI(s). The child IAB-node/UE 30 may attempt to decode, e.g., blind decode, monitor, detect, the DCI to which the CRC parity bits scrambled by the RNTI(s) are attached. For example, the child IAB-node/UE 30 may decode the PDCCH with the CRC scrambled by the RNTI(s). In such case, the child IAB-node/UE may receive the PDCCH, e.g., the DCI format(s), without the blind decoding.

FIG. 45A is a diagrammatic view showing a CRC) associated with downlink control information (DCI) being scrambled by a C-RNTI for a specific child IAB node. In an example case such as that shown in FIG. 45A in which the DU part of IAB-node 24, e.g., Distributed Unit (DU) 52, desires to send the upstream RLF notification 42-18A to a specific child IAB-node or a UE, the Cell RNTI (C-RNTI) of the recipient child IAB-node/UE may be used to scramble a CRC attached to a DCI. In the case of FIG. 45A, for example, DCI format 1_0 or 1_1 with CRC scrambled by the C-RNTI, as specified in 3GPP TS 38.212, may be used.

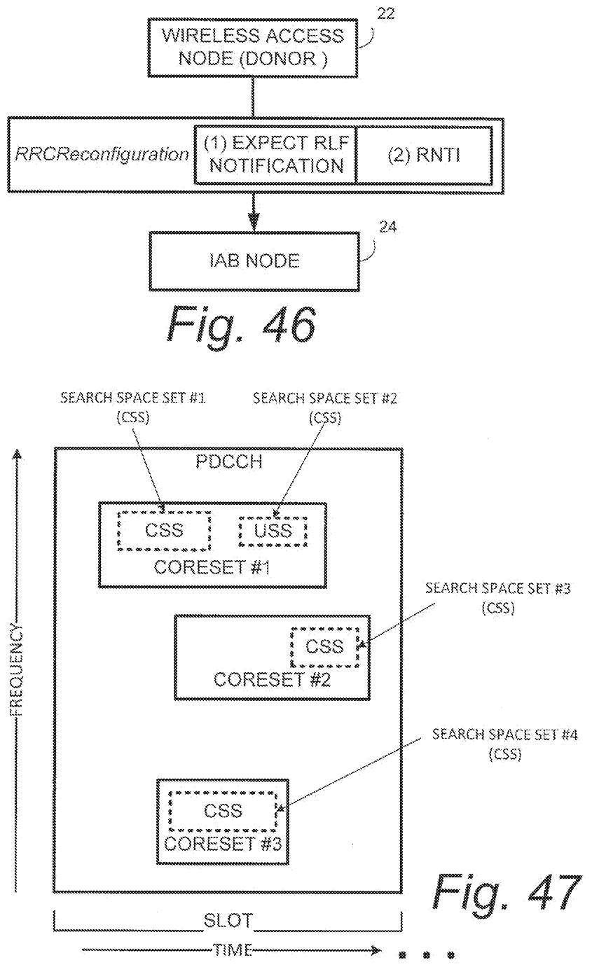

FIG. 45B is a diagrammatic view showing a CRC associated with downlink control information (DCI) being scrambled by an IAB-RNTI for broadcast. In another example case shown in FIG. 45B in which the DU part, e.g., Distributed Unit (DU) 52 of IAB-node 24, desires to broadcast the MAC PDU to its child nodes and UEs, a new RNTI, e.g., IAB-RNTI, or a first RNTI hereafter, may be used to scramble a CRC attached to a DCI, format 1_0, 1_1 or other, used in conjunction with the PDSCH containing the MAC PDU. The IAB-RNTI may be a unique or reserved identification used for a notification(s) of upstream radio link condition(s). An MT part of an IAB-node 24, or a child IAB node or UE 30 may be configured to use an IAB-RNTI to decode PDCCH. The IAB-RNTI may be a pre-configured value, e.g., pre-stored at the node, or configured, e.g., downloaded, to each IAB-node/UE by a network, e.g. by an IAB-donor. FIG. 46 is a diagrammatic view showing an IAB-donor node sending an RRCReconfiguration message comprising (1) an indication of whether or not the IAB-node/UE should expect the upstream RLF notification and (2) a RNTI to be used to decode the DCI associated with the MAC PDU. For example, as depicted in FIG. 46, when an IAB-node/UE 24 establishes an RRC connection with an IAB-donor 22, the IAB-donor 22 may send a RRCReconfiguration message comprising (1) an indication of whether or not the IAB-node/UE should expect the upstream RLF notification and (2) a RNTI, e.g., a C-RNTI, an IAB-RNTI or other RNTI, to be used to decode the DCI associated with the MAC PDU.

FIG. 47 is a diagrammatic view showing a PDCCH comprising one or more control resource sets (CORESETs), each of which may comprise one or more search space set(s). As shown in FIG. 47, a child IAB-node/UE 30 may monitor a set of candidates of the PDCCH in one or more control resource sets (CORESETs) according to a corresponding search space set(s). The set of candidates of the PDCCH for the child IAB-node/UE to monitor may be defined in terms of a search space set(s), also referred to simply as a search space(s). Two types of search space sets may be defined: a common search space set(s), a CSS set(s), and a UE-specific search space set(s), a USS set(s). As used herein:
PDCCH may be a physical channel in a set of PDCCH candidates.
A set of PDCCH candidates may be defined in terms of PDCCH search space sets.
Each search space may be configured to be a common search space set or a UE-specific search space set.
A UE monitors a set of PDCCH candidates in one or more control resource sets (CORESETs).
Each search space set may be configured with an association to one of the CORESETs.
A UE may be provided by higher layer signaling (e.g. RRC) with up to P (e.g. P=3) CORESETs.
A UE may be provided by higher layer signaling with up to S (e.g. S=10) search space sets

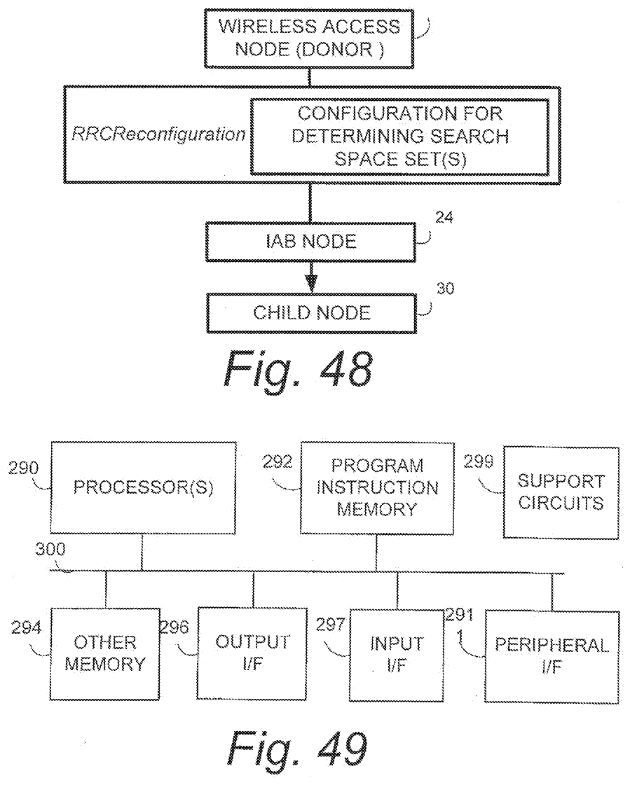

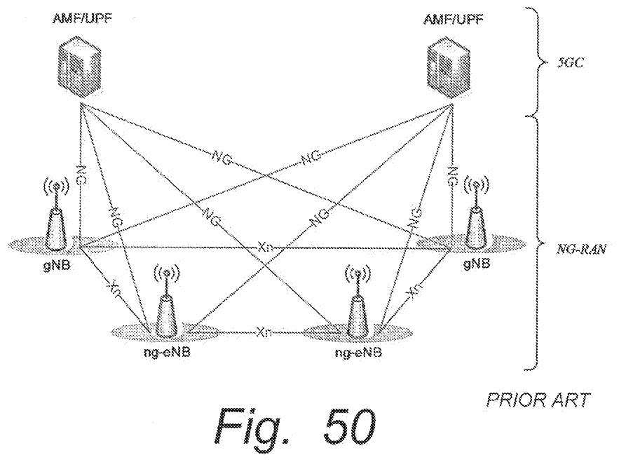

FIG. 48 is a diagrammatic view showing an IAB-donor node sending an RRCReconfiguration message comprising a configuration for determining search space set(s) to be used by an IAB node or UE/IAB node. As shown in FIG. 48, the configurations for determining the search space set(s) to be used, e.g., a type of the search space set(s), may be sent by the network entity, such as an IAB-donor 22, via a signaling message, e.g. RRCReconfiguration message. The child IAB-node/UE 30 may identify the type of the search space set(s) based on the configurations.

Furthermore, the configurations for the radio resources to monitor and/or the first RNTI to use may be configured per search space set, i.e., for each of search space sets. For example, the configurations used for determining an occasion(s) for the PDCCH monitoring may be configured per search space set. In such case, the configurations used for determining the occasion(s) for the PDCCH monitoring may comprise a periodicity and/or an offset value(s) for the PDCCH monitoring.

For PDCCH monitoring, the occasion(s) for the PDCCH for the new DCI format, e.g., the new DCI format with the CRC scrambled by the first RNTI, may be configured. For example, based on the configurations for the occasion(s) for the PDCCH for the new DCI format, the child IAB-node/UE may identify the occasion(s) for monitoring the PDCCH for the new DCI format, e.g., the new DCI format with the CRC scrambled by the first RNTI.

The new DCI format may be monitored only in the CSS set(s). Accordingly, in a case that a search space set(s) is configured as the CSS set(s), the child IAB-node/UE may monitor the new DCI format in the CSS set(s). Additionally or alternatively, the new DCI format may be monitored in the CSS set(s) and the USS set(s). Accordingly, in a case that a search space set(s) is configured as either of the CSS set(s) or the USS set(s), the child IAB-node/UE may monitor the new DCI format in the CSS set(s) or the USS set(s). Also, the new DCI format may be monitored only in the search space other than the search space corresponding to the CORESET #0, e.g., an index “0” of the CORESET, and/or search space #0 (SearchSpace #0. The configurations used for indicating an index of CORESET may be sent by the network entity, such as an IAB-donor, via a signaling message, e.g. RRCReconfiguration message, as shown in FIG. 48.

A search space set may be defined as one or more search space and each of the one or more search space is associated with a CORESET and PDCCH monitoring occasion. The PDCCH monitoring occasion may be defined by one or more of the following configurations:
Monitoring slot periodicity
Aggregation level
Number of consecutive slots that a Search Space lasts in every occasion
The first symbol(s) for PDCCH monitoring in the slots configured for PDCCH monitoring
Search space type
Common search space or UE-specific search space

A CORESET configuration may include one or more of the following configurations:
The number of OFDM symbols for the CORESET
Frequency domain resource
CCE-REG mapping type
TCI (Transmission configuration indication) for PDCCH

### Upstream RLF Notification: Specific Signaling Embodiments: Physical Layer Signaling

FIG. 38B shows an example embodiment and mode wherein a notification message 42-38A includes or comprises physical layer signaling. The example embodiment and mode of FIG. 38B thus provides an alternative way to convey the upstream condition notification, and possibly other information, using physical layer signaling. In one configuration of the FIG. 38B embodiment, a new DCI format on PDCCH may be used for the purpose.

In FIG. 38, the notification message 42-38A is generated by notification message generator 398B of IAB-node 24. The notification message generator 398A may comprise or be included in the node processor(s) 74 of IAB-node 24, and further may be considered as part of distributed unit 72 of IAB-node 24. FIG. 38A further shows that the notification message 42-38B may be transmitted by transmitter circuitry 77 of IAB-node 24 over a radio interface to other nodes, such as child node or UE/IAB node 30 of FIG. 38B. In an example implementation discussed below, IAB-node 24 of FIG. 38B includes processor circuitry configured to generate a notification message for transmission as a downlink control information (DCI), with the notification message comprising information representing a radio condition, as well as transmitter circuitry configured to transmit the notification message to a wireless terminal.

The notification message 42-38B is received by receiver circuitry 88 of UE/IAB node 30, is processed by frame/message handler/generator 94 of UE/IAB node 30, and is more particularly handled by a physical layer entity notification handler 400B of UE/IAB node 30. In an example implementation described herein, the receiver circuitry is configured to receive a notification message from a wireless relay node, the notification message comprising information representing a radio condition of the wireless relay node's upstream radio link, and the notification message being received on a physical layer signaling. The UE/IAB node 30 further comprises processor circuitry configured to perform a designated action based on a reception of the notification message. Non-limiting examples of such designated action may be, for example, to engage in a handoff or handover, or to participate in a connection through one of previously redundant upstream links.

The notification message 42-38B of FIG. 38B may be generated by notification message generator 398B upon occurrence of any upstream link condition as described herein, e.g., in conjunction with the situations of any of the example embodiment and modes described herein, such as upstream radio link failure (RLF). For example, generation of notification message 42-38B may occur in context of the example embodiment and mode of FIG. 11, which addresses a backhaul condition by implementing an autonomous handover, in the context of the example embodiment and mode of FIG. 17, which addresses a backhaul condition in a redundant connection situation. These are non-limiting, non-exhaustive example contexts which may utilize a notification message 42-38B. Various components and functionalities of IAB-node 24 and UE/IAB node 30 illustrated in FIG. 38B may be understood with reference to similarly numbered components and functionalities of preceding example embodiments and modes.

In some example embodiments and modes the occurrence of the upstream link condition may be detected by the IAB-node 24, for which reason FIG. 38B shows inclusion of condition detector 96. FIG. 38B does not particularly illustrate units of the UE/IAB node 30 which may take various actions upon receipt of notification message 42-38B, but non-exhaustive and non-limiting examples of such units and actions are provided in other example embodiments and modes described herein and elsewhere. For example, in terms of actions, the UE/IAB node 30 may engage in a handoff or handover, or to participate in a connection through one of previously redundant upstream links

FIG. 39B is a flowchart showing example, representative acts or steps which may be performed by the IAB-node 24 of FIG. 38B. Act 39B-1 comprises generating downlink control information (DCI) comprising content that indicates whether or not a radio link failure (RLF) has occurred on a link which is upstream from the wireless relay node. The notification message 42-38B may be generated by notification message generator 398B. Act 39B-2 comprises transmitting the downlink control information (DCI) to a wireless terminal.

FIG. 40B is a flowchart showing example, representative acts or steps performed by the UE/IAB node 30 of FIG. 38B. Act 40B-1 comprises receiving a notification message from a wireless relay node. As explained above, the notification message comprises information representing radio condition(s) of the wireless relay node's upstream radio link, and is included in or comprises physical layer signaling. For example, the notification message may be represented by or included in a downlink control information (DCI). Act 40B-2 comprises performing a designated action based on a reception of the notification message. Act 40B-2 may comprise ascertaining from the downlink control information whether or not a radio link failure (RLF) has occurred on a link which is upstream from the wireless relay node. As mentioned above, such a radio link failure (RLF) be ascertained from the notification message 42-38B, non-limiting examples of such designated action may be performing, or at least attempting to perform, a handoff or handover, or utilizing a select one of possibly previously redundant upstream links.

In one configuration of the FIG. 38B embodiment, a new DCI format on PDCCH may be used to provide the notification message 42-38B. The new DCI format may comprise any types or any combination of types of information disclosed in the previous embodiment, e.g., the example embodiment and mode of FIG. 38A, for a MAC CE, such as RLF indication, RLF recovery indication, upstream backhaul link signal quality, a whitelist, a blacklist, a (self) cell/node identification of the transmitting DU and/or a list of (grand)parent cell/node identifications.

Table 2 shows an example format of the new DCI used for notifying an RLF or an RLF recovery.

TABLE 2

| Field | Bits | Description |
|---|---|---|
| Identifier for DCI formats | 1 | Always set to 1, meaning this is |
| | | for DL |
| BH RLF indicator | 1 | 0: no RLF |
| | | 1: RLF |

Similar to the previous embodiment and illustrated by way of example in FIG. 45A and FIG. 45B, the CRC of the new DCI format may be scrambled with a recipient's C-RNTI, as in the case of FIG. 45A, or pre-configured/network-configured IAB-RNTI, e.g., a first RNTI, as in the case of FIG. 45B. A child IAB-node/UE 30 that attempts to receive the DCI may monitor one or more search spaces configured by network, e.g. an IAB-donor, and decode the DCI with the configured RNTI. Search spaces and search spaces sets are understood with reference to, e.g., FIG. 47.

A child IAB-node/UE 30 may be configured to monitor the DCI and attempt to decode by the (pre)configured first RNTI. The configurations for radio resources to monitor and/or the first RNTI to use may be sent by a network entity, such as an IAB-donor, via a signaling message, e.g., via a RRCReconfiguration message in a manner similar to that illustrated in FIG. 48. The child IAB-node/UE 30 may attempt to decode the DCI in a manner similar to the previous embodiment. That is, the child IAB-node/UE may decode the PDCCH with the CRC scrambled by the configured RNTI(s).

The configurations for the radio resources to monitor and/or the first RNTI to use may be configured per search space set, i.e., for each of search space sets, as shown in FIG. 47. For example, the configurations used for determining an occasion(s) for the PDCCH monitoring may be configured per search space set. The configurations used for determining the occasion(s) for the PDCCH monitoring may comprise a periodicity and/or an offset value(s) for the PDCCH monitoring.

For PDCCH monitoring, the occasion(s) for the PDCCH for the new DCI format (e.g., the new DCI format with the CRC scrambled by the first RNTI) may be configured. For example, based on the configurations for the occasion(s) for the PDCCH for the new DCI format, the child IAB-node/UE 30 may identify the occasion(s) for monitoring the PDCCH for the new DCI format, e.g., the new DCI format with the CRC scrambled by the first RNTI.

The new DCI format may be monitored only in the CSS set(s). Accordingly, in a case that a search space set(s) is configured as the CSS set(s), the child IAB-node/UE may monitor the new DCI format in the CSS set(s). Additionally or alternatively, the new DCI format may be monitored in the CSS set(s) and the USS set(s). Accordingly, in a case that a search space set(s) is configured as either of the CSS set(s) or the USS set(s), the child IAB-node/UE may monitor the new DCI format in the CSS set(s) or the USS set(s). Also, the new DCI format may be monitored only in the search space other than the search space corresponding to the CORESET #0 (i.e., an index “0” of the CORESET) and/or search space #0 (SearchSpace #0). The configurations used for indicating an index of CORESET may be sent by the network entity, such as an IAB-donor, via a signaling message, e.g. RRCReconfiguration message.

A search space set may be defined as one or more search space and each of the one or more search space is associated with a CORESET and PDCCH monitoring occasion. The PDCCH monitoring occasion may be defined by one or more of the following configurations:
Monitoring slot periodicity
Aggregation level
Number of consecutive slots that a Search Space lasts in every occasion
The first symbol(s) for PDCCH monitoring in the slots configured for PDCCH monitoring
Search space type
Common search space or UE-specific search space

A CORESET configuration may include one or more of the following configurations:
The number of OFDM symbols for the CORESET
Frequency domain resource
CCE-REG mapping type
TCI (Transmission configuration indication) for PDCCH

It should be understood that the various foregoing example embodiments and modes may be utilized in conjunction with one or more example embodiments and modes described herein. For example, the routing loop prevention information embodiments described herein may be utilized in conjunction with one or more of the earlier described example embodiments and modes. Or, as another example, the upstream notification embodiments may be utilized in conjunction with one or more of the earlier described example embodiments and modes.

The system of IAB is expected to be reliable and robust against various kinds of possible failures. The technology disclosed herein thus provides methods and procedures to deal with a radio link failure on the backhaul link.

The technology disclosed herein provides methods for handling cases where an IAB node loses the connection to the network due to a radio link failure. Example, non-limiting methods and features include:
The IAB node transmits to its child nodes/UEs information representing the radio condition of its upstream link.
The child nodes/UEs decide, based on the received information, whether or not to stay on the current serving IAB node or reselect another cell/IAB node.
The child nodes/UEs may wait for a designated duration before making the decision, expecting that the serving IAB node recovers the upstream radio link during the duration.
The child nodes/UEs may be configured with a conditional handover that allows an autonomous handover when its parent node suffered from a designated radio condition on its upstream link.
The child nodes/UEs may be configured with multiple signaling paths and may report a designated radio condition occurring on one of the paths using one of the remaining paths.
The donor node may configure an IAB node with a list of cell identities that the IAB node is allowed to select upon RLF.
The donor node may configure an IAB node with a list of cell identities that the IAB node is not allowed to select upon RLF.

Certain units and functionalities of the systems 20 may be implemented by electronic machinery. For example, electronic machinery may refer to the processor circuitry described herein, such as node processor(s) 54, relay node processor(s) 74, and node processor(s) 90. Moreover, the term “processor circuitry” is not limited to mean one processor, but may include plural processors, with the plural processors operating at one or more sites. Moreover, as used herein the term “server” is not confined to one server unit, but may encompasses plural servers and/or other electronic equipment, and may be co-located at one site or distributed to different sites. FIG. 49 is a diagrammatic view showing example elements comprising electronic machinery which may comprise a wireless terminal, a radio access node, and a core network node according to an example embodiment and mode. With these understandings, FIG. 49 shows an example of electronic machinery, e.g., processor circuitry, as comprising one or more processors 290, program instruction memory 292; other memory 294 (e.g., RAM, cache, etc.); input/output interfaces 296 and 297, peripheral interfaces 298; support circuits 299; and busses 300 for communication between the aforementioned units. The processor(s) 290 may comprise the processor circuitries described herein, for example, node processor(s) 54, relay node processor(s) 74, and node processor(s) 90.

An memory or register described herein may be depicted by memory 294, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 299 are coupled to the processors 290 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminal 30 and Integrated Access and Backhaul (IAB) nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves basic function of a radio access network, e.g., methods and procedures to deal with problematic conditions on a backhaul link, such as radio link failure (RLF), for example, and providing efficient and effective techniques for providing a message which notifies of radio link conditions such as radio link failure (RLF).

The technology disclosed herein encompasses one or more of the following non-limiting, non-exclusive example embodiments and modes:

Example Embodiment 1: A wireless relay node comprising:
processor circuitry configured to generate a notification message for transmission on Medium Access Control (MAC) layer signaling or physical layer signaling, the notification message comprising information representing a radio condition; and
transmitter circuitry configured to transmit the notification message to a wireless terminal.

Example Embodiment 2: The wireless relay node of Example Embodiment 1, wherein the processor circuitry is configured to generate a notification message for transmission on a Medium Access Control (MAC) subPDU in a MAC PDU.

Example Embodiment 3: The wireless terminal of Example Embodiment 2, further comprising:
receiver circuitry configured to receive downlink (DL) signals from a parent node; and
wherein the processor circuitry is further configured use the receiver circuitry to monitor the radio condition.

Example Embodiment 4: The wireless relay node of Example Embodiment 2, wherein the MAC subPDU comprises a MAC subheader, the MAC subheader including a logical channel identifier (LCID) reserved for the notification message.

Example Embodiment 5: The wireless relay node of Example Embodiment 4, wherein the LCID is associated with a MAC Control Element (CE) used for the information representing the radio condition(s), and the MAC subPDU comprises the MAC CE.

Example Embodiment 6: The wireless relay node of Example Embodiment 4, wherein the LCID is associated with no MAC CE, and the MAC subPDU does not include a MAC CE.

Example Embodiment 7: The wireless relay node of Example Embodiment 2, wherein plural LCIDs are reserved for the notification message, each of the plurality of LCIDs being reserved for types of the information representing the radio condition(s).

Example Embodiment 8: The wireless relay node of Example Embodiment 2, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

Example Embodiment 9: The wireless relay node of Example Embodiment 8, wherein Cyclic Redundancy Check (CRC) parity bits are attached to the DCI, the CRC parity bits being scrambled by a Radio Network Temporary Identifier (RNTI).

Example Embodiment 10: The wireless relay node of Example Embodiment 9, wherein the RNTI is a first RNTI configured by a network entity, the first RNTI being used for a notification(s) of upstream radio link condition(s).

Example Embodiment 11: The wireless relay node of Example Embodiment 9, wherein the RNTI is a Cell RNTI (C-RNTI) configured by a network entity, the C-RNTI used as an identifier of the RRC Connection and for scheduling.

Example Embodiment 12: The wireless relay node of Example Embodiment 8, wherein the DCI is transmitted on the PDCCH in a common search space set(s), a monitoring periodicity for the PDCCH being configured, by a network entity, to the one or more wireless terminals for the common search space set(s).

Example Embodiment 13: The wireless relay node of Example Embodiment 1, wherein the processor circuitry is configured to generate the physical layer signaling as a downlink control information (DCI) comprising content that indicates whether or not a radio link failure (RLF) has occurred on a link which is upstream from the wireless relay node.

Example Embodiment 14: The node of Example Embodiment 13, wherein the processor circuitry further generates a cyclical redundancy check CRC) value associated with the downlink control information (DCI) and to scramble the cyclical redundancy check CRC) value with a Radio Network Temporary Identifier (RNTI).

Example Embodiment 15: The node of Example Embodiment 14, wherein the processor circuitry is configured to scrambles the cyclical redundancy check CRC) value with a recipient's Cell-Radio Network Temporary Identifier (C-RNTI).

Example Embodiment 16: The node of Example Embodiment 14, wherein the processor circuitry is configured to scrambles the cyclical redundancy check CRC) value with Radio Network Temporary Identifier (C-RNTI) used as an indication of a notification of an upstream radio link condition.

Example Embodiment 17: A wireless terminal comprising:
a receiver circuitry configured to receive a notification message form a wireless relay node, the notification message comprising information representing a radio condition of the wireless relay node's upstream radio link, the notification message being received in Medium Access Control (MAC) layer signaling or physical layer signaling; and
a processor circuitry configured to perform a designated action based on a reception of the notification message.

Example Embodiment 18: The wireless terminal of Example Embodiment 17, wherein the notification message is received on a Medium Access Control (MAC) subPDU in a MAC PDU.

Example Embodiment 19: The wireless terminal of Example Embodiment 18, wherein the MAC subPDU comprises a MAC subheader, the MAC subheader including a logical channel identifier (LCID) reserved for the notification message.

Example Embodiment 20: The wireless terminal of Example Embodiment 19, wherein the LCID is associated with a MAC Control Element (CE) used for the information representing the radio condition(s), and the MAC subPDU comprises the MAC CE.

Example Embodiment 21: The wireless terminal of Example Embodiment 19, wherein the LCID is associated with no MAC CE, and the MAC subPDU does not include a MAC CE.

Example Embodiment 22: The wireless terminal of Example Embodiment 20, wherein plural LCIDs are reserved for the notification message, each of the plural LCIDs being reserved for types of the information representing the radio condition(s).

Example Embodiment 23: The wireless terminal of Example Embodiment 18, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

Example Embodiment 24: The wireless terminal of Example Embodiment 23, wherein Cyclic Redundancy Check (CRC) parity bits are attached to the DCI, the CRC parity bits being scrambled by a Radio Network Temporary Identifier (RNTI).

Example Embodiment 25: The wireless terminal of Example Embodiment 24, wherein the RNTI is a first RNTI configured by a network entity, the first RNTI being used for a notification(s) of upstream radio link condition(s).

Example Embodiment 26: The wireless terminal of Example Embodiment 24, wherein the RNTI is a Cell RNTI (C-RNTI) configured by a network entity, the C-RNTI used as an identifier of the RRC Connection and for scheduling.

Example Embodiment 27: The wireless terminal of Example Embodiment 23, wherein the DCI is monitored on the PDCCH in a common search space set(s), a monitoring periodicity for the PDCCH being configured, by a network entity, for the common search space set(s).

Example Embodiment 28: The wireless terminal of Example Embodiment 17, wherein the receiver circuitry configured to receive downlink control information (DCI) over a radio interface from a wireless relay node.

Example Embodiment 29: The wireless terminal of Example Embodiment 28, wherein the processor circuitry is further configured to decode a cyclical redundancy check CRC) value associated with the downlink control information (DCI) that has been scrambled with a Radio Network Temporary Identifier (RNTI).

Example Embodiment 30: The wireless terminal of Example Embodiment 29, wherein the processor circuitry is configured to de-scrambles the cyclical redundancy check CRC) value with a recipient's Cell-Radio Network Temporary Identifier (C-RNTI).

Example Embodiment 31: The wireless terminal of Example Embodiment 29, wherein the processor circuitry is configured to de-scrambles the cyclical redundancy check CRC) value with a Radio Network Temporary Identifier (C-RNTI) used as an indication of a notification of an upstream radio link condition.

Example Embodiment 32: A method for a wireless relay node comprising:
generating a notification message comprising information representing the radio condition(s) for transmission on Medium Access Control (MAC) layer signaling or physical layer signaling; and
transmitting the notification message to a wireless terminal.

Example Embodiment 33: The method of Example Embodiment 32, comprising:
generating the notification message comprising information representing the radio condition(s) for transmission on a Medium Access Control (MAC) subPDU in a MAC PDU.

Example Embodiment 34: The method of Example Embodiment 33, further comprising:
receiving downlink (DL) signals from a parent node; and
using the receiver circuitry to monitor the radio condition of a link from the parent node.

Example Embodiment 35: The method of Example Embodiment 33, wherein the MAC subPDU comprises a MAC subheader, the MAC subheader including a logical channel identifier (LCID) reserved for the notification message.

Example Embodiment 36: The method of Example Embodiment 35, wherein the LCID is associated with a MAC Control Element (CE) used for the information representing the radio condition(s), and the MAC subPDU comprises the MAC CE.

Example Embodiment 37: The method of Example Embodiment 35, wherein the LCID is associated with no MAC CE, and the MAC subPDU does not include a MAC CE.

Example Embodiment 38: The method of Example Embodiment 33, wherein plural LCIDs are reserved for the notification message, each of the plural LCIDs being reserved for types of the information representing the radio condition(s).

Example Embodiment 39: The method of Example Embodiment 33, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

Example Embodiment 40: The method of Example Embodiment 39, wherein Cyclic Redundancy Check (CRC) parity bits are attached to the DCI, the CRC parity bits being scrambled by a Radio Network Temporary Identifier (RNTI).

Example Embodiment 41: The method of Example Embodiment 40, wherein the RNTI is a first RNTI configured by a network entity, the first RNTI being used for a notification(s) of upstream radio link condition(s).

Example Embodiment 42: The method of Example Embodiment 40, wherein the RNTI is a Cell RNTI (C-RNTI) configured by a network entity, the C-RNTI used as an identifier of the RRC Connection and for scheduling.

Example Embodiment 43: The method of Example Embodiment 39, wherein the DCI is transmitted on the PDCCH in a common search space set(s), a monitoring periodicity for the PDCCH being configured, by a network entity, to the one or more wireless terminals for the common search space set(s).

Example Embodiment 44: The method of Example Embodiment 31, comprising:
generating downlink control information (DCI) comprising content that indicates whether or not a radio link failure (RLF) has occurred on a link which is upstream form the wireless relay node; and
transmitting the downlink control information (DCI) to a wireless terminal.

Example Embodiment 45: The method of Example Embodiment 44, further comprising:
generating a cyclical redundancy check (CRC) value associated with the downlink control information (DCI); and
scrambling the cyclical redundancy check (CRC) value with a Radio Network Temporary Identifier (RNTI).

Example Embodiment 46: The method of Example Embodiment 45, further comprising scrambling the cyclical redundancy check CRC) value with a recipient's Cell-Radio Network Temporary Identifier (C-RNTI).

Example Embodiment 47: The method of Example Embodiment 45, further comprising scrambling the cyclical redundancy check CRC) value with Radio Network Temporary Identifier (C-RNTI) used as an indication of a notification of an upstream radio link condition.

Example Embodiment 48: A method for a wireless terminal comprising:
receiving a notification message from a wireless relay node, the notification message comprising information representing radio condition(s) of the wireless relay node's upstream radio link, the notification message being received on Medium Access Control (MAC) layer signaling or physical layer signaling; and
performing a designated action based on a reception of the notification message.

Example Embodiment 49: The method of Example Embodiment 48, wherein the notification message comprises information representing radio condition(s) of the wireless relay node's upstream radio link, the notification message being received on a Medium Access Control (MAC) subPDU in a MAC PDU.

Example Embodiment 50: The method of Example Embodiment 49, wherein the MAC subPDU comprises a MAC subheader, the MAC subheader including a logical channel identifier (LCID) reserved for the notification message.

Example Embodiment 51: The method of Example Embodiment 50, wherein the LCID is associated with a MAC Control Element (CE) used for the information representing the radio condition(s), and the MAC subPDU comprises the MAC CE.

Example Embodiment 52: The method of Example Embodiment 50, wherein the LCID is associated with no MAC CE, and the MAC subPDU does not include a MAC CE.

Example Embodiment 53: The method of Example Embodiment 51, wherein plural LCIDs are reserved for the notification message, each of the plural LCIDs being reserved for types of the information representing the radio condition(s).

Example Embodiment 54: The method of Example Embodiment 49, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

Example Embodiment 55: The method of Example Embodiment 54, wherein Cyclic Redundancy Check (CRC) parity bits are attached to the DCI, the CRC parity bits being scrambled by a Radio Network Temporary Identifier (RNTI).

Example Embodiment 56: The method of Example Embodiment 55, wherein the RNTI is a first RNTI configured by a network entity, the first RNTI being used for a notification(s) of upstream radio link condition(s).

Example Embodiment 57: The method of Example Embodiment 55, wherein the RNTI is a Cell RNTI (C-RNTI) configured by a network entity, the C-RNTI used as an identifier of the RRC Connection and for scheduling.

Example Embodiment 58: The method of Example Embodiment 54, wherein the DCI is monitored on the PDCCH in a common search space set(s), a monitoring periodicity for the PDCCH being configured, by a network entity, for the common search space set(s).

Example Embodiment 59: The method of Example Embodiment 48, further comprising:
receiving a downlink control information (DCI) over a radio interface from a wireless relay node; and
ascertaining from the downlink control information whether or not a radio link failure (RLF) has occurred on a link which is upstream from the wireless relay node.

Example Embodiment 60: The method of Example Embodiment 59, further comprising decoding a cyclical redundancy check CRC) value associated with the downlink control information (DCI) that has been scrambled with a Radio Network Temporary Identifier (RNTI).

Example Embodiment 60: The method of Example Embodiment 60, further comprising de-scrambling the cyclical redundancy check CRC) value with a recipient's Cell-Radio Network Temporary Identifier (C-RNTI).

Example Embodiment 62: The method of Example Embodiment 60, further comprising de-scrambling the cyclical redundancy check CRC) value with a Radio Network Temporary Identifier (C-RNTI) used as an indication of a notification of an upstream radio link condition.

One or more of the following documents may be pertinent to the technology disclosed herein (all of which are incorporated herein by reference in their entirety):

| | | |
|---|---|---|
| R2-1816509 | Selection of Parent for IAB-Node | vivo |
| R2-1816561 | IAB node selection and reselection in RRC IDLE | Ericsson. |
| R2-1816562 | IAB node relocation | Ericsson |
| R2-1816564 | Minimumizing CN functionalities for IAB network | Ericsson |
| R2-1816567 | Network slicing in IAB networks | Ericsson |
| R2-1816579 | Suspension of Transmission upon Failure of Backhaul links | Ericsson |
| R2-1816580 | Setup Procedure for the Adaptation Layer of an IAB Network | Ericsson |
| R2-1817073 | Route management in IAB | Sony |
| R2-1817074 | Open issues related to IAB power on procedure | Sony |
| R2-1817169 | Parent node selection for IAB access | Lenovo, Motorola Mobility |
| R2-1817170 | RLF in backhaul link | Lenovo, Motorola Mobility |
| R2-1817271 | Topology Management for Spanning Tree topologies | Nokia, Nokia Shanghai Bell |
| R2-1817411 | Discussion on backhaul bearer setup in IAB network | ZTE Corporation |
| R2-1817418 | Discussion on IAB node discovery and selection | ZTE Corporation |
| R2-1817419 | Consideration on Routing in IAB | ZTE Corporation |
| R2-1817520 | Topology in IAB system | Lenovo, Motorola Mobility |
| R2-1817543 | Which cell/IAB node support child IAB access | Lenovo, Motorola Mobility |
| R2-1817573 | Consideration of RLF recovery in IAB | Kyocera |
| R2-1817616 | Discovery and measurements for IAB | Nokia, Nokia Shanghai Bell |
| R2-1817699 | Route Adaptation Upon Backhaul Failure | Intel Corporation |
| R2-1817716 | Text proposal for Route Adaptation Upon Backhaul Failure | Intel Corporation |
| R2-1817775 | Route selection method for architecture 1 a | Huawei Technologies France |
| R2-1817836 | CP signalling transmission in IAB NSA | Futurewei Technologies |
| R2-1817906 | IAB bearer mapping decisions | Huawei Technologies France |
| R2-1817931 | QoS parameters for IAB QoS handling | Huawei Technologies France |
| R2-1817990 | Service Interruption Minimization during Topology Adaptation | ITRI |
| R2-1818231 | Consideration on backhaul link enhancement for IAB | LG Electronics France |
| R2-1818292 | Discussion on cell reselection of IAB nodes | LG Electronics Inc |
| R2-1818336 | Support of Multiple connectivity for IAB nodes | Futurewei Technologies |
| R2-1818367 | Handling of the RLF on wireless backhaul link | LG Electronics Inc. |
| R2-1818377 | TAB routing and topology management for Architecture 1a | Nokia, Nokia Shanghai Bell |
| R2-1818415 | Access Control for IAB node | LG Electronics Inc. |
| R2-1818745 | TP QoS parameters for IAB QoS handling | Huawei Technologies France |
| R2-1818746 | Route Adaptation Upon Backhaul Failure | Intel Corporation |
| R2-1818764 | TP QoS parameters for IAB QoS handling | Huawei Technologies France |
| R2-1818765 | Route Adaptation Upon Backhaul Failure | Intel Corporation |
| R2-1818790 | TP on QoS parameters for IAB QoS handling | Huawei Technologies France |

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

### Summary

In one example, a wireless relay node comprising: processor circuitry configured to generate a notification message for transmission on at least one of Medium Access Control (MAC) layer signaling and physical layer signaling, the notification message comprising information representing a radio condition; transmitter circuitry configured to transmit the notification message to a wireless terminal.

In one example, the wireless relay node, wherein the processor circuitry is configured to generate a notification message for transmission on a Medium Access Control (MAC) subPDU in a MAC PDU.

In one example, the wireless terminal, further comprising: receiver circuitry configured to receive downlink (DL) signals from a parent node; and wherein the processor circuitry is further configured use the receiver circuitry to monitor the radio condition.

In one example, the wireless relay node, wherein the MAC subPDU comprises a MAC subheader, the MAC subheader including a logical channel identifier (LCID) reserved for the notification message.

In one example, the wireless relay node, wherein the LCID is associated with a MAC Control Element (CE) used for the information representing the radio condition(s), and the MAC subPDU comprises the MAC CE.

In one example, the wireless relay node, wherein the LCID is associated with no MAC CE, and the MAC subPDU does not include a MAC CE.

In one example, the wireless relay node, wherein plural LCIDs are reserved for the notification message, each of the plurality of LCIDs being reserved for types of the information representing the radio condition(s).

In one example, the wireless relay node, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

In one example, the wireless relay node, wherein Cyclic Redundancy Check (CRC) parity bits are attached to the DCI, the CRC parity bits being scrambled by a Radio Network Temporary Identifier (RNTI).

In one example, the wireless relay node, wherein the RNTI is a first RNTI configured by a network entity, the first RNTI being used for a notification(s) of upstream radio link condition(s).

In one example, the wireless relay node, wherein the RNTI is a Cell RNTI (C-RNTI) configured by a network entity, the C-RNTI used as an identifier of the RRC Connection and for scheduling.

In one example, the wireless relay node, wherein the DCI is transmitted on the PDCCH in a common search space set(s), a monitoring periodicity for the PDCCH being configured, by a network entity, to the one or more wireless terminals for the common search space set(s).

In one example, the wireless relay node, wherein the processor circuitry is configured to generate the physical layer signaling as a downlink control information (DCI) comprising content that indicates whether or not a radio link failure (RLF) has occurred on a link which is upstream from the wireless relay node.

In one example, the node, wherein the processor circuitry further generates a cyclical redundancy check CRC) value associated with the downlink control information (DCI) and to scramble the cyclical redundancy check CRC) value with a Radio Network Temporary Identifier (RNTI).

In one example, the node, wherein the processor circuitry is configured to scrambles the cyclical redundancy check CRC) value with a recipient's Cell-Radio Network Temporary Identifier (C-RNTI).

In one example, the node, wherein the processor circuitry is configured to scrambles the cyclical redundancy check CRC) value with Radio Network Temporary Identifier (C-RNTI) used as an indication of a notification of an upstream radio link condition.

In one example, a wireless terminal comprising: receiver circuitry configured to receive a notification message from a wireless relay node, the notification message comprising information representing a radio condition of the wireless relay node's upstream radio link, the notification message being received in at least one of Medium Access Control (MAC) layer signaling and physical layer signaling; processor circuitry configured to perform a designated action based on a reception of the notification message.

In one example, the wireless terminal, wherein the notification message is received on a Medium Access Control (MAC) subPDU in a MAC PDU.

In one example, the wireless terminal, wherein the MAC subPDU comprises a MAC subheader, the MAC subheader including a logical channel identifier (LCID) reserved for the notification message.

In one example, the wireless terminal, wherein the LCID is associated with a MAC Control Element (CE) used for the information representing the radio condition(s), and the MAC subPDU comprises the MAC CE.

In one example, the wireless terminal, wherein the LCID is associated with no MAC CE, and the MAC subPDU does not include a MAC CE.

In one example, the wireless terminal, wherein plural LCIDs are reserved for the notification message, each of the plural LCIDs being reserved for types of the information representing the radio condition(s).

In one example, the wireless terminal, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

In one example, the wireless terminal, wherein Cyclic Redundancy Check (CRC) parity bits are attached to the DCI, the CRC parity bits being scrambled by a Radio Network Temporary Identifier (RNTI).

In one example, the wireless terminal, wherein the RNTI is a first RNTI configured by a network entity, the first RNTI being used for a notification(s) of upstream radio link condition(s).

In one example, the wireless terminal, wherein the RNTI is a Cell RNTI (C-RNTI) configured by a network entity, the C-RNTI used as an identifier of the RRC Connection and for scheduling.

In one example, the wireless terminal, wherein the DCI is monitored on the PDCCH in a common search space set(s), a monitoring periodicity for the PDCCH being configured, by a network entity, for the common search space set(s).

In one example, the wireless terminal, wherein the receiver circuitry configured to receive downlink control information (DCI) over a radio interface from a wireless relay node.

In one example, the wireless terminal, wherein the processor circuitry is further configured to decode a cyclical redundancy check CRC) value associated with the downlink control information (DCI) that has been scrambled with a Radio Network Temporary Identifier (RNTI).

In one example, the wireless terminal, wherein the processor circuitry is configured to de-scrambles the cyclical redundancy check CRC) value with a recipient's Cell-Radio Network Temporary Identifier (C-RNTI).

In one example, the wireless terminal, wherein the processor circuitry is configured to de-scrambles the cyclical redundancy check CRC) value with a Radio Network Temporary Identifier (C-RNTI) used as an indication of a notification of an upstream radio link condition.

In one example, a method for a wireless relay node comprising: generating a notification message comprising information representing the radio condition(s) for transmission on at least one of Medium Access Control (MAC) layer signaling and or physical layer signaling; transmitting the notification message to a wireless terminal.

In one example, the method, comprising: generating the notification message comprising information representing the radio condition(s) for transmission on a Medium Access Control (MAC) subPDU in a MAC PDU.

In one example, the method, further comprising: receiving downlink (DL) signals from a parent node; using the receiver circuitry to monitor the radio condition of a link from the parent node.

In one example, the method, wherein the MAC subPDU comprises a MAC subheader, the MAC subheader including a logical channel identifier (LCID) reserved for the notification message.

In one example, the method, wherein the LCID is associated with a MAC Control Element (CE) used for the information representing the radio condition(s), and the MAC subPDU comprises the MAC CE.

In one example, the method, wherein the LCID is associated with no MAC CE, and the MAC subPDU does not include a MAC CE.

In one example, the method, wherein plural LCIDs are reserved for the notification message, each of the plural LCIDs being reserved for types of the information representing the radio condition(s).

In one example, the method, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

In one example, the method, wherein Cyclic Redundancy Check (CRC) parity bits are attached to the DCI, the CRC parity bits being scrambled by a Radio Network Temporary Identifier (RNTI).

In one example, the method, wherein the RNTI is a first RNTI configured by a network entity, the first RNTI being used for a notification(s) of upstream radio link condition(s).

In one example, the method, wherein the RNTI is a Cell RNTI (C-RNTI) configured by a network entity, the C-RNTI used as an identifier of the RRC Connection and for scheduling.

In one example, the method, wherein the DCI is transmitted on the PDCCH in a common search space set(s), a monitoring periodicity for the PDCCH being configured, by a network entity, to the one or more wireless terminals for the common search space set(s).

In one example, the method, comprising: generating downlink control information (DCI) comprising content that indicates whether or not a radio link failure (RLF) has occurred on a link which is upstream from the wireless relay node; transmitting the downlink control information (DCI) to a wireless terminal.

In one example, the method, further comprising: generating a cyclical redundancy check CRC) value associated with the downlink control information (DCI); and scrambling the cyclical redundancy check (CRC) value with a Radio Network Temporary Identifier (RNTI).

In one example, the method, further comprising scrambling the cyclical redundancy check CRC) value with a recipient's Cell-Radio Network Temporary Identifier (C-RNTI).

In one example, the method, further comprising scrambling the cyclical redundancy check (CRC) value with Radio Network Temporary Identifier (C-RNTI) used as an indication of a notification of an upstream radio link condition.

In one example, a method for a wireless terminal comprising: receiving a notification message from a wireless relay node, the notification message comprising information representing radio condition(s) of the wireless relay node's upstream radio link, the notification message being received on at least one of Medium Access Control (MAC) layer signaling and physical layer signaling; performing a designated action based on a reception of the notification message.

In one example, the method, wherein the notification message comprises information representing radio condition(s) of the wireless relay node's upstream radio link, the notification message being received on a Medium Access Control (MAC) subPDU in a MAC PDU.

In one example, the method, wherein the MAC subPDU comprises a MAC subheader, the MAC subheader including a logical channel identifier (LCID) reserved for the notification message.

In one example, the method, wherein the LCID is associated with a MAC Control Element (CE) used for the information representing the radio condition(s), and the MAC subPDU comprises the MAC CE.

In one example, the method, wherein the LCID is associated with no MAC CE, and the MAC subPDU does not include a MAC CE.

In one example, the method, wherein plural LCIDs are reserved for the notification message, each of the plural LCIDs being reserved for types of the information representing the radio condition(s).

In one example, the method, wherein the MAC PDU is transmitted on a Physical Downlink Shared Channel (PDSCH), the PDSCH being scheduled by using Downlink Control Information (DCI) transmitted on a Physical Downlink Control Channel (PDCCH).

In one example, the method, wherein Cyclic Redundancy Check (CRC) parity bits are attached to the DCI, the CRC parity bits being scrambled by a Radio Network Temporary Identifier (RNTI).

In one example, the method, wherein the RNTI is a first RNTI configured by a network entity, the first RNTI being used for a notification(s) of upstream radio link condition(s).

In one example, the method, wherein the RNTI is a Cell RNTI (C-RNTI) configured by a network entity, the C-RNTI used as an identifier of the RRC Connection and for scheduling.

In one example, the method, wherein the DCI is monitored on the PDCCH in a common search space set(s), a monitoring periodicity for the PDCCH being configured, by a network entity, for the common search space set(s).

In one example, the method, further comprising: receiving a downlink control information (DCI) over a radio interface from a wireless relay node; ascertaining from the downlink control information whether or not a radio link failure (RLF) has occurred on a link which is upstream from the wireless relay node.

In one example, the method, further comprising decoding a cyclical redundancy check (CRC) value associated with the downlink control information (DCI) that has been scrambled with a Radio Network Temporary Identifier (RNTI).

In one example, the method, further comprising de-scrambling the cyclical redundancy check (CRC) value with a recipient's Cell-Radio Network Temporary Identifier (C-RNTI).

In one example, the method, further comprising de-scrambling the cyclical redundancy check (CRC) value with a Radio Network Temporary Identifier (C-RNTI) used as an indication of a notification of an upstream radio link condition.

In one example, a wireless relay node comprising: processor circuitry configured to generate a notification message for transmission on at least one of Medium Access Control (MAC) layer signaling and physical layer signaling, the notification message comprising information representing a radio condition; transmitter circuitry configured to transmit the notification message to a wireless terminal.

In one example, the wireless relay node, wherein the processor circuitry is configured to generate a notification message for transmission on a Medium Access Control (MAC) subPDU in a MAC PDU.

In one example, the wireless relay node, wherein the processor circuitry is configured to generate the physical layer signaling as a downlink control information (DCI) comprising content that indicates whether or not a radio link failure (RLF) has occurred on a link which is upstream from the wireless relay node.

In one example, a wireless terminal comprising: receiver circuitry configured to receive a notification message from a wireless relay node, the notification message comprising information representing a radio condition of the wireless relay node's upstream radio link, the notification message being received in at least one of Medium Access Control (MAC) layer signaling and physical layer signaling; processor circuitry configured to perform a designated action based on a reception of the notification message.

In one example, the wireless terminal, wherein the receiver circuitry configured to receive downlink control information (DCI) over a radio interface from a wireless relay node.

In one example, a method for a wireless relay node comprising: generating a notification message comprising information representing the radio condition(s) for transmission on at least one of Medium Access Control (MAC) layer signaling and or physical layer signaling; transmitting the notification message to a wireless terminal.

In one example, the method, comprising: generating the notification message comprising information representing the radio condition(s) for transmission on a Medium Access Control (MAC) subPDU in a MAC PDU.

In one example, a method for a wireless terminal comprising: receiving a notification message from a wireless relay node, the notification message comprising information representing radio condition(s) of the wireless relay node's upstream radio link, the notification message being received on at least one of Medium Access Control (MAC) layer signaling and physical layer signaling; performing a designated action based on a reception of the notification message.

In one example, the method, wherein the notification message comprises information representing radio condition(s) of the wireless relay node's upstream radio link, the notification message being received on a Medium Access Control (MAC) subPDU in a MAC PDU.

In one example, the method, further comprising: receiving a downlink control information (DCI) over a radio interface from a wireless relay node; ascertaining from the downlink control information whether or not a radio link failure (RLF) has occurred on a link which is upstream from the wireless relay node.

1-3. (canceled)

4. A wireless terminal comprising:
receiver circuitry configured to receive a notification message from a wireless relay node, the notification message comprising information representing at least one radio condition of an upstream radio link of the wireless relay node, the notification message received in at least one of Medium Access Control (MAC) layer signaling and physical layer signaling; and
processor circuitry configured to perform a designated action based on reception of the notification message.

5. The wireless terminal of claim 4, wherein the receiver circuitry is further configured to receive downlink control information (DCI) over a radio interface from the wireless relay node.

6-7. (canceled)

8. A method for a wireless terminal comprising:
receiving a notification message from a wireless relay node, the notification message comprising information representing at least one radio condition of an upstream radio link of the wireless relay node, the notification message received on at least one of Medium Access Control (MAC) layer signaling and physical layer signaling; and
performing a designated action based on reception of the notification message.

9. The method of claim 8, wherein the notification message is received on a MAC sub Protocol Data Unit (PDU) (subPDU) in a MAC PDU.

10. The method of claim 8, further comprising:
receiving downlink control information (DCI) over a radio interface from the wireless relay node.

11. The method of claim 10, further comprising:
ascertaining from the DCI whether radio link failure (RLF) has occurred on a link which is upstream from the wireless relay node.

12. A method for a wireless relay node comprising:
generating a notification message comprising information representing at least one radio condition for transmission on at least one of Medium Access Control (MAC) layer signaling and or physical layer signaling; and
transmitting the notification message to a wireless terminal.

13. The method of claim 12, comprising:
generating the notification message on a MAC sub Protocol Data Unit (PDU) (subPDU) in a MAC PDU.

14. The wireless terminal of claim 4, wherein the notification message is received on a MAC sub Protocol Data Unit (PDU) (subPDU) in a MAC PDU.

15. The wireless terminal of claim 5, wherein the processor circuitry is further configured to ascertain from the DCI whether radio link failure (RLF) has occurred on a link which is upstream from the wireless relay node.
